(19) United States
(12) Patent Application Publication
(10) Pub. No.: US 2008/0086640 A1
(43) Pub. Date: Apr. 10, 2008

(54) SYSTEMS, METHODS AND APPARATUS OF AN EMAIL CLIENT

(75) Inventors: Terry A. Voss, Spokane, WA (US); Martin W. Howser, Spokane, WA (US)

Correspondence Address: RAMIREZ & SMITH, PO BOX 341179, AUSTIN, TX, 78734, US

(73) Assignee: JMJ Software, LLC, Spokane, WA (US)

(21) Appl. No.: 11/625,336

(22) Filed: Jan. 21, 2007

Related U.S. Application Data
(63) Continuation-in-part of application No. 11/191,358, filed on Jul. 28, 2005.

(51) Int. Cl. H04L 9/30

(52) U.S. Cl. 713/171; 380/282

(57) ABSTRACT

Systems, methods and apparatus of email communication are described.

### RELATED APPLICATION

This application claims the benefit of and is a continuation-in-part to copending U.S. Original application Ser. No. 11/191,358, filed Jul. 28, 2005, entitled “SYSTEMS, METHODS AND APPARATUS OF AN EMAIL CLIENT.”

### FIELD OF THE INVENTION

This invention relates generally to client/server systems, and more particularly to email clients.

### BACKGROUND OF THE INVENTION

Email is considered to be the “killer” application that helped create wide-spread popularity and adoption of the Internet. The ability to exchange information and files within a few seconds between any points on Earth is tremendously useful and may have provided significant economic growth in the Western world and possibly to the economies of all nations. Email has affected the structure and organization of corporations, enabling companies to disburse and distribute work and tasks between remote locations to an extent that could only be done with the nearly instant and convenient exchange of data that email provides.

As discussed above, the commercial value and function of email is tremendous, however, the function of conventional email clients present problems. One problem is display of the body of an email that is encoded in extended ASCII characters. Extended ASCII characters are characters in which one or more characters are encoded in binary 128 or higher. When the content is stored in a conventional format such as UTF8 text, the characters encoded in the extended character set are displayed as a question mark character “?” on a computer that does not recognize the extended characters.

In another aspect of conventional email clients, email communication can be intercepted during transit from a sender to a recipient. The email can also be modified by a party of a computer process without consent by the sender or the recipient. The email can be forged or falsely generated and distributed on the Internet by a hacker or spammer with false attribution to another party.

In yet a further aspect of conventional email clients, database management software is expensive to purchase and even more difficult to install. Robust conventional database managers often require installation of an Object Framework to support features of applications that use the database manager which requires installation of both the application and the database manager. The requirement to install both the application and the database manager compounds the difficulty of installation.

In an additional aspect of conventional email clients, a user is allowed to specify a folder for emails to be stored in upon receipt of said email. However, the association of the email is limited to that location.

Furthermore, conventional means of storing and managing favorites are very cumbersome. More specifically, email communications often contain one or more hyperlinks to an information resource. If a user clicks on the hyperlink, a browser program is invoked and the browser program displays the information resource at that hyperlink location. The information can be referred to as a page. If the user wants to save the hyperlink for future reference, the user can save the hyperlink in a list often referred to as “favorites” which is often embodied as a specialized folder with a software facility that provides retrieval of the hyperlink. In conventional “favorites” systems, those folders are difficult to remember and change because the favorites list is spread across multiple screens, so that a change of organization can not be easily contemplated, and once a plan for change is developed, drag and drop functionality is not available to make those changes easy and quick to do. Another problem with conventional “favorites” systems is that the favorites data is held in a proprietary file which prevents a user from modifying the favorites through simple tools such as a text editor when migrating the favorites to a new computer.

There are many ways that recurring events are managed by conventional email clients. In general, either the options are very limited to be easy to use, or many options are served on separate pages to the user to lead them through creating a meaningful recurring event in a wizard-like fashion. Conventional email clients have difficulty blending the advantages of either approaches.

Conventional email clients display or view email content in a container that lacks graphical display capabilities. Therefore when the user clicks on a hyperlink in an email communication, another program, a browser program, is invoked to view the webpage associated with the hyperlink that was clicked. In this process, part of the email program is not visible where the browser overlaps.

Furthermore, conventional email clients are difficult to find emails, people, topics or hyperlinks when needed because the user has not remembered what folder an email communication was placed.

In conventional email programs, emails are stored and organized in regard to a personal identity. Storing and organizing by personal identity can be performed by creating a folder that is identified with that person, and then storing emails associated with that person in that folder. However, this is a very time consuming activity.

Some conventional email clients limit processing to text emails, in which emails having HTML code are not processed. However, this limits the interaction of the email client with email communications from other email clients that process HTML.

For the reasons stated above, and for other reasons stated below which will become apparent to those skilled in the art upon reading and understanding the present specification, there is a need in the art for greater security of email communication. In addition, there is a need in the art for a more convenient installation procedure of an application program and an associated database manager. There is also a need for a more general association between emails on other indicia. Furthermore, there is a need in the art for a Favorites list that can be easily viewed to contemplate changes and perform drag and drop operations and a need to use simple editing tools on the Favorites file. In addition, there is a need in the art to combine the advantages of either approach of managing recurring events. There is also a need to display or view a hyperlink in the email program so that the entire display of the email program is visible to the user. Yet, there is a further need to more easily access email communications. There is still a further need in the art for a less time-consuming manner of storing and organizing email communications in regard to a personal identity. In addition, there is a need for an email client that does not process email communications to generate a reply to an email communication that includes HTML. Further, there is a need in the art to display all extended characters of text that is encoded in an extended character set.

### BRIEF DESCRIPTION OF THE INVENTION

The above-mentioned shortcomings, disadvantages and problems are addressed herein, which will be understood by reading and studying the following specification.

In one aspect, a method that solves the need in the art to display all extended characters of text that is encoded in an extended character set, includes retrieving the email communication as a binary file from a server, receiving a designation of a character set of a text body of the email communication, populating a data structure that is compliant with the MIME standard with data from the email communication, populating an email data structure with data from the MIME-compliant data structure; populating the email data structure with the designation of the character set; and storing the email data structure in a database.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram that provides an overview of a system to provide a reliable apparatus of managing email data;

FIG. 2 is a diagram of a table layout data structure to manage categories;

FIG. 3 is a diagram of a table layout data structure to manage persons;

FIG. 4 is a diagram of a table layout data structure to manage category and person relationships;

FIG. 5 is a diagram of a data structure to manage category and person relationships;

FIG. 6 is a diagram of a table layout data structure to manage communications;

FIG. 7 is a diagram of a data structure to manage category and communications relationships;

FIG. 8 is a diagram of a data structure to manage persons and communications relationships;

FIG. 9 is a diagram of a table layout data structure to manage attachments;

FIG. 10 is a diagram of a data structure to manage communication and attachment relationships;

FIG. 11 is a diagram of a table layout data structure to manage zip codes;

FIG. 12 is a diagram of a data structure to manage persons and zip code relationships;

FIG. 13 is a diagram of a table layout data structure to manage recurrences;

FIG. 14 is a diagram of a data structure to manage persons and recurrences relationships;

FIG. 15 is a diagram of a table layout data structure to manage states;

FIG. 16 is a diagram of a data structure to manage persons and state relationships;

FIG. 17 is a diagram of a table layout data structure to manage countries;

FIG. 18 is a diagram of a data structure to manage persons and country relationships;

FIG. 19 is a diagram of a table layout data structure to manage setups;

FIG. 20 is a diagram of a table layout data structure to manage priorities;

FIG. 21 is a diagram of a table layout data structure to manage generations;

FIG. 22 is a diagram of a table layout data structure to manage email sending defaults;

FIG. 23 is a diagram of a table layout data structure to manage contacts.

FIG. 24 is a diagram of a table layout data structure to manage mdefaults;

FIG. 25 is a diagram of a table layout data structure to manage cdefaults;

FIG. 26 is a diagram of a table layout data structure to manage communications;

FIG. 27 is a diagram of a data structure to manage category and communications relationships;

FIG. 28 is a diagram of a data structure to manage persons and communications relationships;

FIG. 29 is a diagram of a data structure to manage communications and attachment relationships;

FIG. 30 is a dataflow diagram to manage email communications according to an embodiment;

FIG. 31 is a diagram of a table layout data structure to manage favorites;

FIG. 32 is a block diagram of a hardware and operating environment in which different embodiments can be practiced;

FIG. 33 is a block diagram of a data storage architecture that provides a stable data storage environment through a transaction-based architecture;

FIG. 34 is a block diagram of a database manager that provides a stable data storage environment through a high level security manager;

FIG. 35 is a block diagram of a database manager that provides a stable data storage environment through relational data management;

FIG. 36 is a data flow diagram to manage attachments according to an embodiment;

FIG. 37 is a data flow diagram to manage embedded graphics according to an embodiment;

FIG. 38 is a flowchart of a method to import an email according to an embodiment;

FIG. 39 is a data flow diagram to import data into an email client according to an embodiment;

FIG. 40 is a data flow diagram to import data into an email client according to an embodiment.

FIG. 41 is a dataflow diagram to manage multiple users according to an embodiment;

FIG. 42 is a flowchart of a method to manage email associations, according to an embodiment;

FIG. 43 is a flowchart of a method to provide storage for email data including attachments according to an embodiment;

FIG. 44 is a flowchart of a method to retrieve an email attachment according to an embodiment;

FIG. 45 is a flowchart of a method to manage auto-receive according to an embodiment;

FIG. 46 is a flowchart of a method to import an email communication according to an embodiment.

FIG. 47 is a flowchart of a method to create an executable managed code email client according to an embodiment;

FIG. 48 is a flowchart of a method to prioritize email communications according to an embodiment;

FIG. 49 is a flowchart of a method to encrypt email communications according to an embodiment;

FIG. 50 is a flowchart of a method to encrypt email communications according to an embodiment;

FIG. 51 is a flowchart of a method to decrypt email communications according to an embodiment;

FIG. 52 is a flowchart of a method to install supporting components of an email communication client according to an embodiment;

FIG. 53 is a flowchart of a method to manage scenarios of previous installation states of an email communication client according to an embodiment;

FIG. 54 is a flowchart of a method to associate an email with an idea or a category in an email communication client according to an embodiment;

FIG. 55 is a flowchart of a method to store locations of favorite resources, according to an embodiment;

FIG. 56 is a flowchart of a method to manage recurring events, according to an embodiment;

FIG. 57 is a flowchart of a method to view email communications, according to an embodiment;

FIG. 58 is a flowchart of a method to access email communications, according to an embodiment;

FIG. 59 is a flowchart of a method to automate history of email communications, according to an embodiment;

FIG. 60 is a flowchart of a method to convert HTML to text, according to an embodiment;

FIG. 61 is a flowchart of a method to receive and store an email communication that retains a designation of the character set of the email communication, according to an embodiment;

FIG. 63 is a block diagram of a graphical user interface (GUI) to associate an email with an idea or a category in an email communication client, according to an embodiment;

FIG. 64 is a block diagram of a display of nested Favorites list to store locations of favorite resources, according to an embodiment;

FIG. 65 is a block diagram of a display of recurring events, according to an embodiment;

FIG. 66 is a block diagram of a display of an email communication, according to an embodiment;

FIG. 67 is a block diagram of a display of an email communication, according to an embodiment;

FIG. 68 is a block diagram of a display of an email screen, according to an embodiment;

FIG. 69 is a block diagram of a display of a person screen, according to an embodiment;

FIG. 70 is a block diagram of a display of a history screen, according to an embodiment;

FIG. 71 is a block diagram of a display of an email composition screen before conversion of HTML to text, according to an embodiment; and

FIG. 72 is a block diagram of a display of an email composition screen after conversion of HTML to text, according to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

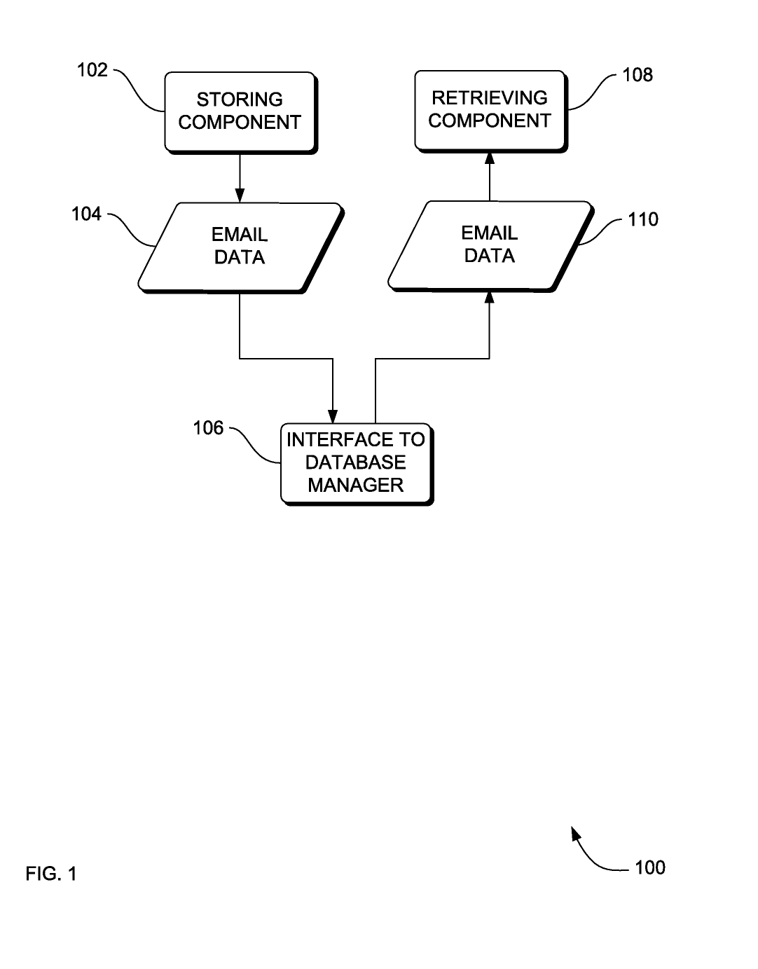

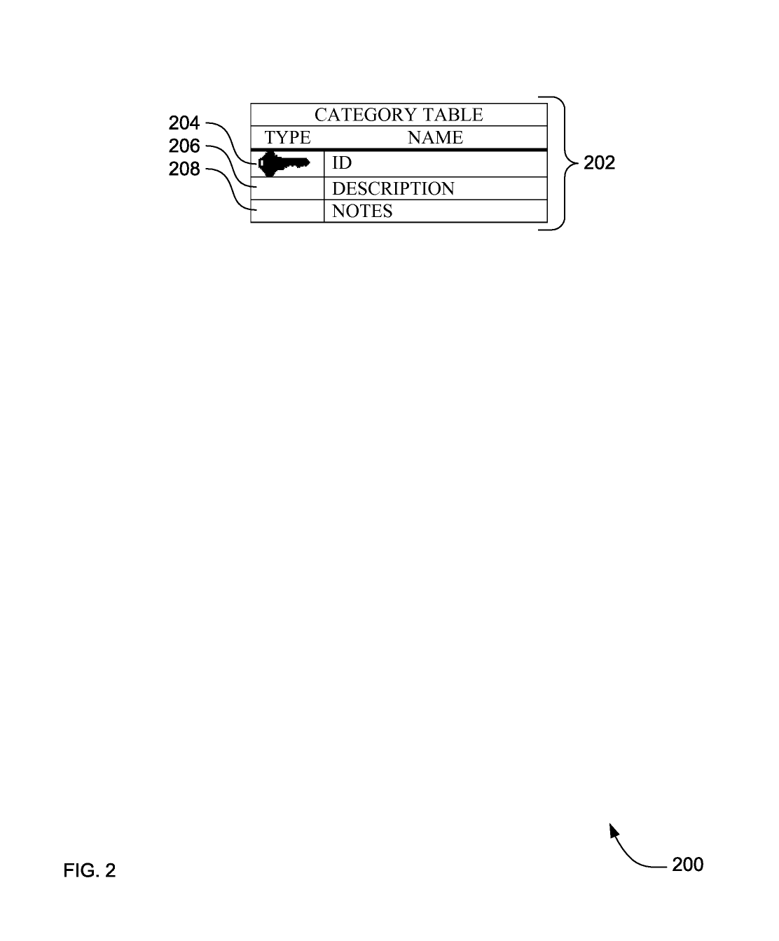

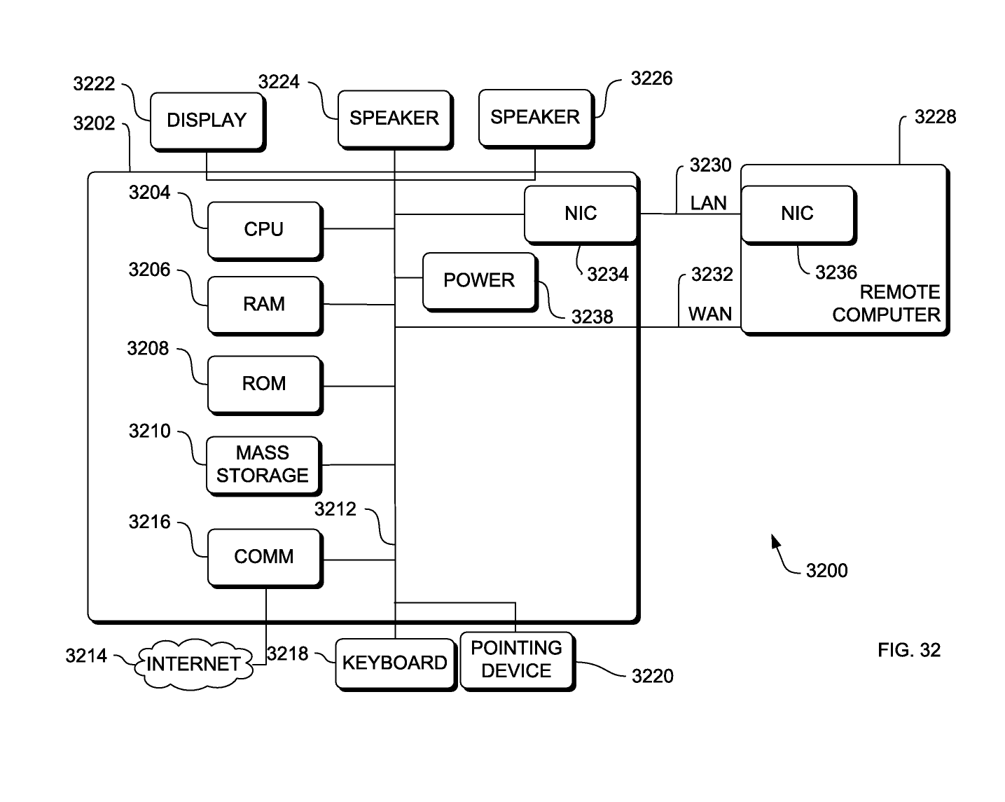

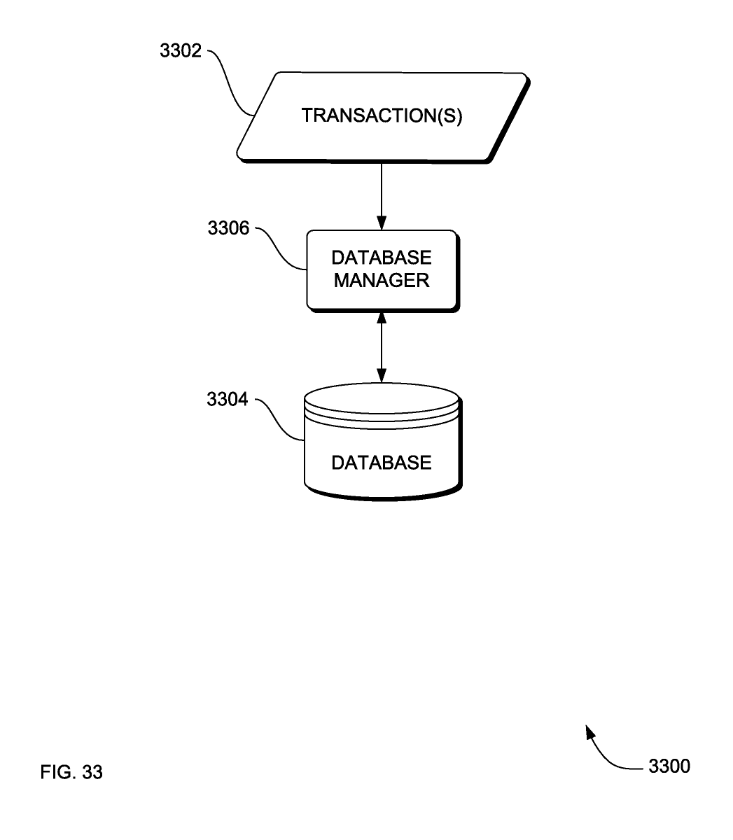

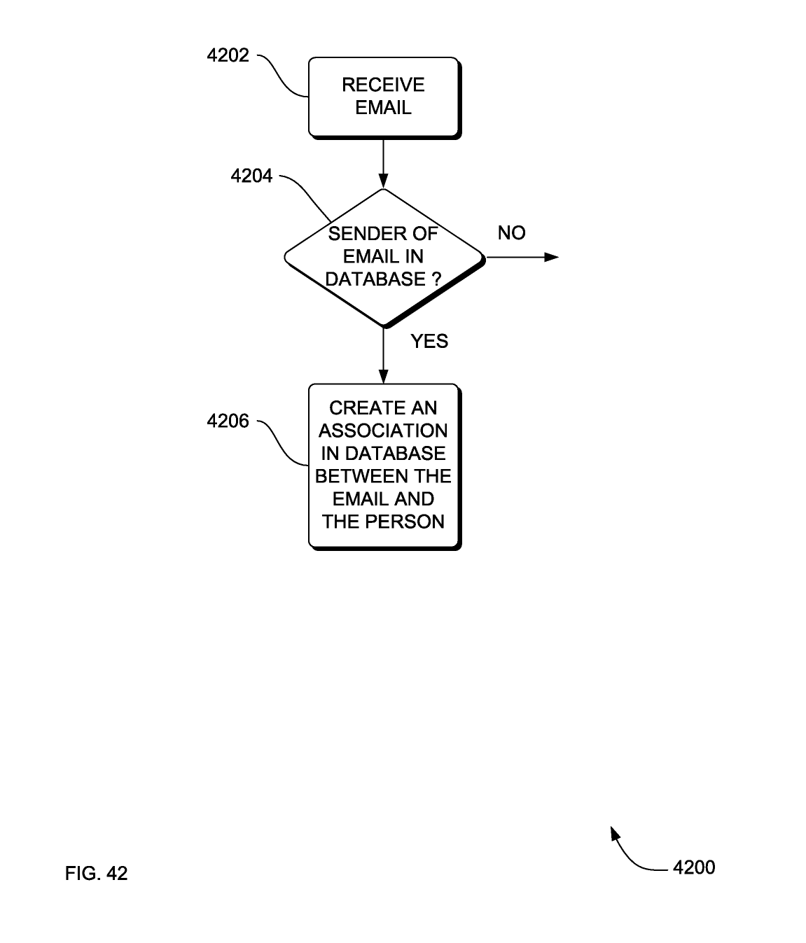

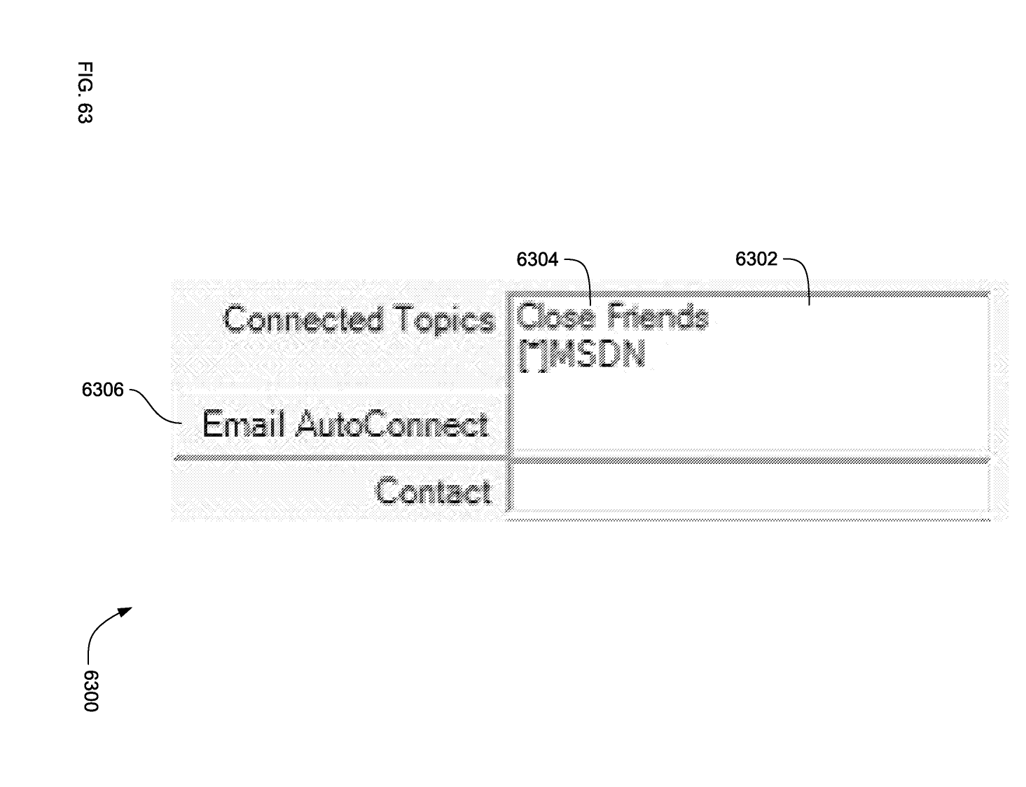

The detailed description is divided into six sections. In the first section FIG. 1, a system level overview is described. In the second section FIGS. 2-31, database table embodiments of apparatus are described. In the third section FIG. 32, a hardware and operating environment in which embodiments may be practiced is described. In the fourth section FIGS. 33-41, database manager embodiments are described. In the fifth section FIGS. 42-61, embodiments of methods and dataflow diagrams are described. The the sixth section FIGS. 63-72, embodiments of graphical user interfaces are described. Finally, in the seventh section, a conclusion of the detailed description is provided.

### System Level Overview

FIG. 1 is a block diagram that provides an overview of a system to provide a reliable apparatus of managing email data. System 100 solves the need in the art for an operationally stable email client

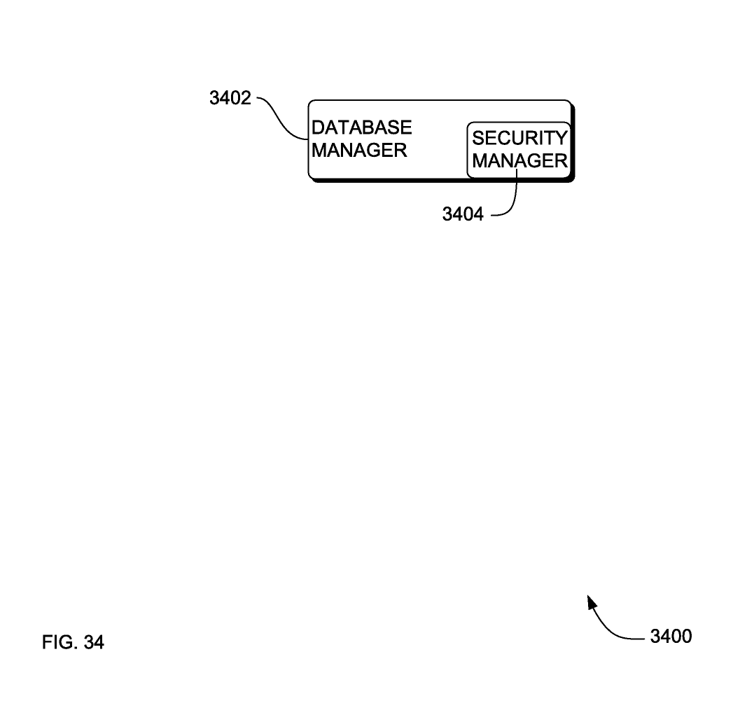

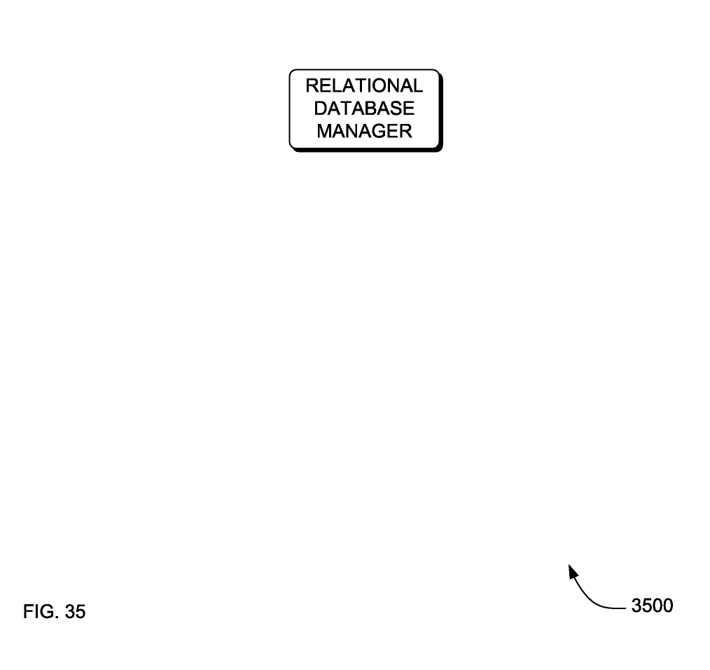

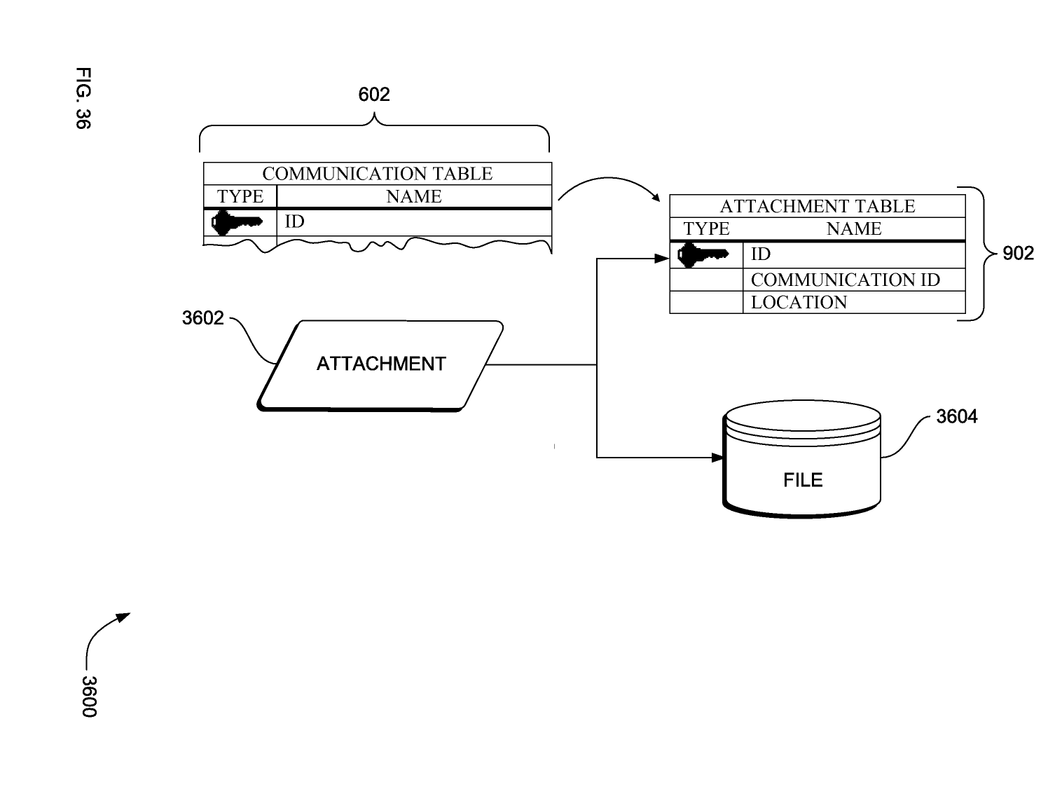

System 100 includes a storing software component 102 that is operable to store email data 104 through an interface to database manager 106. The database manager 106 provides a stable data storage environment for the email data 104. FIG. 33 below shows an embodiment in which the database manager provides a stable data storage environment through a transaction-based architecture. FIG. 34 below shows an embodiment in which the database manager provides a stable data storage environment through a high level security manager. FIG. 35 below shows an embodiment in which a relational database manager provides a stable data storage environment. In some embodiments, the format of the email data 104 is defined and prescribed in the Request for Comments published by the Internet Engineering Task Force at 1895 Preston White Drive, Suite 100, Reston, Va. 20191.

System 100 also includes a retrieving software component 108 that is operable to retrieve email data 110 through the interface 106 to a database manager. The storing software component 102 and the retrieving software component 108 are adapted to communicate with the interface 106 to a database manager.

The interface 106 to a database manager in some embodiments is a separate component from the storing software component 102 and the retrieving software component 108 as shown to the extent that the interface 106 to a database manager is separately installed on a computer that operates system 100. However, in other embodiments not shown, the interface 106 to a database manager is a component of system 100 to the extent that the interface 106 to a database manager is installed on a computer with the storing software component 102 and the retrieving software component 108.

Managing email data 104 and 110 through the interface to a database manager 106 provides an operationally stable system of managing email data 104 and 110.

In some embodiments, the software components 102 and 108 are more generally apparatus, such as computer hardware circuitry. System 100 operates in a multi-processing, multi-threaded operating environment on a computer, such as computer 3202 in FIG. 32.

While the system 100 is not limited to any particular storing software component 102, retrieving software component 108 or an interface 106 to database manager, for sake of clarity a simplified storing software component 102, retrieving software component 108 and interface 106 to a database manager are described.

### Database Table Embodiments

In the previous section, a system level overview of the operation of an embodiment is described. In this section, the particular database implementations of such an embodiment are described. Describing the database implementations by reference to database table layouts enables one skilled in the art to develop such programs, firmware, or hardware, including such instructions to carry out the methods on suitable computers, executing the instructions from computer-readable media. Table layouts 200-3100 are implemented by software, firmware and/or hardware that is a part of, a computer, such as computer 3202 in FIG. 32.

FIG. 2 is a diagram of a table layout data structure 200 to manage categories.

Table layout data structure 200 includes a table representing categories 202. Each record of the category table 202 includes an indexed key field representing an identification of a category 204, a text field representing a description of the category 206 and a text field representing a note on the category 208. Categories are groups or associations. Examples of categories are “Friday evening Volleyball Group” or “Mayoral campaign” or “heaven.” Categories are more generally any relationship.

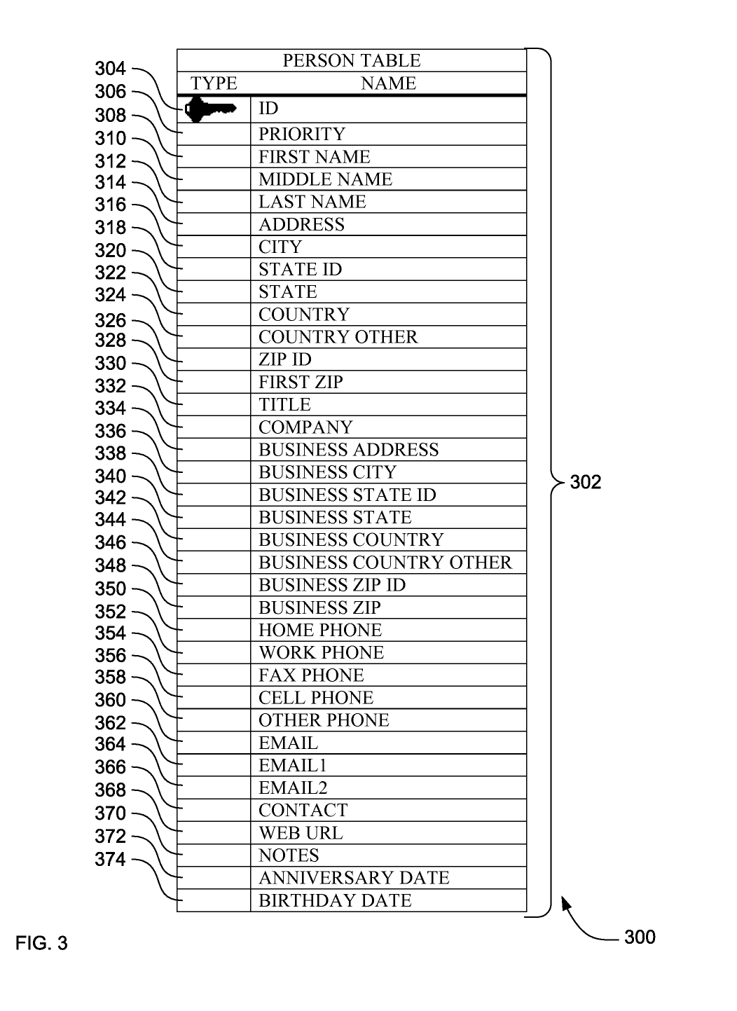

FIG. 3 is a diagram of a table layout data structure 300 to manage persons.

Table layout data structure 300 includes a table representing persons 302. Each record of the persons table 302 includes an indexed key field representing an identification of a person 304.

Other embodiments of the persons table 302 include any combination of the following: A field representing a priority 306 of the person, a field representing a first name 308 of the person, a field representing a middle name 310 of the person, a field representing a last name 312 of the person, a field representing an address 314 of the person, a field representing a city 316 of the person, a field representing a state identification 318 of the person, a field representing a state 320 of the person, a field representing a country 322 a field representing a country other 324 of the person, a field representing a zip code identification 326 of the person, a field representing a zip code 328 of the person, a field representing a title 330 of the person, a field representing a company name 332 of the person, a field representing a business address 334 of the person, a field representing a business city 336 of the person, a field representing a business state identification 338 of the person, a field representing a business state 340 of the person, a field representing a business country 342 of the person, a field representing a business country other 344 of the person, a field representing a business zip code identification 346 of the person, a field representing a business zip code 348 of the person, a field representing a home phone 350 of the person, a field representing a work phone 352 of the person, a field representing a fax number 354 of the person, a field representing a cell phone number 356 of the person, a field representing an other phone 358 of the person, a field representing a first email address 360 of the person, a field representing a second email address 362 of the person, a field representing a third email address 364 of the person, a field representing a contact 366 of the person, a field representing an Internet URL 368 of the person, a field representing a notes 450 of the person, a field representing an anniversary date 372 and a field representing a birthday date 374.

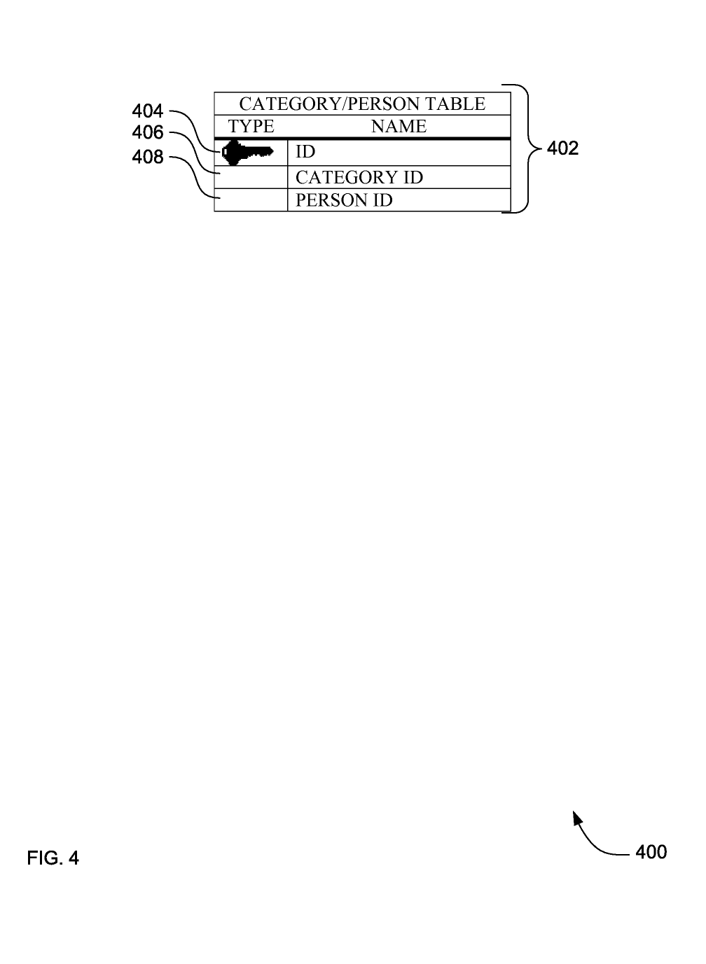

FIG. 4 is a diagram of a table layout data structure 400 to manage category and person relationships.

Table layout data structure 400 includes a table representing category/person relationships 402. Each record of the category/person table 402 includes an indexed key field representing an identification of category/person 404, a field representing a description of the category identification 406 and a text field representing a person identification 408. The table layout data structure 400 that includes a table representing category/persons 402 provides a relationship between categories and persons. Some embodiments of table layout data structure 400 includes a field representing autocompletion which stores an indication as to whether or not one or none categories are selected for auto connection for a person. This indication relies upon a many-to-many relationship between person and category tables, so that one person can easily access the categories to which that the person is connected.

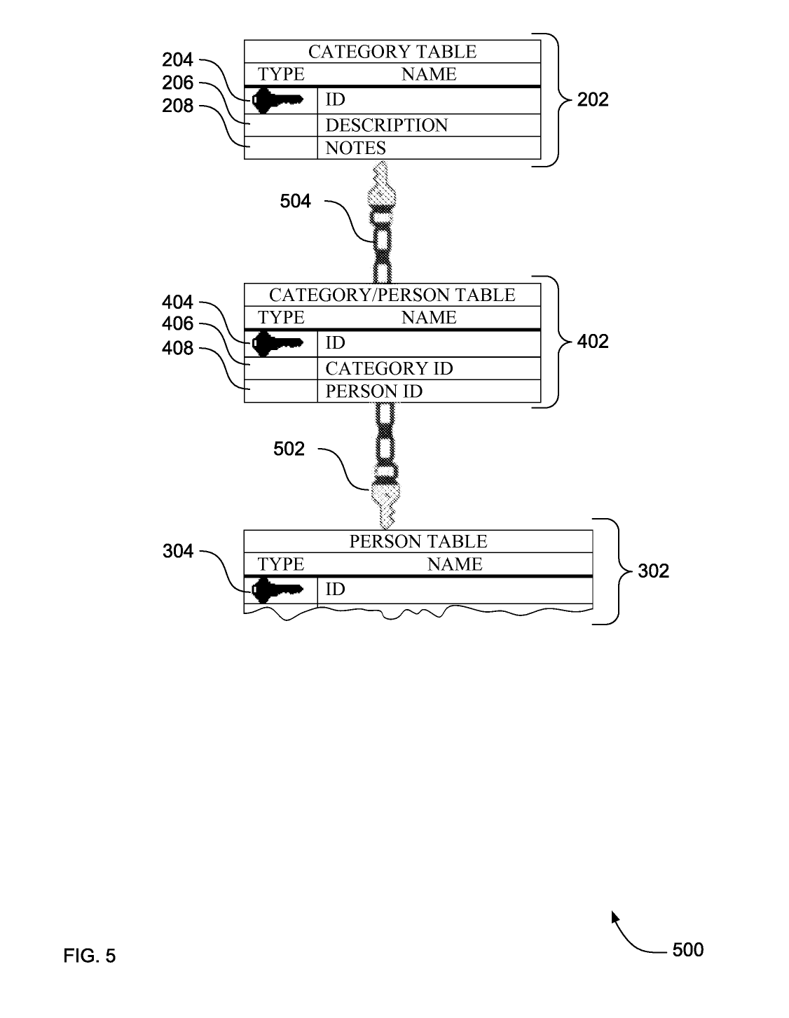

FIG. 5 is a diagram of a data structure 500 to manage category and person relationships. Table layout data structure 500 includes a table representing categories 202, a table representing persons 302 and a table representing category and person relationships 402. The category/person relationships table 402 provides a path through which persons are associated with category data. The persons table 302 has a one-to-many relationship with the category/person relationships table 402 as indicated by the connection 502 and the category table 202 has one-to-many relationship with the category/person relationships table 402 as indicated by the connection 504.

In table layout data structure 500, the category/person relationships table 402 acts an intermediary table that provides many-to-many associations between the categories table 202 and the persons table. This provides a many-to-many relationship between persons and categories. Any person, and any number of persons, can be associated with any category or any number of categories.

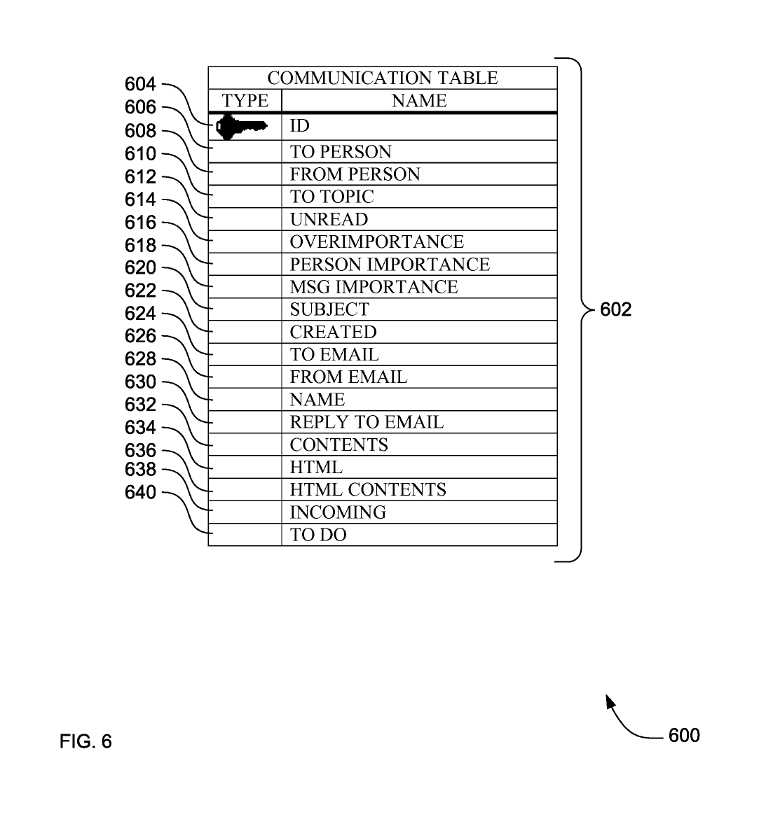

FIG. 6 is a diagram of a table layout data structure 600 to manage communications. In some embodiments, the communication is an email communication.

Table layout data structure 600 includes a table representing communications 602. Each record of the communication table 602 includes an indexed key field representing an identification of a communication 604, a field representing a identification of a person to whom the communication was sent 606, a field representing an identification of a person from whom the communication was sent 608, a field representing a topic of the communication 610, a field representing a read/unread status of the communication 612, a field representing an over importance of the communication 614, a field representing an importance of the person of the communication 616, a field representing an importance of the communication 618, a field representing a subject of the communication 620, a field representing a creation date the communication 622, a field representing a “to” email address of the communication 624, a field representing a “from” email address of the communication 626, a field representing a name of the communication 628, a field representing a reply address of the communication 630, a field representing a contents or body of the communication 632, a field representing a HTML status of the communication 634, a field representing a HTML contents status of the communication 636, a field representing an incoming status of the communication 638, and a field representing a ‘to do” status of the communication 640. The contents field 632 stores the text of the body of the email communication. The HTML contents 636 stores the HTML tags and text of the email communication.

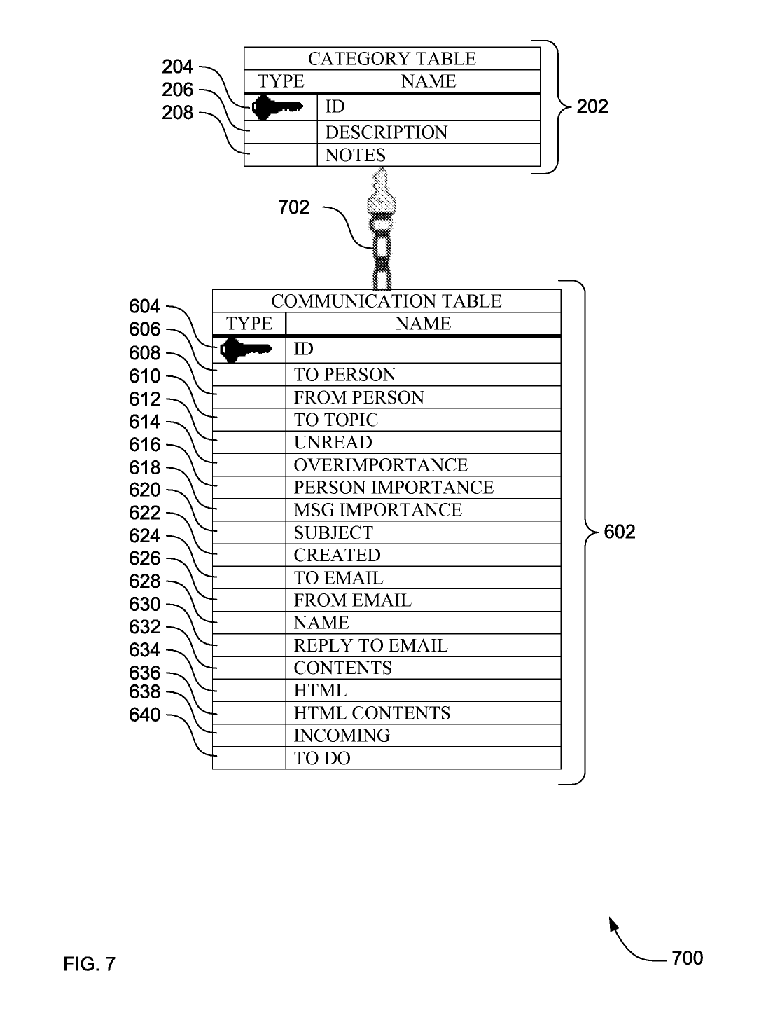

FIG. 7 is a diagram of a data structure 710 to manage category and communications relationships.

Table layout data structure 700 includes a table representing categories 202, and a table representing communications 602. The category table 202 has a one-to-many relationship with the communications table 602 as indicated by the connection 702.

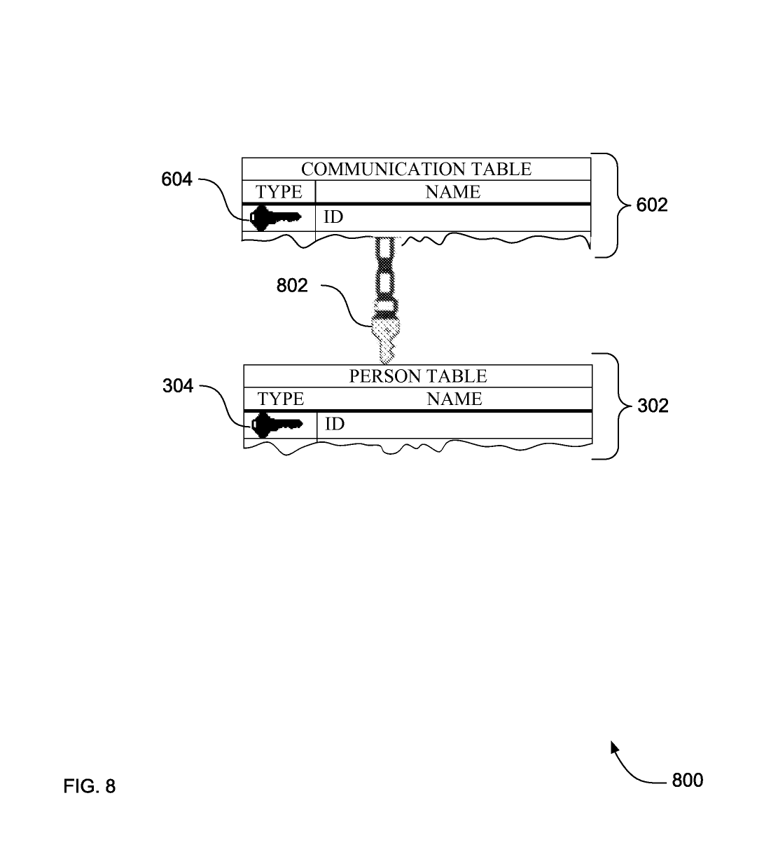

FIG. 8 is a diagram of a data structure 800 to manage persons and communications relationships.

Table layout data structure 800 includes a table representing persons 302, and a table representing communications 602. The persons table 302 has a one-to-many relationship with the communications table 602 as indicated by the connection 802.

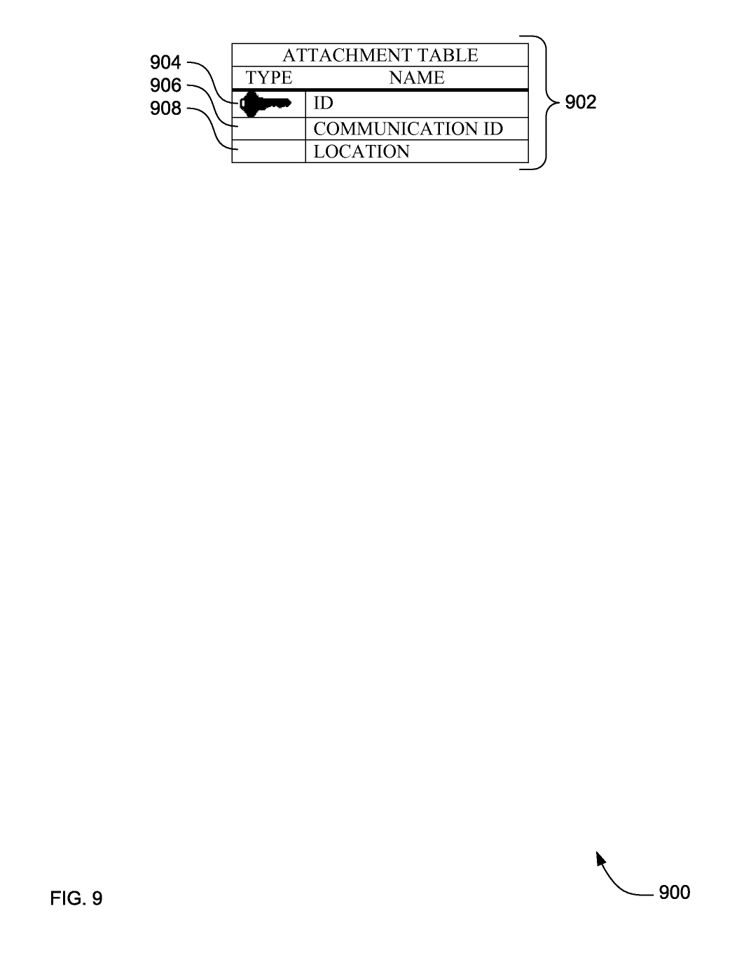

FIG. 9 is a diagram of a table layout data structure 900 to manage attachments. Table layout data structure 900 solves the need in the art for more storage of email data including attachments, without having to resort to archival files.

Table layout data structure 900 includes a table representing attachments 902. Each record of the attachments table 902 includes an indexed key field representing an identification of an attachment 904, a text field representing a communication identification 906 and a field representing a location of the attachment 908. In some embodiments, the communication is an email. In some embodiments, the location 908 is a full path name such as “C:\\USERFILES\ATTACHMENT04340.DOC”.

In some embodiments, the location 908 is outside the email database. The attachments table 902 provides a means to locate attachments that are stored separately from the email database. Thus the attachments table 900 supports storage of attachments outside of the email database, which allows the only the emails to be stored in the email database, which in turn reduces, if not eliminates, the amount of storage in the email database required to store attachments. This allows many more emails to be stored in the email database and the attachments to be stored elsewhere, such as on the disk drive of the computer, which has a tremendously larger amount of storage space. For example, on a computer running the Microsoft Windows® operating system, the maximum file size of an email database file is often two gigabytes, while the computer will often have ten to sixty gigabytes of unused hard disk space. Storing the attachments in the unused hard disk space separately from the email database not only provides a means to make the much larger amount of unused disk space available to store attachments, but also provides a means to use the email database only for emails, which allows more emails to be stored in the email database. Thus attachment table 900 solves the need in the art for more storage for email data including attachments, without having to resort to archival files.

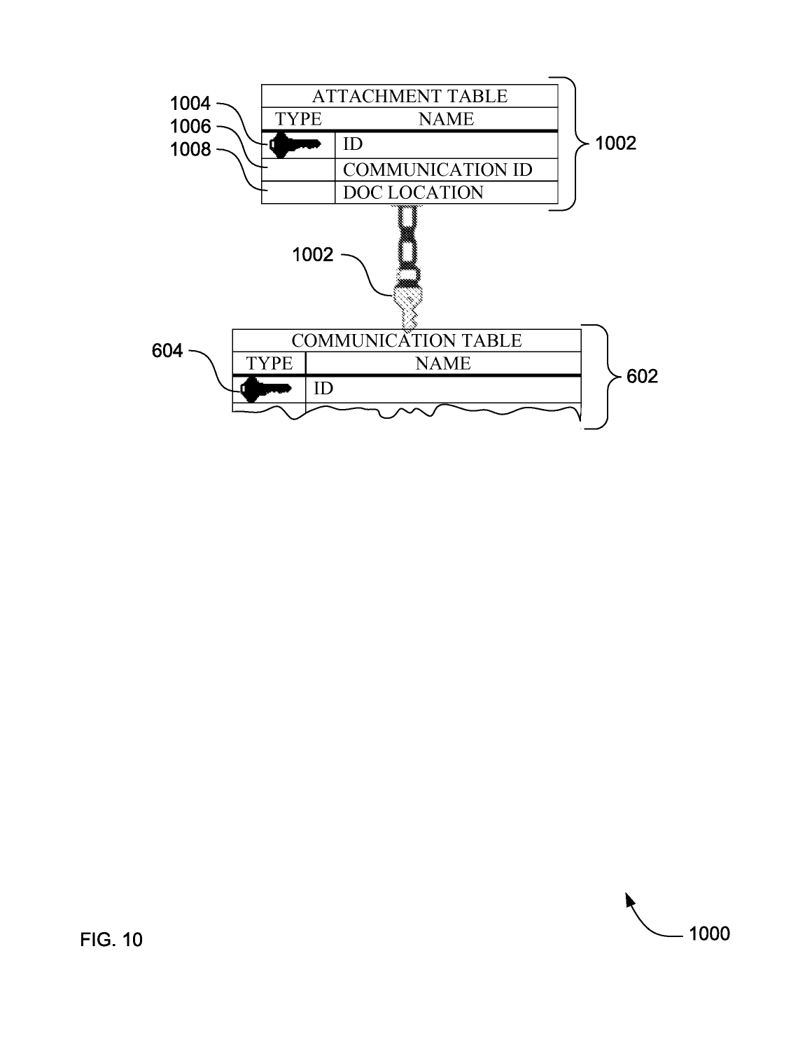

FIG. 10 is a diagram of a data structure 1000 to manage communications and attachment relationships.

Table layout data structure 1000 includes a table representing attachments 902, and a table representing communications 602. The communications table 602 has a one-to-many relationship with the attachments table 902 as indicated by the connection 1002.

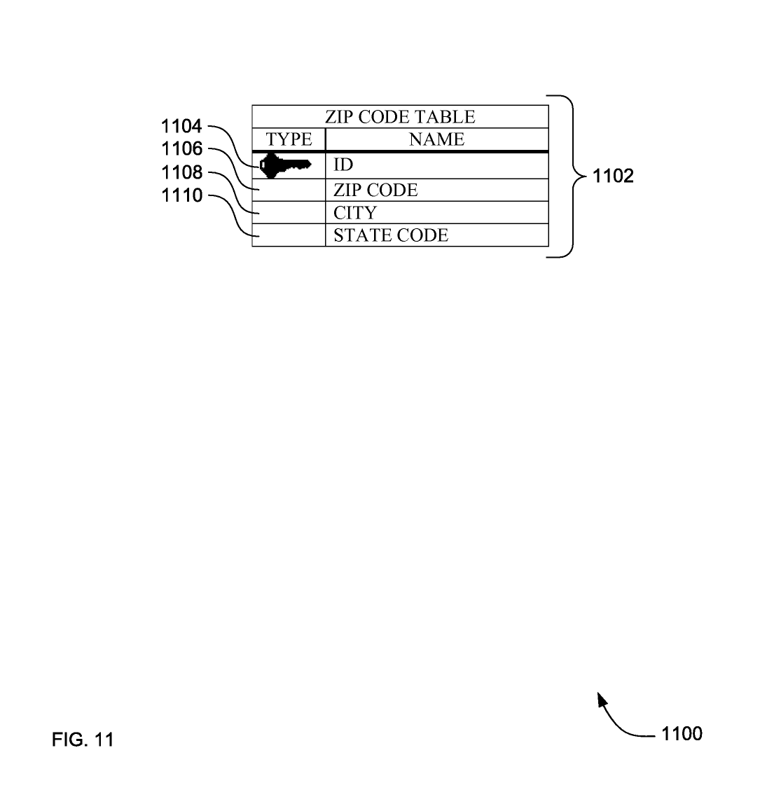

FIG. 11 is a diagram of a table layout data structure 1100 to manage zip codes.

Table layout data structure 1100 includes a table representing zip codes 1102. Each record of the zip code table 1102 includes an indexed key field representing an identification of a zip code 1104, a field representing a zip code 1106, a field representing a city of the zip code and a field representing state of the zip code 1110.

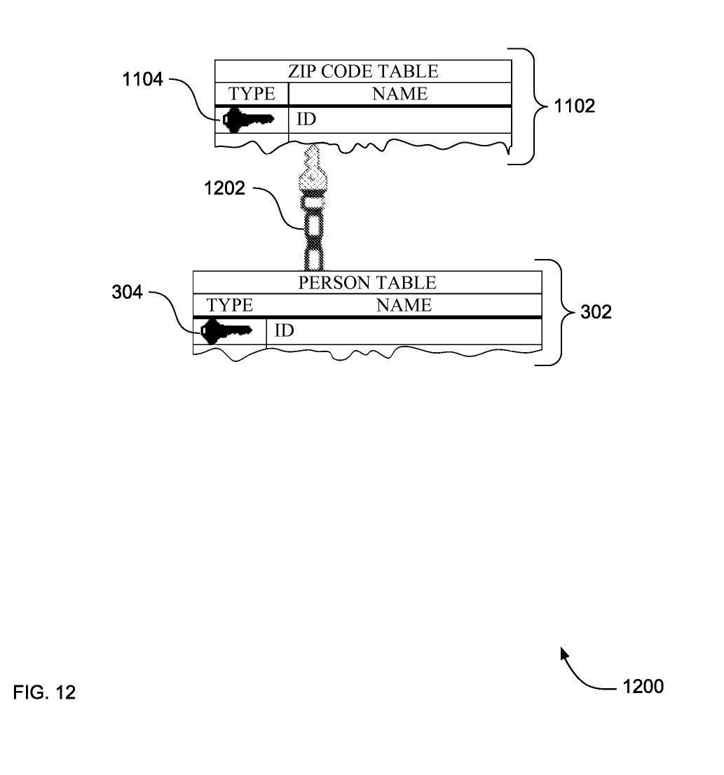

FIG. 12 is a diagram of a data structure 1200 to manage persons and zip code relationships.

Table layout data structure 1200 includes a table representing persons 302, and a table representing zip codes 1102. The zip code table 1102 has a one-to-many relationship with the persons table 302 as indicated by the connection 1202.

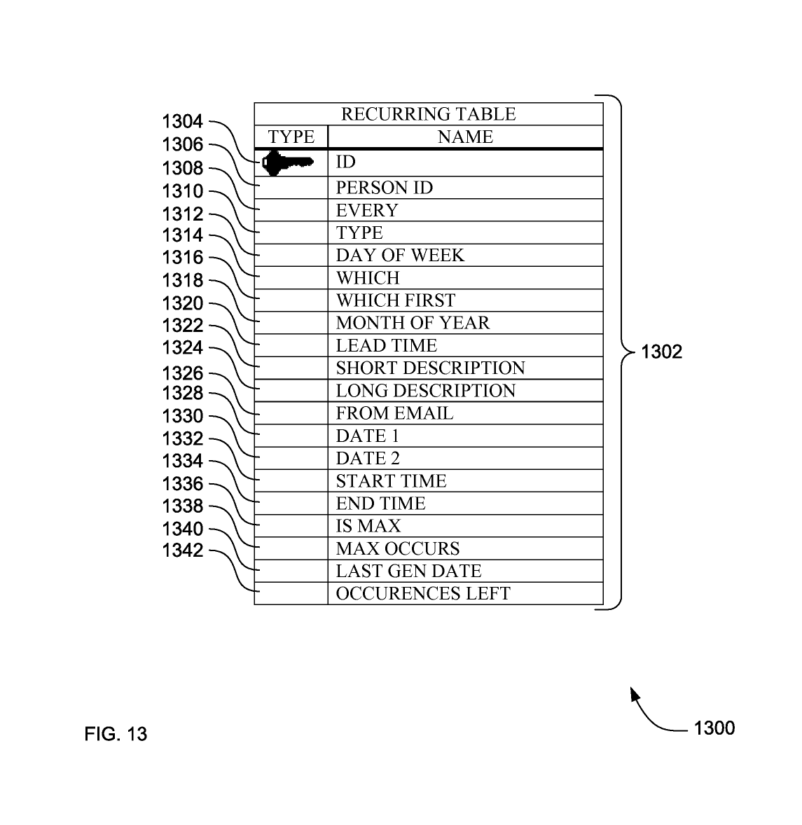

FIG. 13 is a diagram of a table layout data structure 1300 to manage recurrences.

Table layout data structure 1300 includes a table representing recurrences 1302. Each record of the recurring table 1302 includes an indexed key field representing an identification of a recurrence 1304.

Other embodiments of the recurring table 1302 include any combination of the following: A field representing a person identification 1306, a field representing a period of recurrence 1308, a field representing a type of recurrence 1310, a field representing a day of the week of the recurrence 1312, a field representing a which of the recurrence 1314, a field representing a which first of the recurrence 1316, a field representing a month of the recurrence 1318, a field representing a lead time of the recurrence 1320, a field representing a short description of the recurrence 1322, a field representing a long description of the recurrence 1324, a field representing a from email address of the recurrence 1326, a field representing a first date of the recurrence 1328, a field representing a second date of the recurrence 1330, a field representing a start time of the recurrence 1332, a field representing an end time of the recurrence 1334, a field representing a maximum status of the recurrence 1336, a field representing a maximum occurrences of the recurrence 1338, a field representing a last date that the occurrence was generated 1340, and a field representing a number of remaining occurrences 1342.

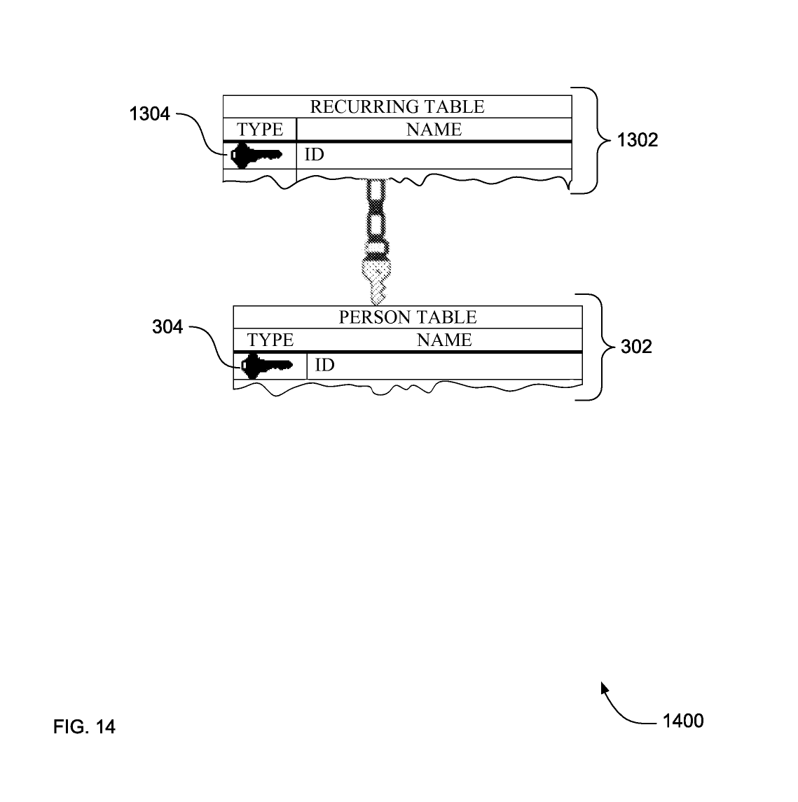

FIG. 14 is a diagram of a data structure 1400 to manage persons and recurrences relationships.

Table layout data structure 1400 includes a table representing persons 302, and a table representing recurrences 602. The persons table 302 has a one-to-many relationship with the recurrences table 602 as indicated by the connection 1402.

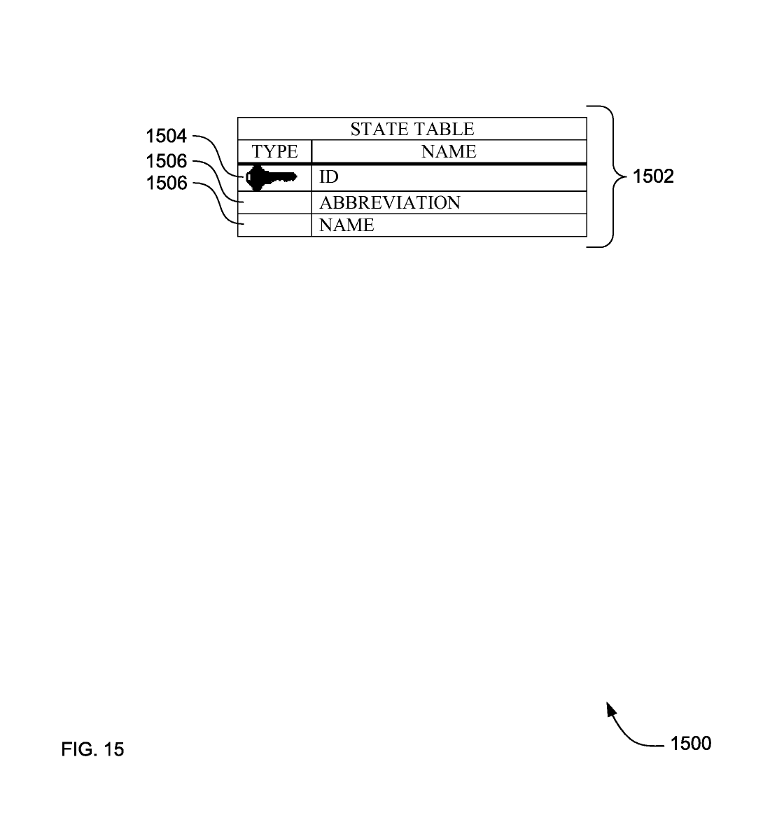

FIG. 15 is a diagram of a table layout data structure 1500 to manage states.

Table layout data structure 1500 includes a table representing states 1502. Each record of the states table 1502 includes an indexed key field representing an identification of a state 1504, a text field representing an abbreviation of the state 1506 and a field representing a name of the state 1508.

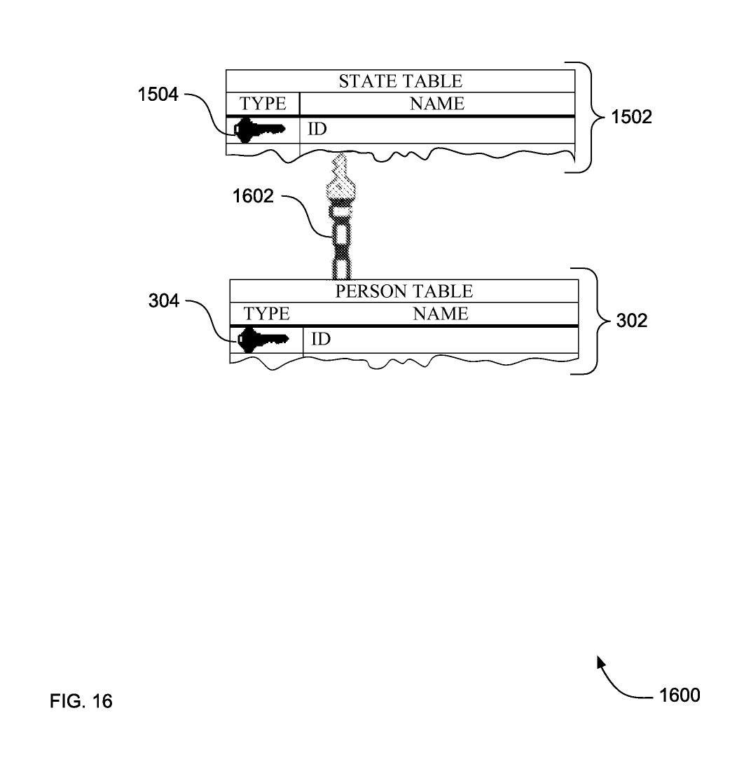

FIG. 16 is a diagram of a data structure 1600 to manage persons and state relationships.

Table layout data structure 1600 includes a table representing persons 302, and a table representing states 1502. The state table 1502 has a one-to-many relationship with the persons table 302 as indicated by the connection 1602.

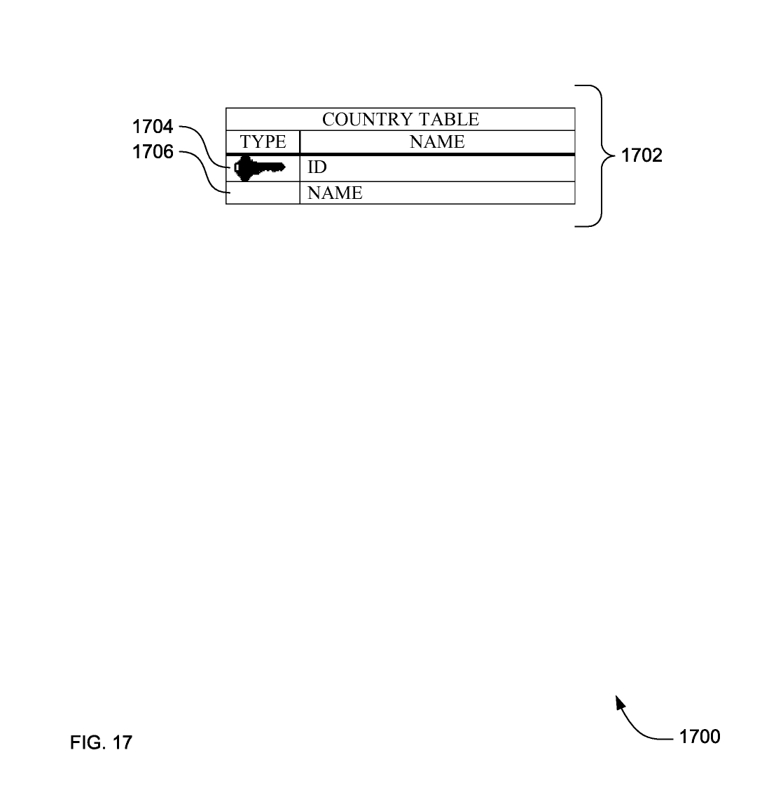

FIG. 17 is a diagram of a table layout data structure 1700 to manage countries.

Table layout data structure 1700 includes a table representing countries 1702. Each record of the country table 1702 includes an indexed key field representing an identification of a country 1704, and a field representing a name of the country 1706.

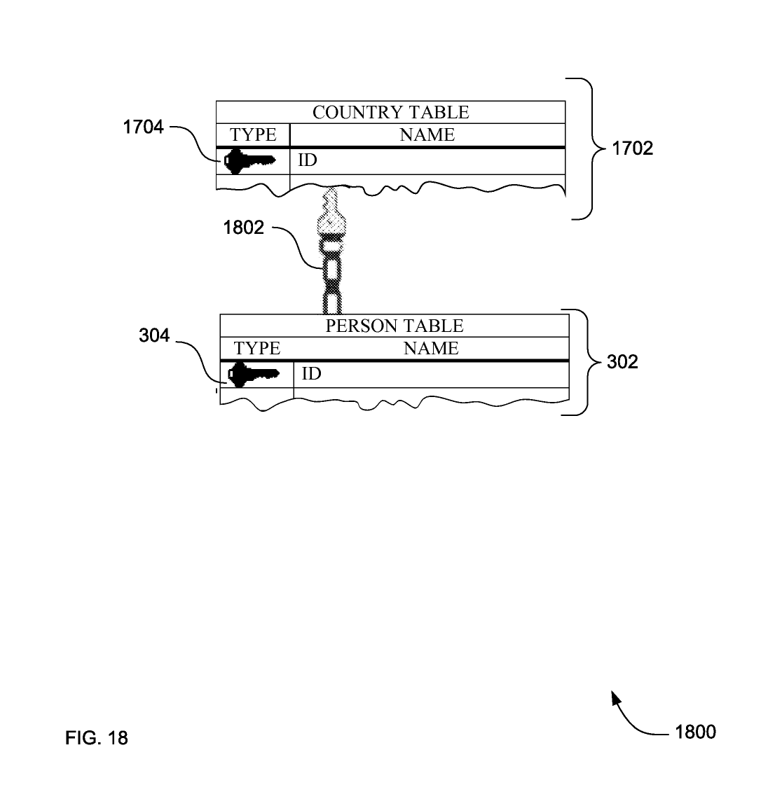

FIG. 18 is a diagram of a data structure 1800 to manage persons and country relationships.

Table layout data structure 1800 includes a table representing persons 302, and a table representing countries 1702. The country table 1702 has a one-to-many relationship with the persons table 302 as indicated by the connection 1802.

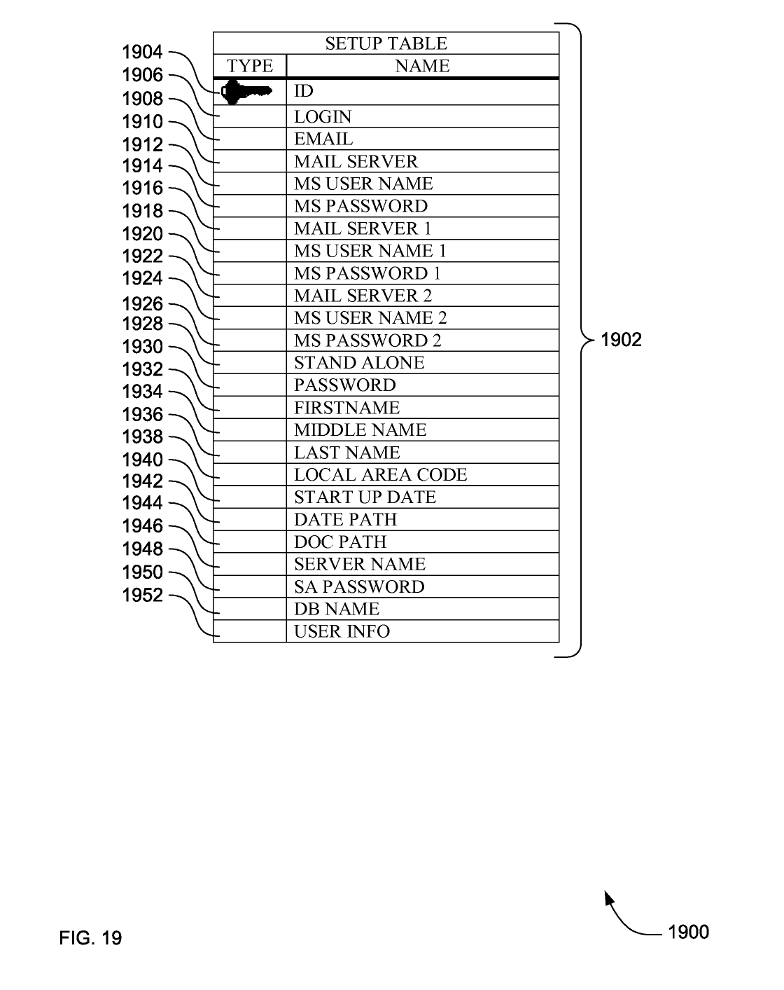

FIG. 19 is a diagram of a table layout data structure 1900 to manage setups.

Table layout data structure 1900 includes a table representing setups 1902. Each record of the setup table 1902 includes an indexed key field representing an identification of a setup 1904.

Other embodiments of the setup table 1902 include any combination of the following: A field representing a login 1906, a field representing an email address 1908, a field representing a first mail server 1910, a field representing a first Microsoft user name 1912, a field representing a first Microsoft password 1914, a field representing a second mail server 1916, a field representing a second Microsoft user name 1918, a field representing a second Microsoft password 1920, a field representing a third mail server 1922 a field representing a third Microsoft user name 1924, a field representing a third Microsoft password 1926, a field representing a standalone status 1928, a field representing a password 1930, a field representing a first name 1932, a field representing a middle name 1934, a field representing a last name 1936, a field representing a local area code 1938, a field representing a start up date 1940, a field representing a date path 1942, a field representing a document path 1944, a field representing a server name 1946, a field representing a super administrator (SA) password 1948, a field representing a database name 1950, and a field representing user information 1952.

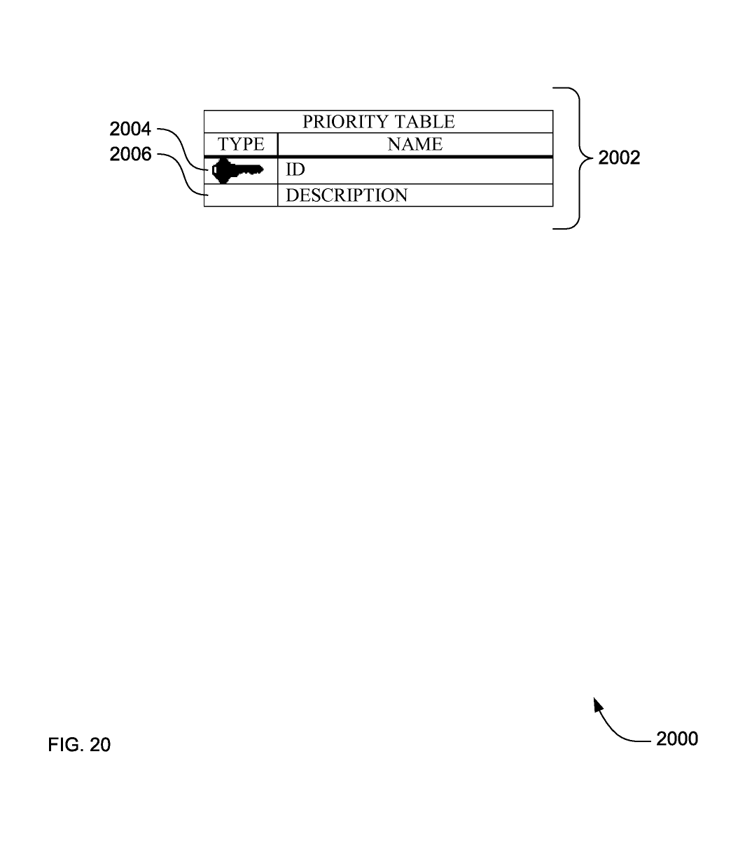

FIG. 20 is a diagram of a table layout data structure 2000 to manage priorities.

Table layout data structure 2000 includes a table representing priorities 2002. Each record of the priority table 2002 includes an indexed key field representing an identification of a priority 2004, and a field representing a description of the priority 2006.

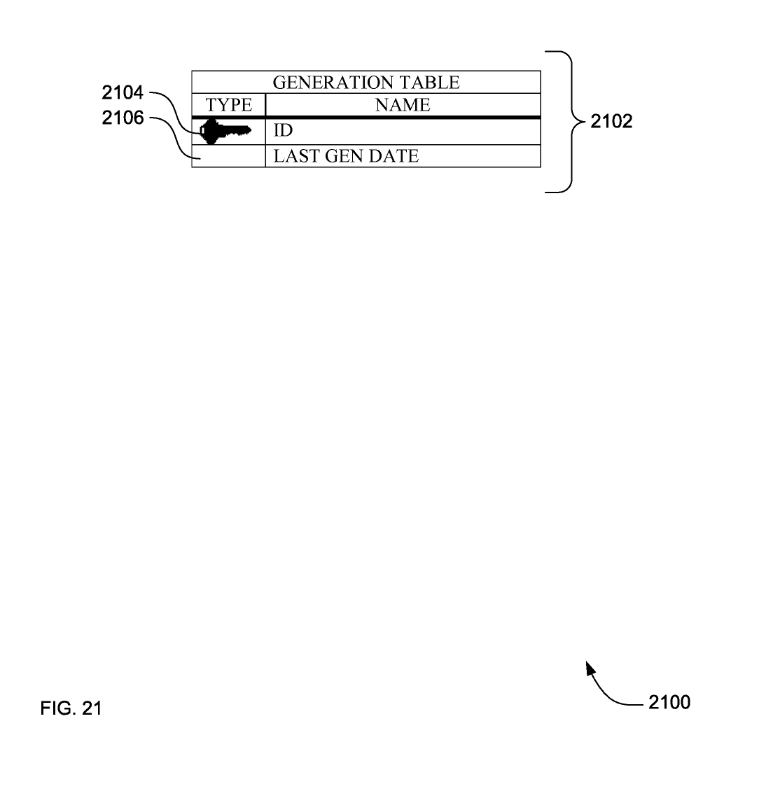

FIG. 21 is a diagram of a table layout data structure 2100 to manage generations.

Table layout data structure 2100 includes a table representing generations 2102. Each record of the priority table 2102 includes an indexed key field representing an identification of a generation 2104, and a field representing a late generation date of the priority 2106.

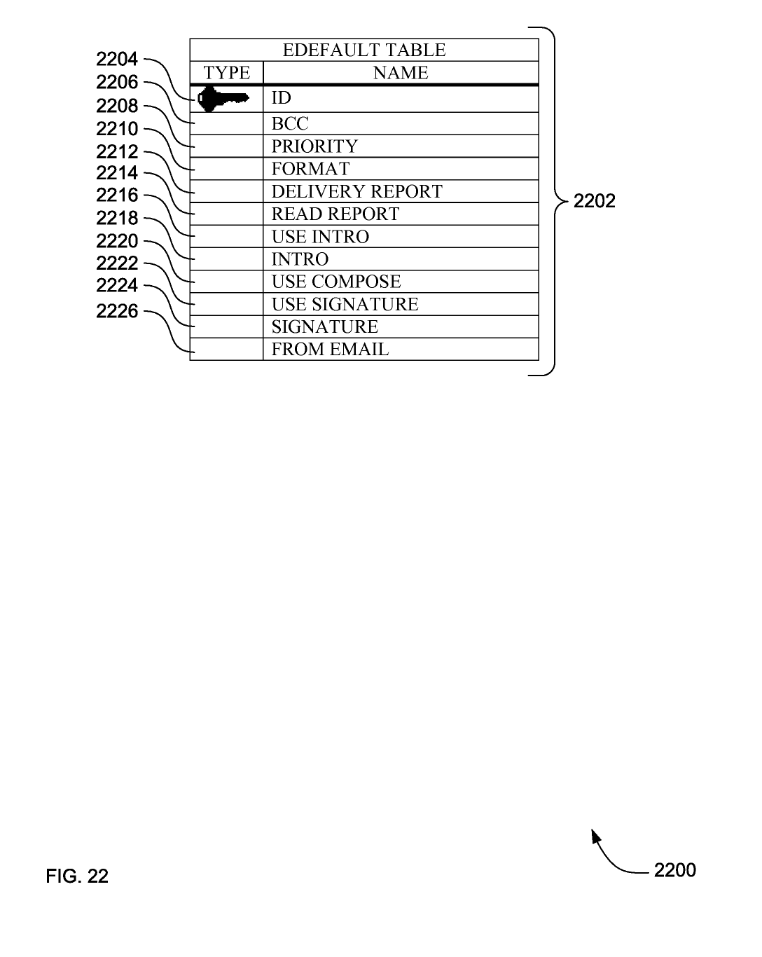

FIG. 22 is a diagram of a table layout data structure 2200 to manage email sending defaults (edefaults).

Table layout data structure 2200 includes a table representing edefaults 2202. Each record of the edefaults table 2202 includes an indexed key field representing an identification of an edefault 2204.

Other embodiments of the edefaults table 2202 include any combination of the following: A field representing a blind-carbon-copy (BCC) 2206, a field representing a priority of the edefault 2208, a field representing a format of the edefault 2210, a field representing a delivery report 2212, a field representing a read report 2214, a field representing a use introduction 2216, a field representing an introduction 2218, a field representing a use compose 2220, a field representing a use signature 2222 a field representing a signature 2224, and a field representing a from email address 2226.

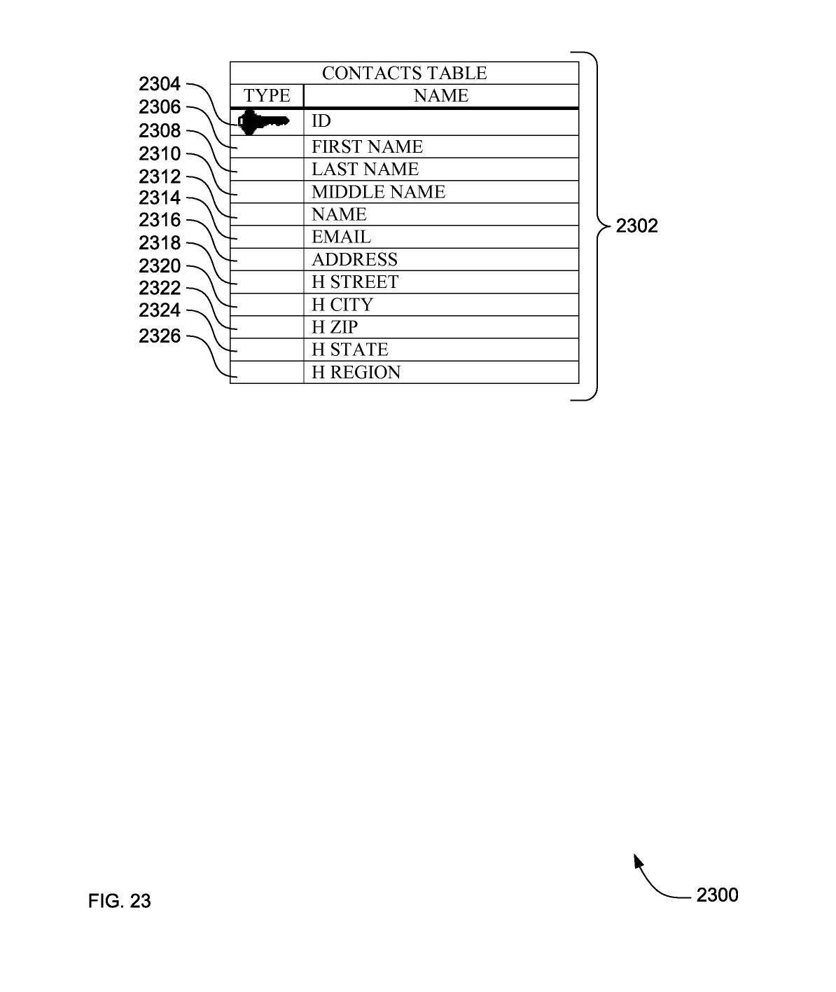

FIG. 23 is a diagram of a table layout data structure 2300 to manage contacts.

Table layout data structure 2300 includes a table representing contacts 2302. Each record of the contacts table 2302 includes an indexed key field representing an identification of a contact 2304.

Other embodiments of the contacts table 2302 include any combination of the following: A field representing a first name 2306, a field representing a last name of the contact 2308, a field representing a middle name of the contact 2310, a field representing a name 2312, a field representing an email address 2314, a field representing an address 2316, a field representing a street 2318, a field representing a city 2320, a field representing a zip code 2322 a field representing a state 2324, and a field representing a region 2326.

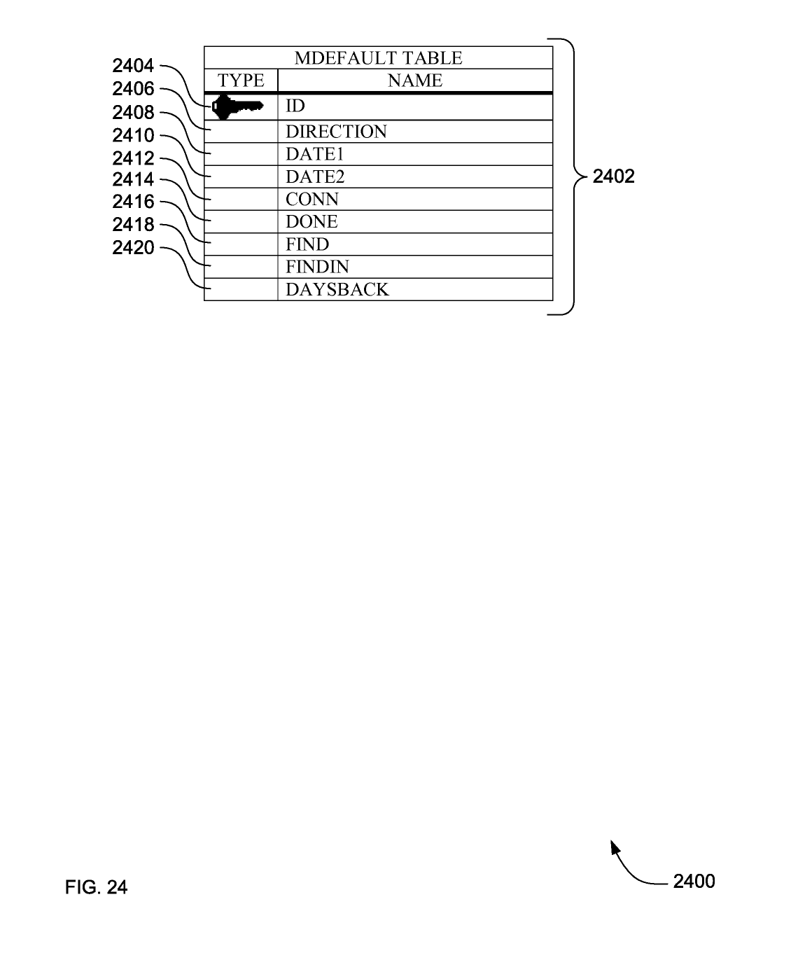

FIG. 24 is a diagram of a table layout data structure 2400 to manage email receiving defaults (mdefaults).

Table layout data structure 2400 includes a table representing mdefaults 2402. Each record of the mdefaults table 2402 includes an indexed key field representing an identification of a mdefault 2404.

Other embodiments of the mdefaults table 2402 include any combination of the following: A field representing a direction 2406, a field representing a first date of the mdefault 2408, a field representing a second date of the mdefault 2410, a field representing a connection 2412, a field representing a done status 2414, a field representing a find status 2416, a field representing a findin status 2418, and a field representing days back 2420.

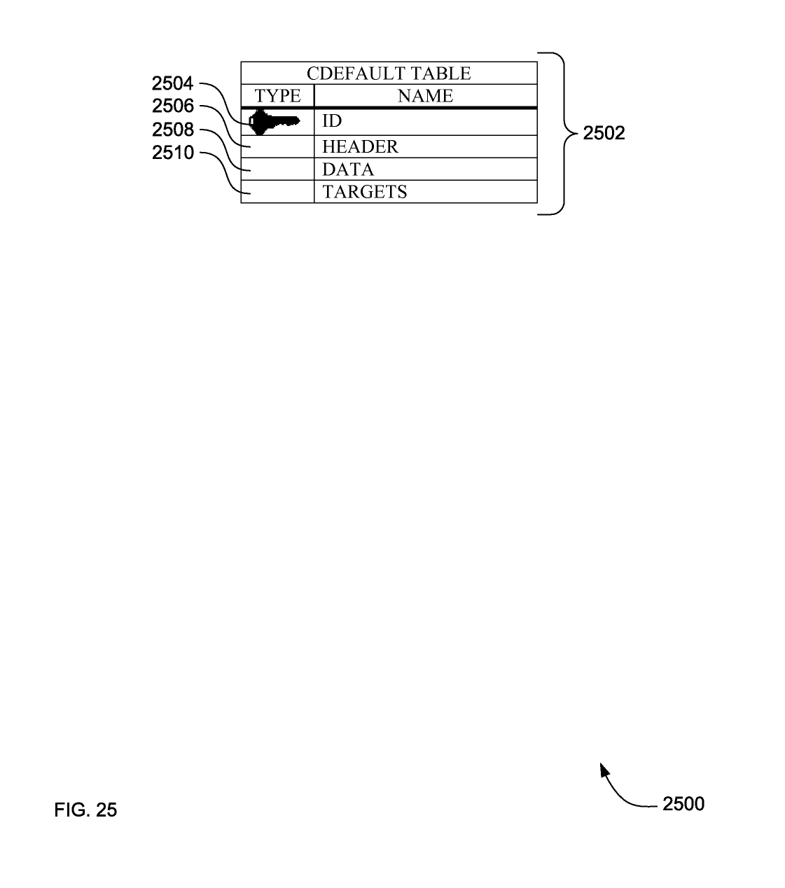

FIG. 25 is a diagram of a table layout data structure 2500 to manage contact defaults (cdcfaults).

Table layout data structure 2500 includes a table representing contact default information 2502. Each record of the contact default table 2502 includes an indexed key field representing an identification of a contact default 2504, a field representing a contact default header 2506, a field representing data of the contact default and a field representing at least one target of the contact default 2510.

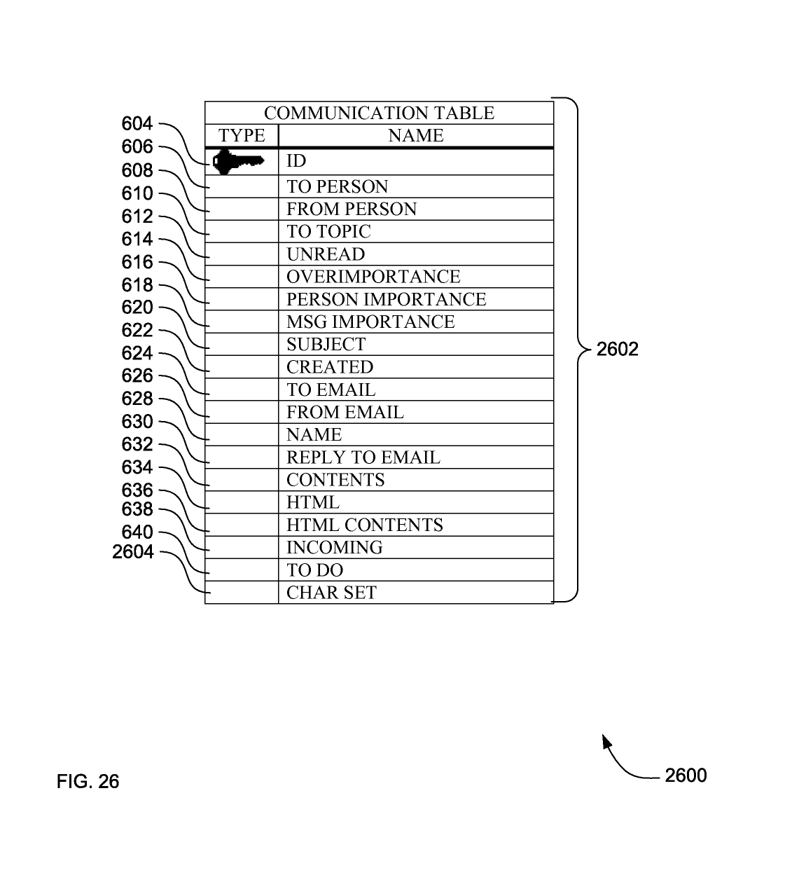

FIG. 26 is a diagram of a table layout data structure 2600 to manage communications. In some embodiments, the communication is an email communication. Table layout data structure 2600 includes a table representing communications 2602. Each record of the communication table 2602 includes a field representing an identification of a character set that that the email contents are encoded.

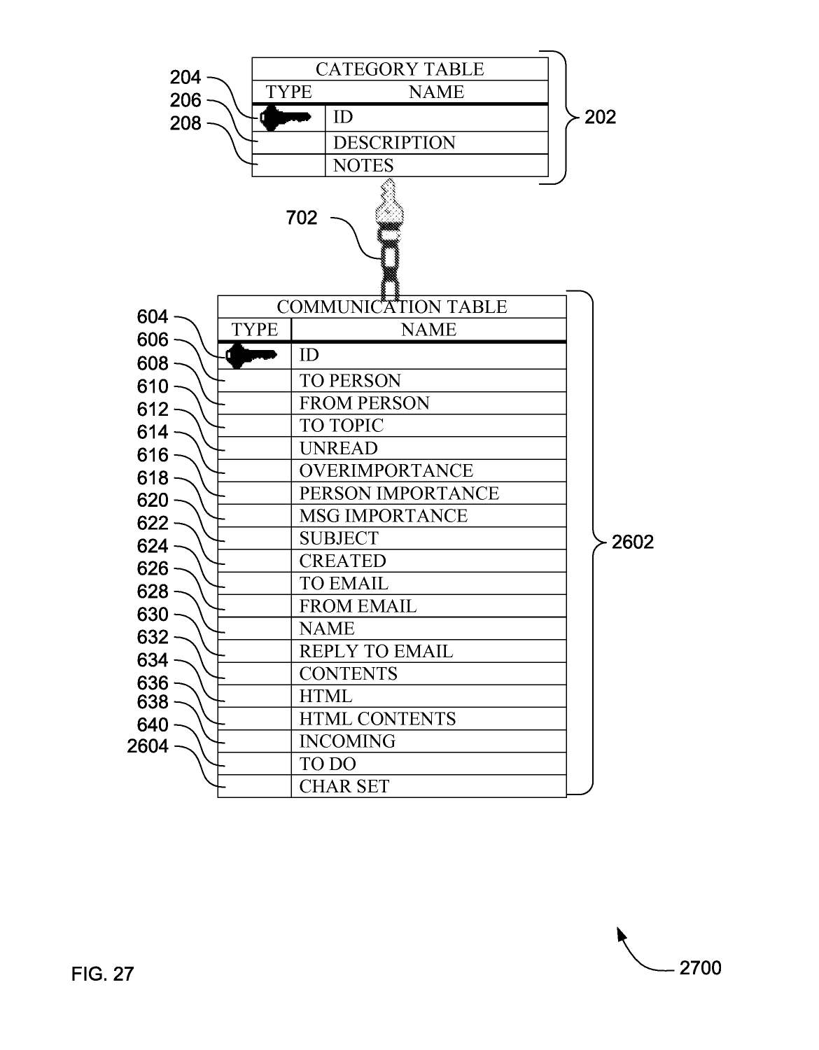

FIG. 27 is a diagram of a data structure 2700 to manage category and communications relationships. Table layout data structure 2700 includes a table representing categories 202, and a table representing communications 2602. The category table 202 has a one-to-many relationship with the communications table 2602 as indicated by the connection 2702.

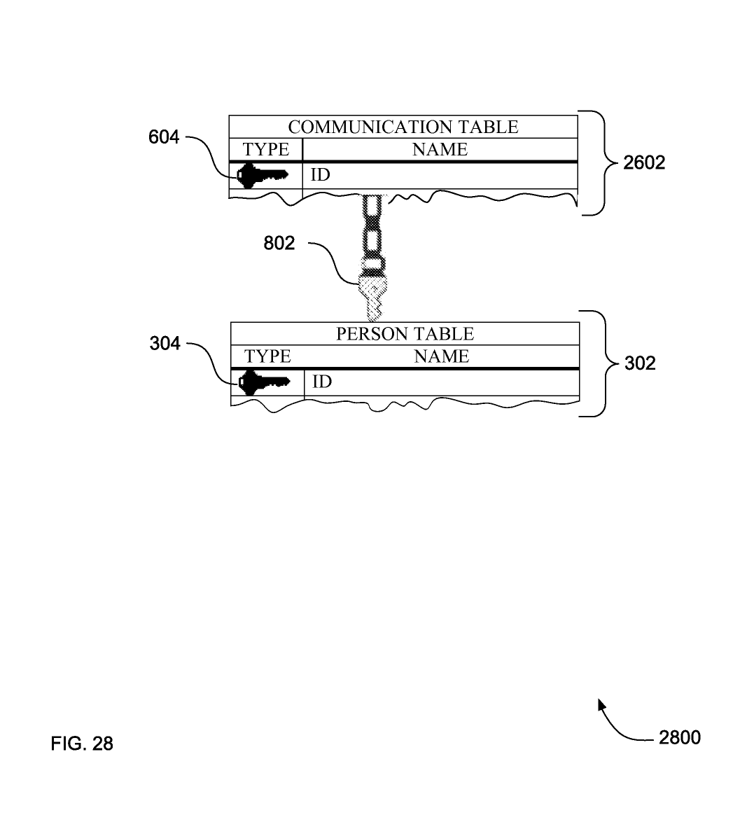

FIG. 28 is a diagram of a data structure 2800 to manage persons and communications relationships. Table layout data structure 2800 includes a table representing persons 302, and a table representing communications 2602. The persons table 302 has a one-to-many relationship with the communications table 2602 as indicated by the connection 2802.

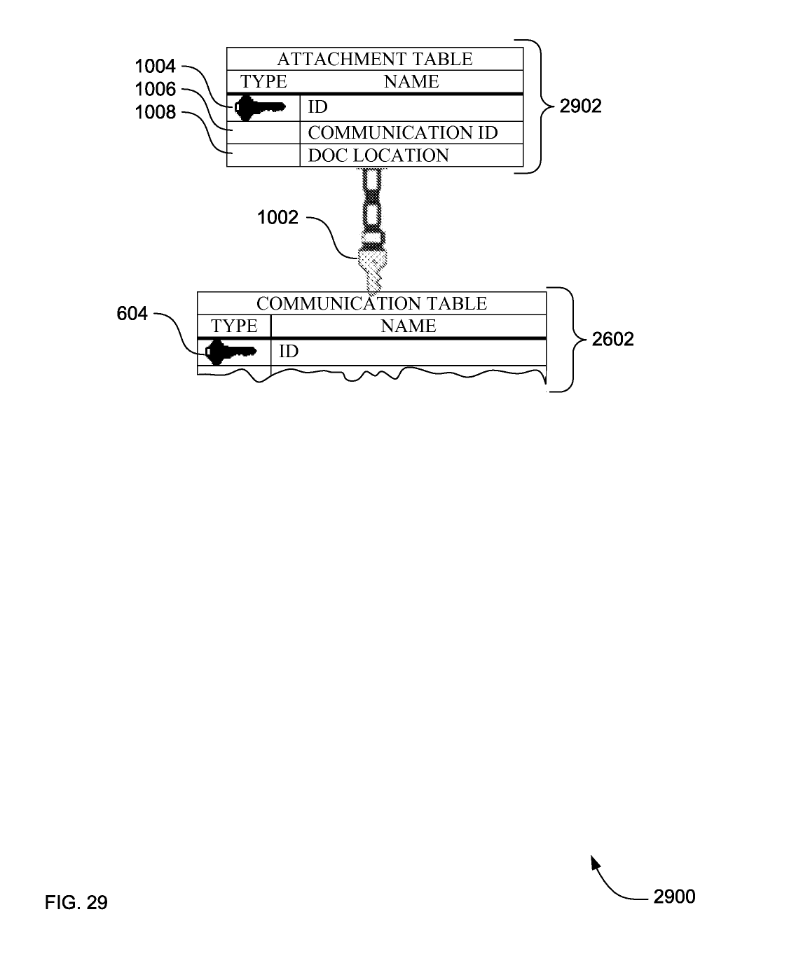

FIG. 29 is a diagram of a data structure 2900 to manage communications and attachment relationships. Table layout data structure 2900 includes a table representing attachments 902, and a table representing communications 2602. The communications table 2602 has a one-to-many relationship with the attachments table 902 as indicated by the connection 2902.

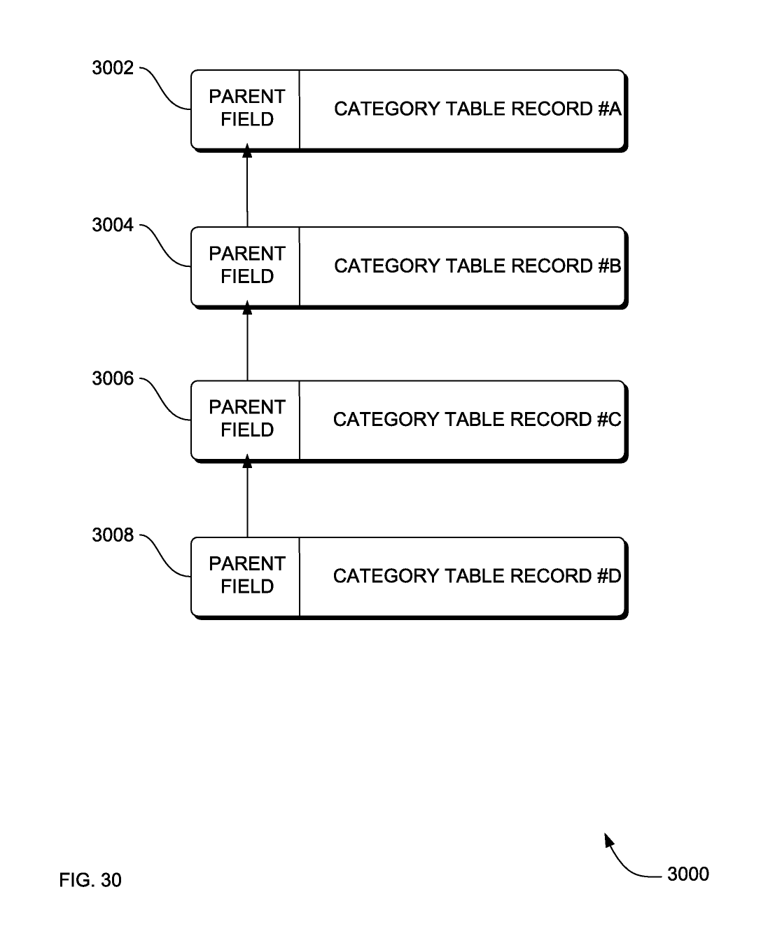

FIG. 30 is a dataflow diagram 3000 to manage email communications according to an embodiment.

Dataflow diagram 3000 provides a flexible hierarchy of categories, the hierarchy providing an unlimited number of levels within the hierarchy of categories. The hierarchy is accomplished by providing a linked list of records in a category table.

In the embodiment of linked category records shown in FIG. 30, all but a final parent record links to the immediate parent record of each category record. In the example shown in FIG. 30, final parent record for category table record #A 3002 is linked by a child category table record #B 3004. This pattern repeats for as many successive child category table records as necessary. More specifically, parent record for category table record #B 3004 is linked by a child category table record #C 3006, parent record for category table record #C 3006 is linked by a child category table record #D 3008.

In some embodiments, dataflow diagram 3000 includes a treeview control (not shown) to manage the hierarchy of category records. The treeview control recursively traverses the hierarchy. In a communication table, records are linked to category records, that are in turn linked to other category records through a parent filed that contains the ID number of the patent category. In a person table, records are linked to categories, but the categories are linked to parent categories through the parent field of the category record.

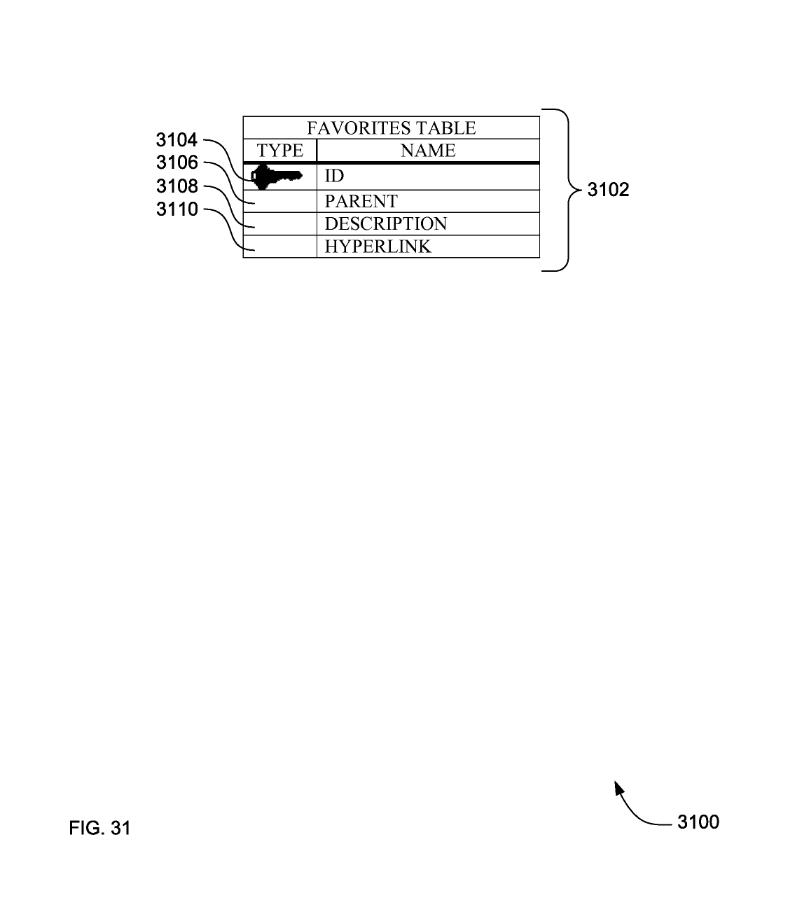

FIG. 31 is a diagram of a table layout data structure 3100 to manage favorites. Table layout data structure 3100 solves the need in the art manage recurring events with the advantages of conventional systems.

Table layout data structure 3100 includes a table representing favorites 3102. Each record of the favorites table 3102 includes an indexed key field representing an identification 3104 of the favorite, a field representing a parent 3106 of the favorite, a field representing a description 3106 of the favorite and a field representing a hyperlink of the favorite 3110. In some embodiments, the ID 5614 is an integer of 4 bytes length, the parent 3106 is an integer of 4 bytes length, the description is a character field of 40 bytes length and the hyperlink is an integer of 4 bytes length. In some embodiments, the distinction between a favorite hyperlink and a Favorite Group is that the hyperlink 3110 of a favorite group is null.

### Hardware and Operating Environment

FIG. 32 is a block diagram of a hardware and operating environment 3200 in which different embodiments can be practiced. The description of FIG. 32 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Computer 3202 includes a processor 3204, commercially available from Intel, Motorola, Cyrix and others. Computer 3202 also includes random-access memory (RAM) 3206, read-only memory (ROM) 3208, and one or more mass storage devices 3210, and a system bus 3212, that operatively couples various system components to the processing unit 3204. The memory 3206, 3208, and mass storage devices, 3210, are types of computer-accessible media. Mass storage devices 3210 are more specifically types of nonvolatile computer-accessible media and can include one or more hard disk drives, floppy disk drives, optical disk drives, and tape cartridge drives. The processor 3204 executes computer programs stored on the computer-accessible media.

Computer 3202 can be communicatively connected to the Internet 3214 via a communication device 3216. Internet 3214 connectivity is well known within the art. In one embodiment, a communication device 3216 is a modem that responds to communication drivers to connect to the Internet via what is known in the art as a “dial-up connection.” In another embodiment, a communication device 3216 is an EthernetO or similar hardware network card connected to a local-area network (LAN) that itself is connected to the Internet via what is known in the art as a “direct connection” (e.g., T1 line, etc.).

A user enters commands and information into the computer 3202 through input devices such as a keyboard 3218 or a pointing device 3220. The keyboard 3218 permits entry of textual information into computer 3202, as known within the art, and embodiments are not limited to any particular type of keyboard. Pointing device 3220 permits the control of the screen pointer provided by a graphical user interface (GUI) of operating systems such as versions of Microsoft Windows . Embodiments are not limited to any particular pointing device 3220. Such pointing devices include mice, touch pads, trackballs, remote controls and point sticks. Other input devices (not shown) can include a microphone, joystick, game pad, satellite dish, scanner, or the like.

In some embodiments, computer 3202 is operatively coupled to a display device 3222. Display device 3222 is connected to the system bus 3212. Display device 3222 permits the display of information, including computer, video and other information, for viewing by a user of the computer. Embodiments are not limited to any particular display device 3222. Such display devices include cathode ray tube (CRT) displays (monitors), as well as flat panel displays such as liquid crystal displays (LCD's). In addition to a monitor, computers typically include other peripheral input/output devices such as printers (not shown). Speakers 3224 and 3226 provide audio output of signals. Speakers 3224 and 3226 are also connected to the system bus 3212.

Computer 3202 also includes an operating system (not shown) that is stored on the computer-accessible media RAM 3206, ROM 3208, and mass storage device 3210, and is and executed by the processor 3204. Examples of operating systems include Microsoft Windows®, Apple MacOS®, Linux®, UNIX®. Examples are not limited to any particular operating system, however, and the construction and use of such operating systems are well known within the art.

Embodiments of computer 3202 are not limited to any type of computer 3202. In varying embodiments, computer 3202 comprises a PC-compatible computer, a MacOS®-compatible computer, a Linux®-compatible computer, or a UNIX®-compatible computer. The construction and operation of such computers are well known within the art.

Computer 3202 can be operated using at least one operating system to provide a graphical user interface (GUI) including a user-controllable pointer. Computer 3202 can have at least one web browser application program executing within at least one operating system, to permit users of computer 3202 to access an intranet, extranet or Internet world-wide-web pages as addressed by Universal Resource Locator (URL) addresses. Examples of browser application programs include Netscape Navigator® and Microsoft Internet Explorer®.

The computer 3202 can operate in a networked environment using logical connections to one or more remote computers, such as remote computer 3228. These logical connections are achieved by a communication device coupled to, or a part of, the computer 3202. Embodiments are not limited to a particular type of communications device. The remote computer 3228 can be another computer, a server, a router, a network PC, a client, a peer device or other common network node. The logical connections depicted in FIG. 32 include a local-area network (LAN) 3230 and a wide-area network (WAN) 3232. Such networking environments are commonplace in offices, enterprise-wide computer networks, intranets, extranets and the Internet.

When used in a LAN-networking environment, the computer 3202 and remote computer 3228 are connected to the local network 3230 through network interfaces or adapters 3234, which is one type of communications device 3216. Remote computer 3228 also includes a network device 3236. When used in a conventional WAN-networking environment, the computer 3202 and remote computer 3228 communicate with a WAN 3232 through modems (not shown). The modem, which can be internal or external, is connected to the system bus 3212. In a networked environment, program modules depicted relative to the computer 3202, or portions thereof, can be stored in the remote computer 3228.

Computer 3202 also includes power supply 3238. Each power supply can be a battery.

### Database Manager Implementation

Referring to FIGS. 33-41, particular implementations of database managers and data architectures are described in conjunction with the system overview in FIG. 1 and the methods described in conjunction with FIGS. 42-61.

FIG. 33 is a block diagram of a data storage architecture 3300 that provides a stable data storage environment through a transaction-based architecture. In a transaction-based database manager, a bifurcated file structure improves data integrity.

Transactions 3302 are stored separately from the database 3304 which allows the transactions 3302 to be backed up separately from the database 3304. The separate data storage locations provide the bifurcated structure. This reduces the chance that corruption in the database 3304 will affect the transactions 3302. When the database 3304 becomes corrupted, a backup copy (not shown) of that database 3304 is restored, and then the transactions 3302 are applied to the database 3304 by a transaction-based database manager 3306, bringing the database 3304 to a fully updated state. In other embodiments, the transactions 3302 are rolled back from the corrupted database 3304 by the transaction-based database manager 3304. Thus the state of the database 3304 is returned to a state prior to the corruption. The ability to back out transactions 3302 and update the database 3304 with transactions 3302 greatly reduces the chance that data will be permanently lost, which improves data integrity of the database 3304.

Apparatus 3300 solves the need in the art to improve data integrity, and thus operational stability of an email client that accesses the data storage architecture 3300.

FIG. 34 is a block diagram of a database manager 3400 that provides a stable data storage environment through a high level security manager.

Database manager 3400 includes a high level security manager 3402 that ensures that data is written to appropriate portions of a database (not shown), and only to appropriate portions of the database, and also ensures that the data is written only under required authorizations. This reduces the chances of corruption of the database, which improves data integrity of the database.

FIG. 35 is a block diagram of a database manager 3500 that provides a stable data storage environment through relational data management. The relational database manager 3500 is adapted to operate in conjunction with tables, such as tables 200-3100.

Apparatus components can be embodied as computer hardware circuitry or as a computer-readable program, or a combination of both. In another embodiment, the systems, methods and apparatus are implemented in an application service provider (ASP) system.

More specifically, in the computer-readable program embodiment, the programs can be structured in managed or unmanaged code, or in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 3202 in FIG. 32, or on at least as many computers as there are components.

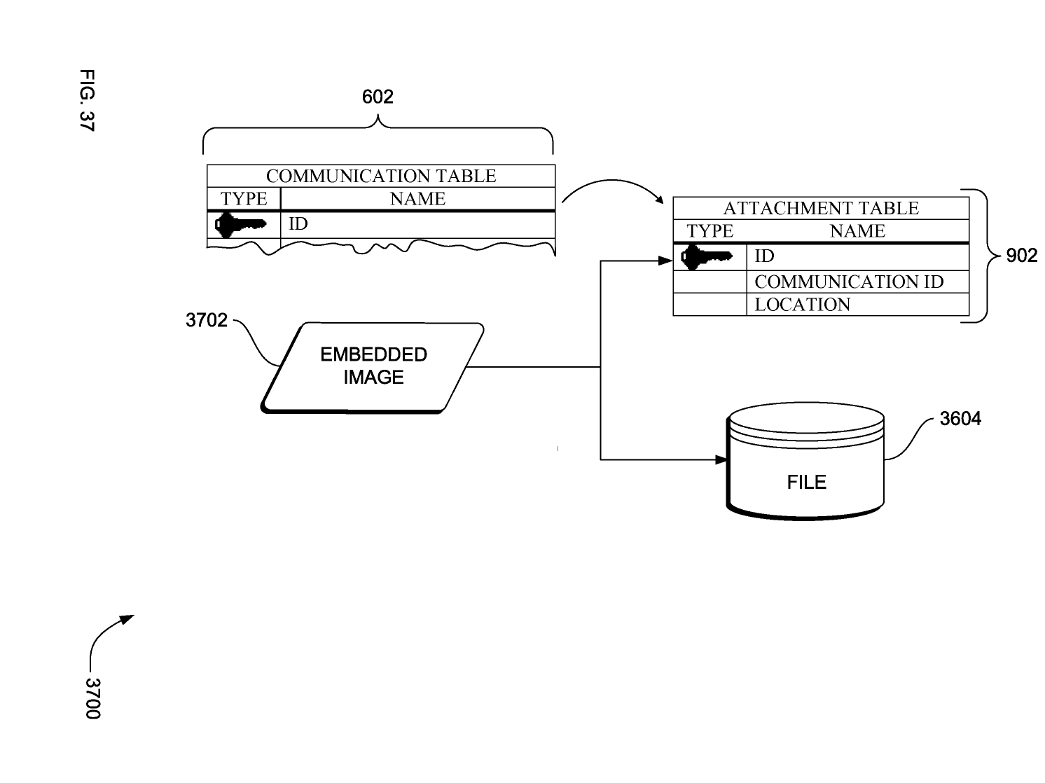

FIGS. 36-39 below show that embedded images and attachments can be managed identically, using the same data structures. In some embodiments, an embedded image 3702 from an email is stored in a same subdirectory as an attachment 3602 from the same email.

FIG. 36 is a data flow diagram 3600 to manage attachments according to an embodiment. Data flow diagram 3600 solves the need in the art for more storage of email data including attachments, without having to resort to archival files.

Data flow diagram 3600 includes an attachment 3602 of an email that is stored on a mass storage device 3604 in a data file structure that is separate from a body of the email. Data describing the attachment 3602 (including the location of the attachment 3602 on the mass storage device 3604) is stored in a record in an attachment table 902 and data describing the email is stored in a record of a communication table 602 (including the location of the record in the attachment table 902. Thus, the attachment 3602 is stored separately from the email on the mass storage device 3602 and the attachment 3602 is associated with the email through the communication table 602. In some embodiments, the location of the attachment 3602 is stored in the communication table 602.

Thus the data flow diagram 3600 supports storage of attachments outside of the email database, which allows the only the emails to be stored in the email database, which in turn reduces, if not eliminates, the amount of storage in the email database required to store attachments. This allows many more emails to be stored in the email database and the attachments to be stored elsewhere, such as on the disk drive of the computer, which has a tremendously larger amount of storage space. For example, on a computer running the Microsoft Windows® operating system, the maximum file size of an email database file is often two gigabytes, while the computer will often have ten to sixty gigabytes of unused hard disk space. Storing the attachments in the unused hard disk space separately from the email database not only provides a means to make the much larger amount of unused disk space available to store attachments, but also provides a means to use the email database only for emails, which allows more emails to be stored in the email database. Thus data flow diagram 3600 solves the need in the art for more storage for email data including attachments, without having to resort to archival files.

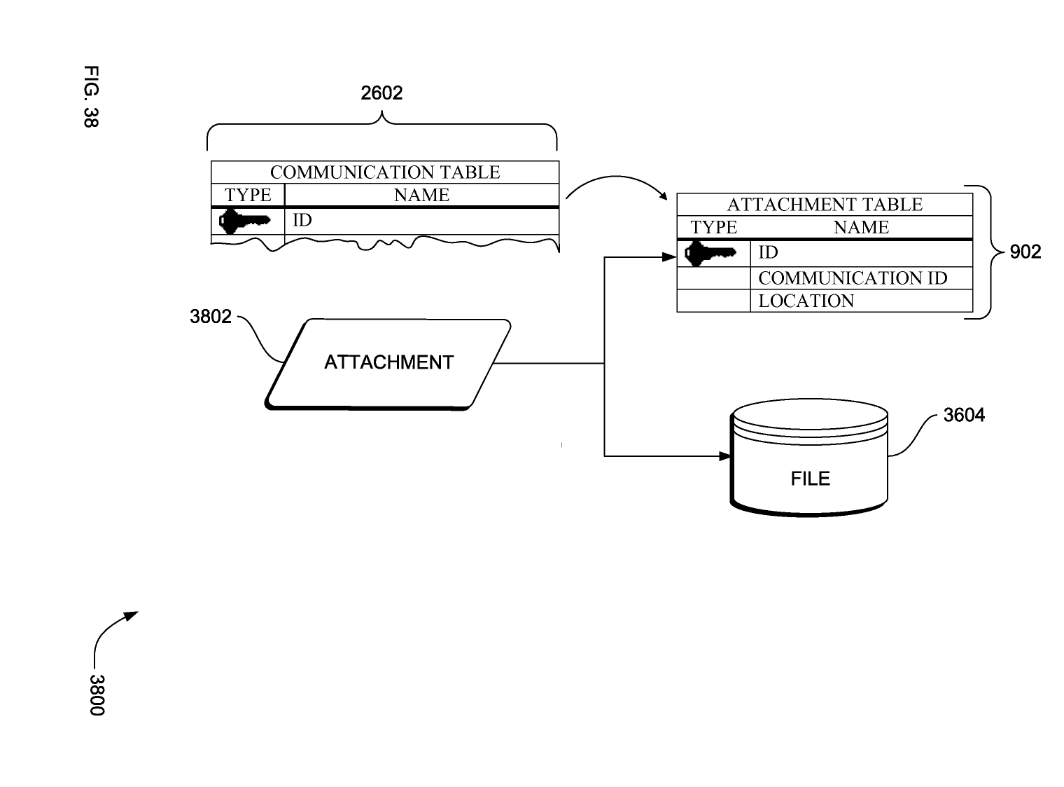

FIG. 37 is a data flow diagram 3700 to manage embedded graphics according to an embodiment. Data flow diagram 3700 solves the need in the art for more storage of email data including embedded images, without having to resort to archival files.

Data flow diagram 3700 includes an embedded image 3702 of an email that is stored on a mass storage device 3604 in data file structure that is separate from the email. Data describing the embedded image 3702 (including the location of the embedded image 3702 on the mass storage device 3604) is stored in a record in an attachment table 902 and data describing the email is stored in a record of a communication table 602 (including the location of the record in the attachment table 902. Thus, the embedded image 3702 is stored separately from the email on the mass storage device 3702, the embedded image 3702 is associated with the email through the communication table 602. In some embodiments, the location of the embedded image 3702 is stored in the communication table 602.

Thus the data flow diagram 3700 supports storage of embedded images outside of the email database, which allows the only the emails to be stored in the email database, which in turn reduces, if not eliminates, the amount of storage in the email database required to store embedded images. This allows many more emails to be stored in the email database and the embedded images to be stored elsewhere, such as on the disk drive of the computer, which has a tremendously larger amount of storage space. For example, on a computer running the Microsoft Windows® operating system, the maximum file size of an email database file is often two gigabytes, while the computer will often have ten to sixty gigabytes of unused hard disk space. Storing the embedded images in the unused hard disk space separately from the email database not only provides a means to make the much larger amount of unused disk space available to store embedded images, but also provides a means to use the email database only for emails, which allows more emails to be stored in the email database. Thus data flow diagram 3700 solves the need in the art for more storage for email data including embedded images, without having to resort to archival files.

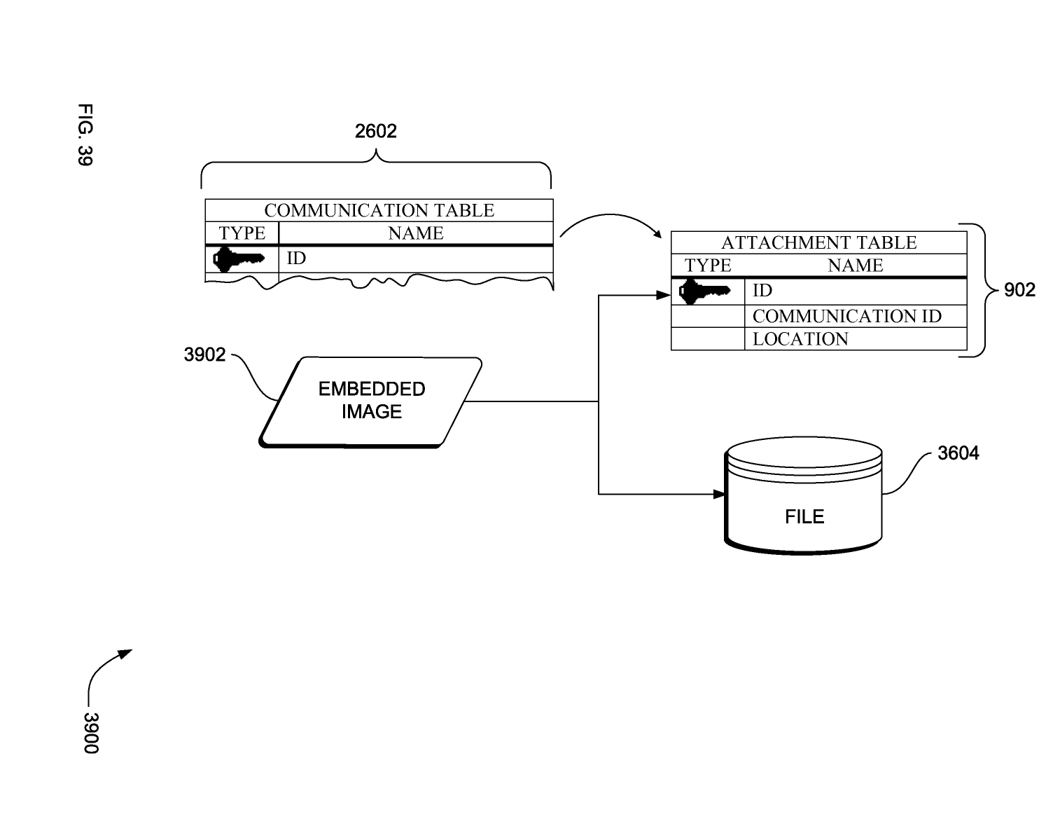

FIG. 38 is a data flow diagram 3800 to manage attachments according to an embodiment. Data flow diagram 3800 solves the need in the art for more storage of email data including attachments, without having to resort to archival files.

Data flow diagram 3800 includes an attachment 3802 of an email that is stored on a mass storage device 3804 in data file structure that is separate from a body of the email. Data describing the attachment 3802 (including the location of the attachment 3802 on the mass storage device 3804) is stored in a record in an attachment table 902 and data describing the email is stored in a record of a communication table 2602 (including the location of the record in the attachment table 902. Thus, the attachment 3802 is stored separately from the email on the mass storage device 3802 and the attachment 3802 is associated with the email through the communication table 2602. In some embodiments, the location of the attachment 3802 is stored in the communication table 2602.

Thus the data flow diagram 3800 supports storage of attachments outside of the email database, which allows the only the emails to be stored in the email database, which in turn reduces, if not eliminates, the amount of storage in the email database required to store attachments. This allows many more emails to be stored in the email database and the attachments to be stored elsewhere, such as on the disk drive of the computer, which has a tremendously larger amount of storage space. For example, on a computer running the Microsoft Windows® operating system, the maximum file size of an email database file is often two gigabytes, while the computer will often have ten to sixty gigabytes of unused hard disk space. Storing the attachments in the unused hard disk space separately from the email database not only provides a means to make the much larger amount of unused disk space available to store attachments, but also provides a means to use the email database only for emails, which allows more emails to be stored in the email database. Thus data flow diagram 3800 solves the need in the art for more storage for email data including attachments, without having to resort to archival files.

FIG. 39 is a data flow diagram 3900 to manage embedded graphics according to an embodiment. Data flow diagram 3900 solves the need in the art for more storage of email data including embedded images, without having to resort to archival files.

Data flow diagram 3900 includes an embedded image 3702 of an email that is stored on a mass storage device 3604 in data file structure that is separate from the email. Data describing the embedded image 3702 (including the location of the embedded image 3702 on the mass storage device 3604) is stored in a record in an attachment table 902 and data describing the email is stored in a record of a communication table 2602 (including the location of the record in the attachment table 902. Thus, the embedded image 3702 is stored separately from the email on the mass storage device 3702, the embedded image 3702 is associated with the email through the communication table 2602. In some embodiments, the location of the embedded image 3702 is stored in the communication table 2602.

Thus the data flow diagram 3900 supports storage of embedded images outside of the email database, which allows the only the emails to be stored in the email database, which in turn reduces, if not eliminates, the amount of storage in the email database required to store embedded images. This allows many more emails to be stored in the email database and the embedded images to be stored elsewhere, such as on the disk drive of the computer, which has a tremendously larger amount of storage space. For example, on a computer running the Microsoft Windows® operating system, the maximum file size of an email database file is often two gigabytes, while the computer will often have ten to sixty gigabytes of unused hard disk space. Storing the embedded images in the unused hard disk space separately from the email database not only provides a means to make the much larger amount of unused disk space available to store embedded images, but also provides a means to use the email database only for emails, which allows more emails to be stored in the email database. Thus data flow diagram 3900 solves the need in the art for more storage for email data including embedded images, without having to resort to archival files.

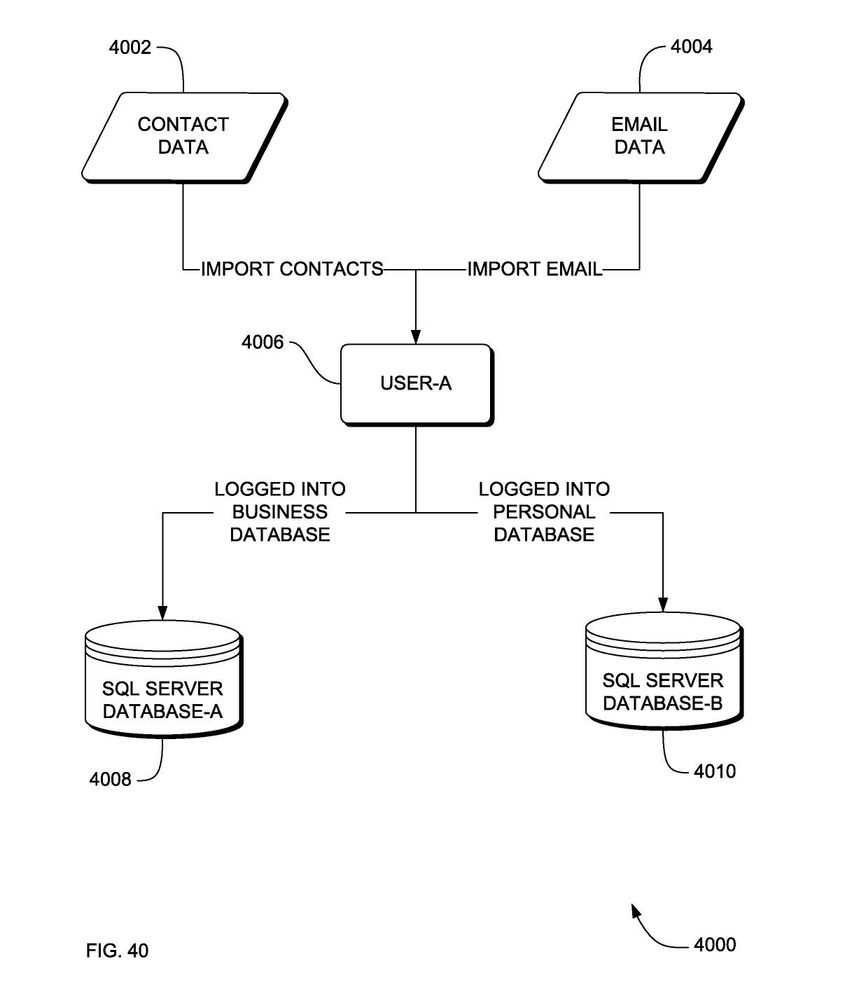

FIG. 40 is a data flow diagram 4000 to import data into an email client according to an embodiment.

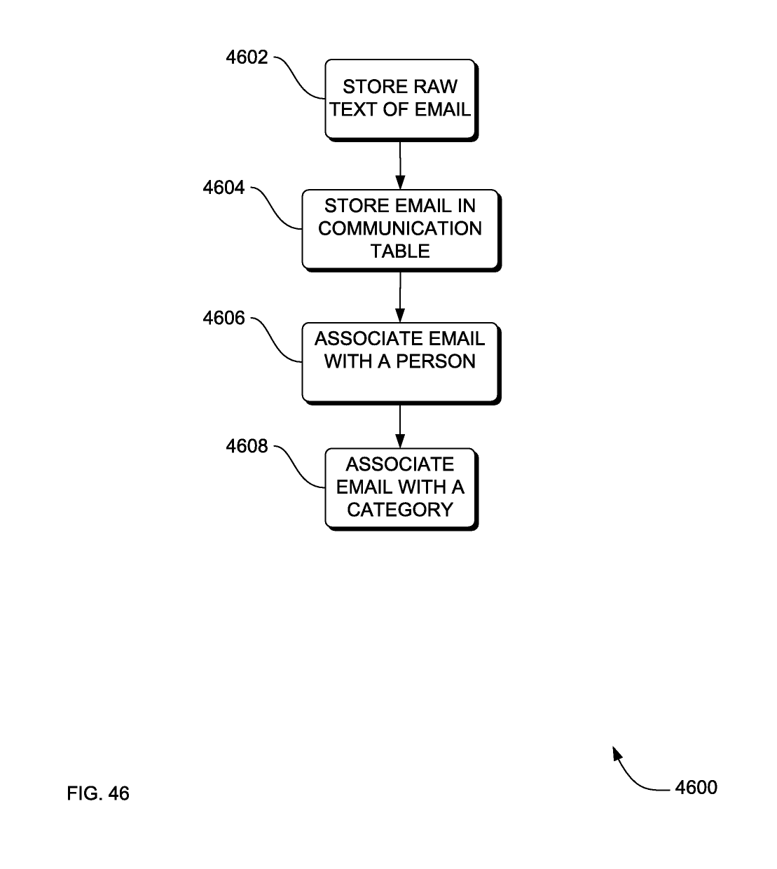

Data flow diagram 4000 includes contact data 4002 and email data 4004 that is received by the email client (not shown) in association with a particular user of the email client, such as User-A 4006. In some embodiments, the contact data 4002 and the email data 4004 is in the same file format as the received email in FIG. 46, such as in one of a plurality of emails in a .mbx file, a .csv file or an .eml file.

Depending upon which of a number of databases User-A 4006 is logged into, such as SQL Server Database-A 4008 or SQL Server Database-B 4010, the contact data 4002 and email data 4004 will be stored into the database that the user is logged into. Any number of users, such as User-B, User-C or User-D can be associated with any number of databases, such as Database-C, Database-D or Database-E. In some embodiments, the method of FIG. 46 is performed during the storing in FIG. 40.

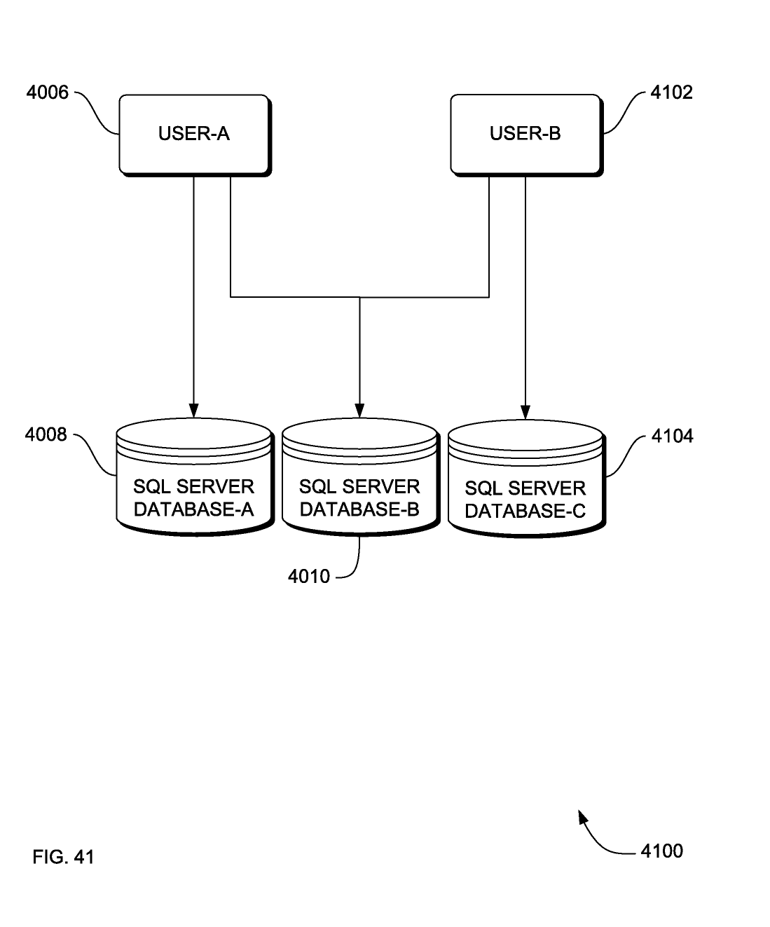

FIG. 41 is a dataflow diagram 4100 to manage multiple users according to an embodiment.

Dataflow diagram 4100 includes a User-A 3906 who accesses a Server Database-A 3908 and/or SQL Server Database-B 3910. Dataflow diagram also includes User-B 3702 who accesses the Server Database-B 3910 and/or SQL Server Database-C 4104.

In some embodiments, the User-A 3906 is named “admin” and the User-B 4102 is named “user.”

Dataflow diagram 4100 shows two different embodiments of database access. In the first embodiment, User-A 3906 has exclusive access to Server Database-A 3908 and User-B 3702 has exclusive access to SQL Server Database-C 4104. In the second embodiment, User-A 3906 and User-B 4102 share access to SQL Server Database-B 3910.

When a user is added to a setup table, such as setup table 1902, a database name, servename and password are added to that user for a new database or one that already exists. If a non-existent database is specified, that database is created, and then the database is connected to servename and password.

In some embodiments, any person can have multi-databases: personal, business, etc. For example, one user can have and access a personal database of emails and people, and then at some point, leave the program, and log into another business database that is there database also, (separate from the personal database), so no mixing of emails. Access to each database is through the login that allows entry. In another example, any set of users can share one database in which different users can use the same database by just both submitting the login credentials to the email client. In another example, all users can have separate databases, in which each user has their own database so that no other user could delete their emails. In another example, each user can import to their database connecting emails to any topic, in which a user logs into any database, that user will have the authorization to import into that database. In another example, when a user logs in as a user with access to a database, all importing by the email client directed by the user do applies to the database the user has the ability to which to connect.

### Method Embodiments

In the previous section, table layouts are described. In this section, the particular methods and dataflow diagrams of such embodiments are described by reference to a series of flowcharts. Describing the methods by reference to a flowchart and dataflow diagrams enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 4200-6100 are performed by a program executing on, or performed by firmware or hardware that is a part of, a computer, such as computer 3202 in FIG. 32.

FIG. 42 is a flowchart of a method 4200 to manage email associations, according to an embodiment.

Method 4200 includes receiving an email 4202 and determining 4204 whether or not the sender of the email is in a database. In some embodiments, the determination is performed by comparing a sender email address contained in the email to a table in a database, such as the person table 300 in FIG. 3. For example, the fields EMAIL 360, EMAIL1 360 and/or EMAIL3 364 in the person table 300 in FIG. 3 can be compared to the sender's email address to determine if the sender is in the database.

If the sender of the email is in the database, then a connection is created 4206 in the database between email and the person.

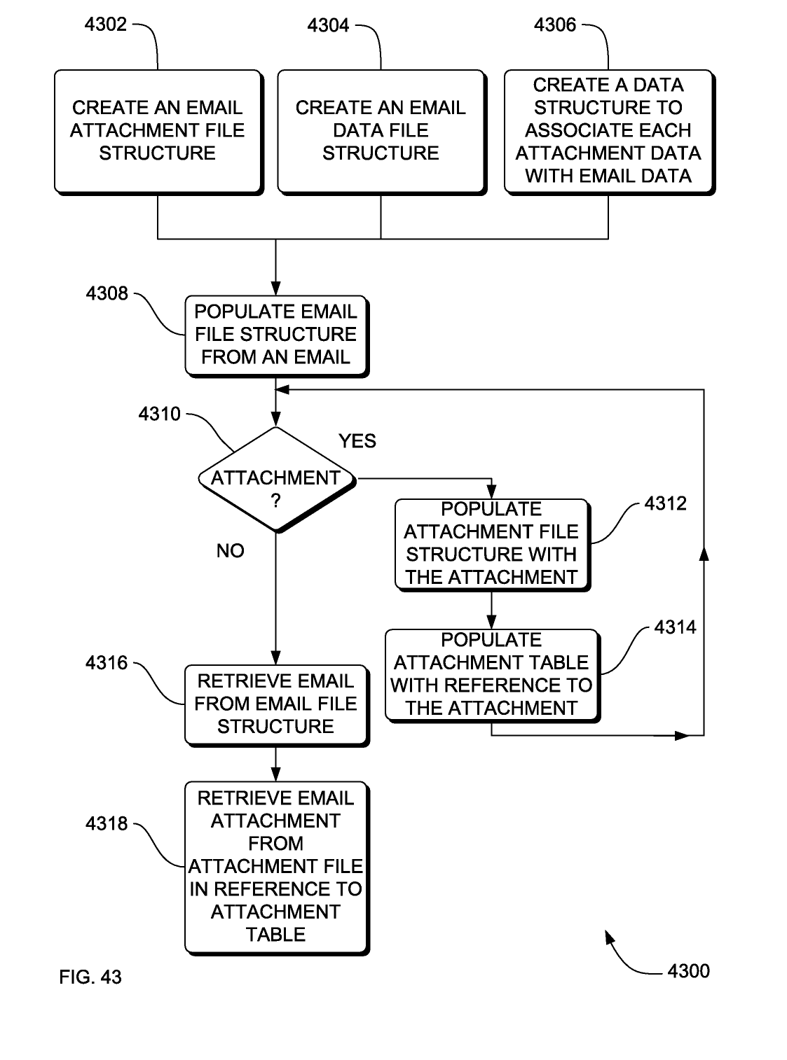

FIG. 43 is a flowchart of a method 4300 to provide storage for email data including attachments according to an embodiment. Method 4300 solves the need in the art for more storage of email data including attachments, without having to resort to archival files.

Method 4300 includes creating 4302 a file structure that is operable to store email attachment data. In some embodiments, that email attachment file structure is a file stored on a disk drive of a computer performing method 4300.

Method 4300 also includes creating 4304 a file structure that is operable to store email data other than the email attachment data. One such data structure created by action 4304 is a record in the communication table 602 in FIG. 6 above.

Method 4300 further includes creating 4306 a data structure that is operable to associate each attachment data with an email data. One such data structure created by action 4306 is a record in the attachment table 902 in FIG. 9 above.

Thereafter, method 4300 includes populating 4308 the file structure that is operable to store email data other than the email attachment data with an email data file other than email attachment data.

If the email includes an attachment 4310, then method 4300 includes populating 4312 the file structure that is operable to store email attachment data with the email attachment file and populating 4314 the attachment table 900 with an entry related to the email attachment file in the email attachment file structure. Actions 4310-3514 are repeated for as many attachments that are associated with the email data.

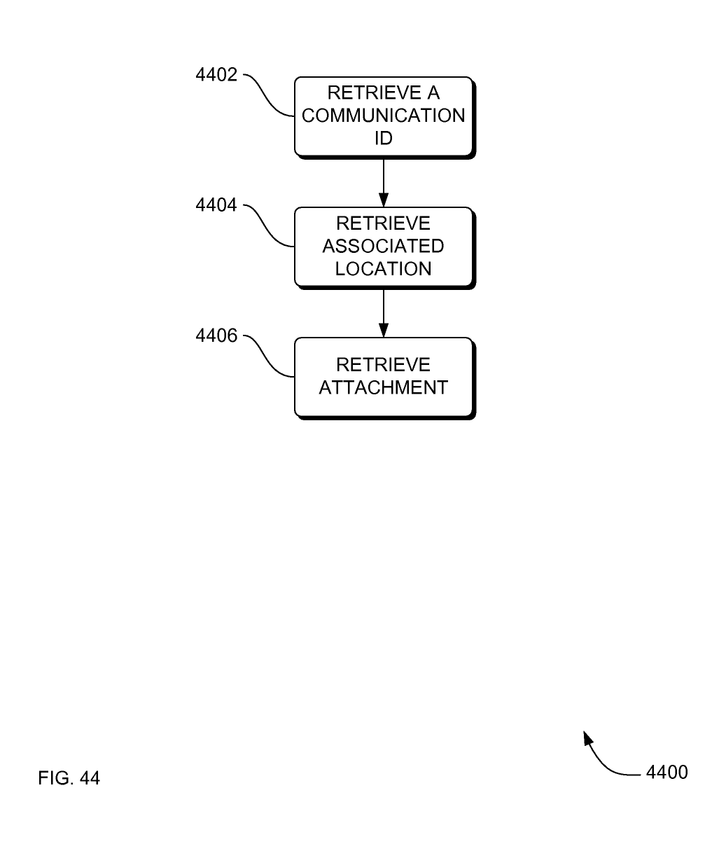

Thereafter, in some embodiments, method 4300 includes retrieving 4316 the email data file from the file structure that is operable to store email data other than the email attachment data and method 4300 includes retrieving 4318 the email attachment data file from the file structure that is operable to store email attachment data. One embodiment of retrieving 4318 is described below in FIG. 44.

In essence, method 4300 provides a manner of the storing an attachment of an email, providing on a disk drive of a computer performing method 4300, creating an association of the attachment to the email and later retrieving the attachment in reference to the association.

In some embodiments of method 4300 in FIG. 43 above and method 4400 in FIG. 44 below, the subject of each method is an embedded graphic file instead of an attachment. An email communication may be associated with an embedded graphic file. In these embodiments, the graphic file is treated substantially similar to the attachment; more specifically, the embedded graphic file is stored on a disk drive of a computer performing method 4300, an association between the embedded graphic file and the email is created and later the embedded graphic file is retrieved from the disk drive in reference to the association.

FIG. 44 is a flowchart of a method 4400 to retrieve an email attachment according to an embodiment. Method 4400 solves the need in the art for more storage of email data including attachments, without having to resort to archival files. Method 4400 is one embodiment of retrieving 4318 an email attachment in FIG. 4300 above.

Method 4400 includes receiving 4402 a communication identification and retrieving 4404 a location associated with the communication identification. In some embodiments, the communication identification is retrieved from a data structure that associates the attachment data with the email data such as an entry in the attachment table 900. Thereafter, method 4400 includes retrieving 4406 the attachment from a file structure that is operable to store email attachment data in reference to the location.

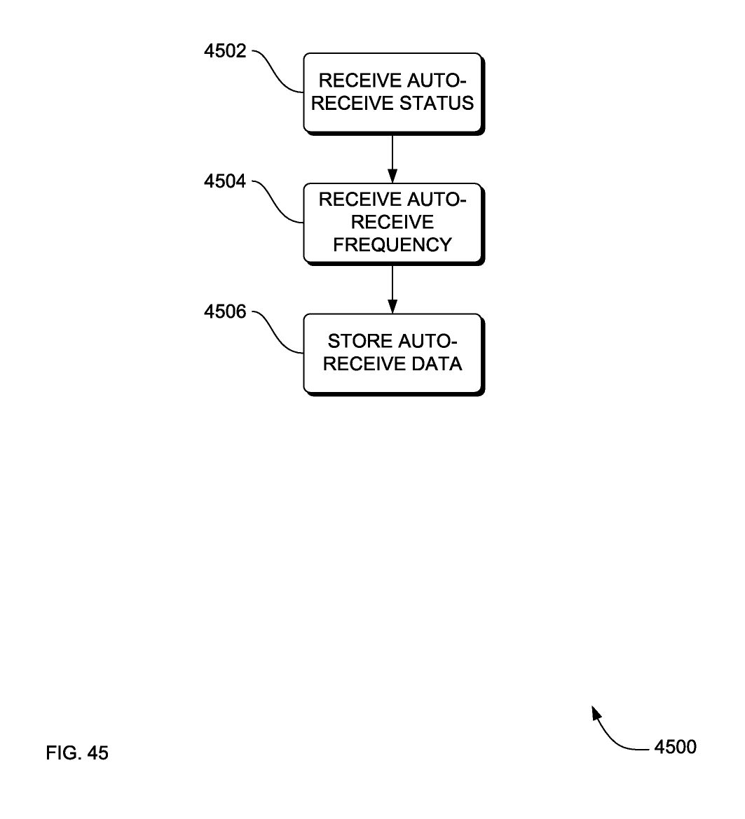

FIG. 45 is a flowchart of a method 4500 to manage auto-receive according to an embodiment. Method 4500 provides a means of determining from a user a number of parameters pertinent to the email client and performing periodic queries for emails that have not yet been downloaded from an email server to a computer executing the email client.

Method 4500 includes receiving 4502 an indication of the status of checkbox that represents a binary condition. Various embodiments of the data of the auto-receive status include ON/OFF, TRUE/FALSE, CHECKED/UNCHECKED and 0/1. The auto-receive status indicates whether or not auto-receiving of emails is enabled. The indication of the status can be solicited from the user via a checkbox via a graphical user interface.

Method 4500 also includes receiving 4504 an integer value representing the frequency of auto-receiving emails. The units of time of the frequency is predetermined and communicated to a user via a graphical user interface.

Method 4500 also includes storing 4506 the auto-receive status and the auto-receive frequency. In some embodiments, the auto-receive parameters are stored in the mdefault table 2402 in FIG. 24. Thereafter, the auto-receive data is available for access and reference by the email client.

FIG. 46 is a flowchart of a method 4600 to import an email communication according to an embodiment.

Method 4600 includes receiving and storing 4602 raw text of an email and creating a record in a communication table, such as communication table 602. In some embodiments, the received email in one of a plurality of emails in a .mbx file, a .csv file or an .eml file.

Method 4600 also includes storing 4604 the email data in a communication table, such as communication table 602 that is described above. In some embodiments, the storing 4604 includes creating an entry in the communication table and copying the email data to the entry.

Method 4600 also includes associating 4606 the stored email data with a person. One example of associating 4606 includes updating a field in the stored communication entry indicating a person indicated by an “emailfromaddress” who is represented in a entry in a person table 302.

Method 4600 also includes associating 4608 the stored email data with a category. One example of associating 4608 includes updating a field in the stored communication entry indicating a category that is described in an entry in a category table 202.

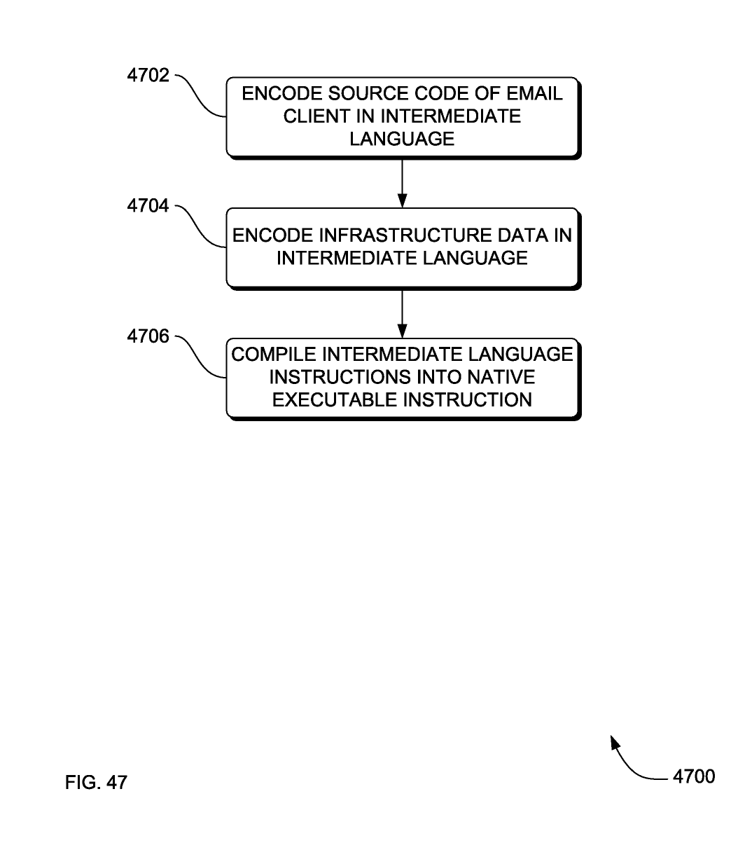

FIG. 47 is a flowchart of a method 4700 to create an executable managed code email client according to an embodiment. Method 4700 solves the need in the art for an operationally stable email client.

Managed code is executable computer instructions whose execution is managed by a runtime module, such as the Microsoft .NET Framework Common Language Runtime (CLR). The runtime module refers to an architecture of cooperation between natively executing instructions and the runtime module. This architecture specifies that at any point of execution, the runtime module may stop an executing processor (CPU) and retrieve information specific to the current CPU instruction address. Information that must be query-able generally pertains to runtime state, such as register or stack memory contents.

Method 4700 includes encoding 4702 source code of an email client in an intermediate language (IL). An IL describes how the information is to be encoded, and programming languages that target the runtime module emit the correct encoding. One embodiment of an IL is the Common Language Infrastructure (CLI) Standard published by the International Organization for Standardization (ISO) in Geneva Switzerland, of which the CLR is the primary commercial implementation.

In addition, infrastructure data such as associated metadata, or symbolic information that describes all of the entry points and the constructs exposed in the IL (e.g., methods, properties) and their characteristics, are encoded 4704 in the IL.

The IL instructions are compiled 4706 into native executable instructions. Because the compiling 4706 is performed by the managed execution environment (or, in some embodiment, by a runtime-aware compiler that accesses information on how to target the managed execution environment), the managed execution environment can provide information about what function the instructions will perform. The managed execution environment can insert traps and appropriate garbage collection hooks, exception handling, type safety, array bounds and index checking. For example, such a compiler creates stack frames so that a garbage collector can run in the background on a separate thread, constantly traversing the active call stack, finding all the roots, identifying all of the live objects. In addition because the IL instructions have information describing type safety, an execution engine will maintain type safety eliminating some programming mistakes that often lead to security holes. The managed execution provides an operationally stable email client.

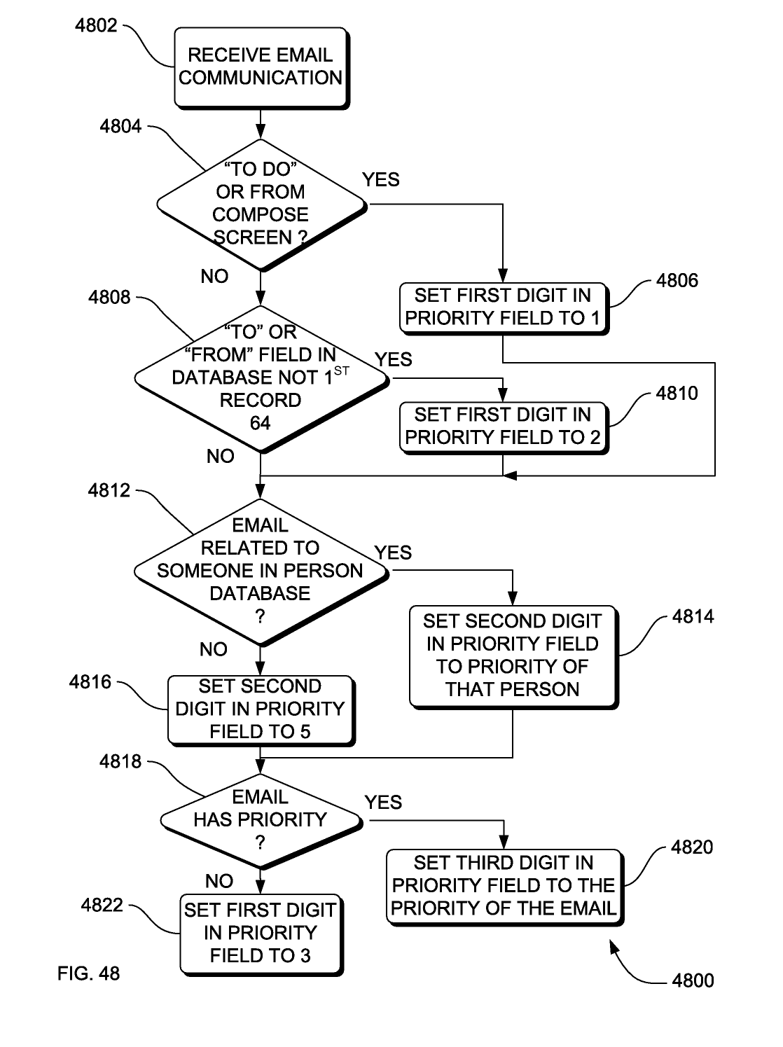

FIG. 48 is a flowchart of a method 4800 to prioritize email communications according to an embodiment. Method 4800 solves the need in the art for improved sorting/prioritization of emails.

Method 4800 includes receiving 4802 an email communication. A numeric priority field is set to numeric “0” in all digits of the priority field. The leading digit (the first digit) represents the overall importance of the email communication. A second digit represents the person importance of the email communication, and a third digit represents the email priority of the email communication. Some embodiments of the priority field comprise 3 digits, as the digits described above, other embodiments include a subset of the above described digits, other embodiments includes the above three digits and other digits, and other embodiments include a subset of the above three digits and other digits.

A determination 4804 as to whether or not the email communication is a “To Do” communication or whether or not the email communication was created from a compose screen of the email client. If either determination is true, the first digit in a numeric priority field is set 4806 to numeric 1. If both determinations 4804 are false, then a determination 4808 is performed as to whether or not the value in the “to” or the “from of the email communication is found in a database of email addresses other than the owner of the email client, the owner of the email client being indicated in the 1^{st} entry in the database in some embodiments. If determination 4808 is true, then the first digit in the numeric priority field is set 4810 to numeric 2.

Thereafter a determination 4812 as to whether or not the email communication is related to a person in the database. If the determination 4812 is true, then the second digit in the priority field is set 4814 to the priority of that person, otherwise the second digit in the priority field is set 4816 to 5.

Thereafter, a determination 4818 as to whether or not the email communication has a priority is made. If the determination 4818 is true, then the third digit in the priority field is set 4820 to the priority of the email communication. If the determination 4818 is false, then the third digit in the priority field is set 4822 to an average, middle, representation, such as numeric 3.

Thus, a priority of each email communication is set or determined. The emails can be displayed by the email client in descending numeric order indicated by the priority field.

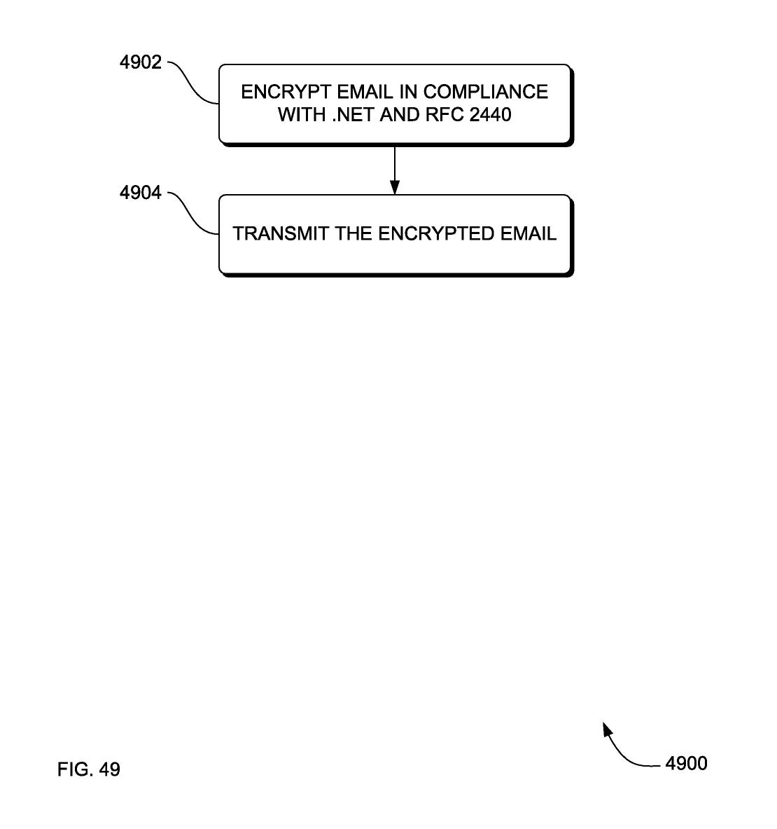

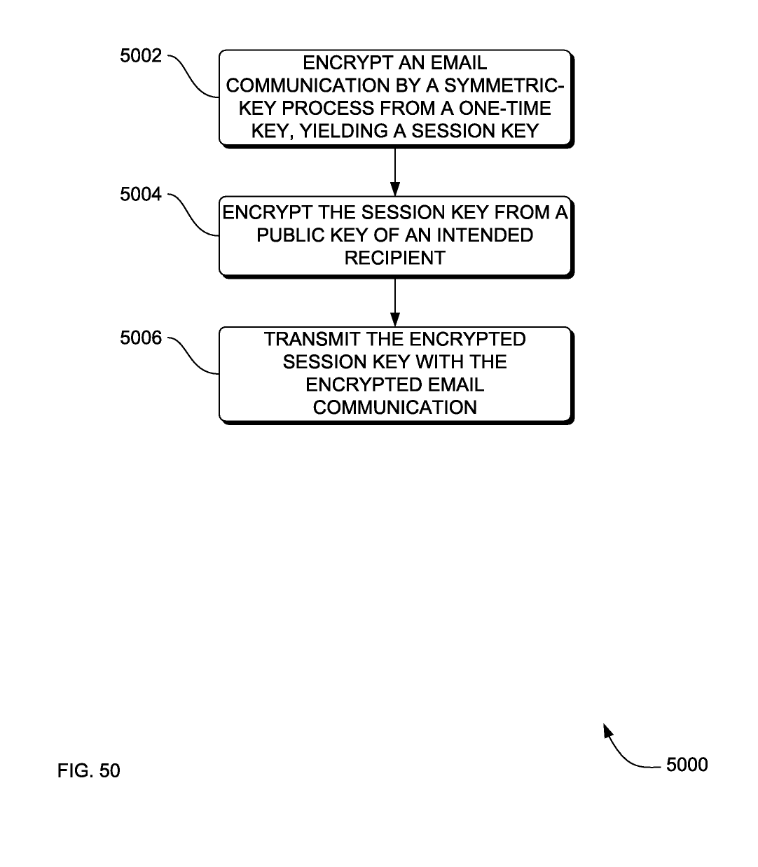

FIGS. 49-50 describe a number of methods that can be implemented in the creation, sending, and decrypting of email communications that use public key encryption. In general, the method encompass the following steps: In some embodiments, 1) the sender generating an initial key, 2) the sender signing and encrypting an email communication, 3) a receiver receiving a public key of the sender 4) a receiver of the email communication decrypting the email communication using their private key. The above actions provide secure signing and encryption of email communications between any number of clients. Components that implement the above action can be modified to support any portion of the many commands and options available in a public key encryption interface.

Encryption can be performed using a single key (symmetric) or multiple keys (antisymetric).

One variation of antisymmetric encryption uses two keys, a private key and a public key. Examples of public/private key encryption are PGP and GnuPG. GnuPG is a public domain near equivalent or PGP. The private key must not be distributed in order to maintain security of encrypted data, yet the public key is publicly distributed and required to decrypt the encrypted data.

One embodiment implementation of public key encryption that FIGS. 49-50 can implement is described in RFC 2440. RFC 2440 is commonly known as GnuPG encryption. RFC 2440 is published by the Internet Engineering Task Force at 1895 Preston White Drive, Suite 100, Reston, Va. 20191.

PGP or GnuPG encryption standards were originally developed in the Linux/C language environments, but PGP and GnuPG can also be used in Windows .NET environments easily with a wrapper. The wrapper can be written to support any features of PGP or GnuPG.

FIG. 49 is a flowchart of a method 4900 to encrypt email communications according to an embodiment. Method 4900 solves the need in the art for greater security of email communication.

Method 4900 includes encrypting 4902 an email communication from a public key in conjunction with a key management facility in a manner that is compliant with RFC 2440.

The encryption is performed by a component that is compliant with Microsoft .NET Framework Common Language Runtime (CLR). The CLR is an architecture of cooperation between natively executing instructions and a runtime module. In .NET, the architecture specifies that at any point of execution, the runtime module is operable to stop an executing processor (CPU) and retrieve information specific to the current CPU instruction address, the information including runtime state information. The encrypting action of 4902 can be embodied in a .NET wrapper class that provides PGP encryption in accordance with RFC 2440.

Method 4900 also includes transmitting 4904 the encrypted email communication. Method 4900 provides for strong encryption using no-fee public encryption standards in a .NET environment that reduces the possibility of the email being intercepted by unauthorized parties during transit from a sender to a recipient across the Internet or other network, and then decrypted, modified by a party or a computer process without consent by the sender or the recipient and/or be forged or falsely generated and distributed on the Internet by a hacker or spammer with false attribution to another party.

In some embodiments of method 4900 that implement processes that are compliant with RFC 2440 and GnuPG, the primary functions include initial generation of a private key and a public key, building complex option strings for encryption/decryption.

More specifically, in method 4900, to generate a public key, a local path address is received and a variable that holds a reference to the current user and all properties of the user is created.

Some embodiments of method 4900 also include creating a parameter to hold a formatted string of parameters. In some embodiments the formatted string of parameters is populated with a message parameter, such as “% echo Generating keys . . . ” In some embodiments the formatted string of parameters is populated with the type of key to create, such as “Key-Type: DSA”. In some embodiments the formatted string of parameters is populated with the type of subkey to create, such as “Subkey-Type: ELG-E”. The size of a subkey can be set to 2048 for more security, but which will cause increase the time required to generate a key. In some embodiments the formatted string of parameters is populated with the length of subkey to create, such as “Subkey-Length: 1024”. In some embodiments the formatted string of parameters is populated with a passphrase, such as “Passphrase: tester999”. ‘& user.Password.Trim. In some embodiments the formatted string of parameters is populated with a length of key to create, such as “Key-Length: 1024″. In some embodiments the formatted string of parameters is populated with a name to create, such as “Name-Real:”& Me.GetNameReal( ). In some embodiments the formatted string of parameters is populated with an email to create, such as “Name-Email:”& user.Email.Trim. In some embodiments the formatted string of parameters is populated with a comment to create the keys with, such as “Name-Comment: autogenerated”. In some embodiments the formatted string of parameters is populated with a date these keys should expire, such as “Expire-Date: 0”. In some embodiments the formatted string of parameters is populated with an instruction to begin creation, such as “% commit”. In some embodiments the formatted string of parameters is populated with an ending message to show on screen during debugging only, such as “% echo Completed Successfully”.

Some embodiments of method 4900 also include creating a string object to hold a string of encryption parameters. In some embodiments the string object of encryption parameters is populated with a parameter indicating a location of output, such as “—homedir”. In some embodiments the string object of encryption parameters is populated with a parameter indicating a length of subkey to create, such as “—no-tty”. In some embodiments the string object of encryption parameters is populated with a parameter indicating a length of subkey to create, such as “—status-fd=2”. In some embodiments the string object of encryption parameters is populated with a parameter indicating a length of subkey to create, such as “—no-secmem-waming”. In some embodiments the string object of encryption parameters is populated with a parameter indicating whether or not to generate the keys in a batch mode or silent versus manual with lots of interactive prompts so to automate this procedure, such as “—batch—gen-key”.

Some embodiments of method 4900 also include creating a string object indicating the name of the executable encryption program. In some embodiments the string object of the encryption program is populated with a parameter indicating to a .NET command launcher the fullpath to the program that we will be running which will be the executable encryption program, such as a path & “gpg.exe”.

Some embodiments of method 4900 also include creating an object that holds the above information, such as “ProcessStartlnfo(gpgExecutable, gpgOptions)”. In some embodiments the object that holds the above information is populated with a working directory path, such as by setting WorkingDirectory=path. In some embodiments the object that holds the above information is populated with an instruction to execute a command in the background, such as by setting CreateNoWindow=True. In some embodiments the object that holds the above information is populated with an instruction to not use shellexecute version because of multithread necessities, such as setting by “UseShellExecute” to false. In some embodiments the object that holds the above information is populated with an instruction to redirect stdin to input parameters, stderr in case of errors, such as by setitng redirectStandardInput=True. In some embodiments the object that holds the above information is populated with an instruction to redirect stderr to input parameters, such as by setitng RedirectStandardError=True. In some embodiments the object that holds the above information is populated with an instruction to start the executing of the gnupg command now, such as by setting processobject=Process.Start(pinfo). In some embodiments the object that holds the above information is populated with an instruction to write the parameter contents formatted string as input to the command, such as by setting StandardInput.WriteLine(paramContents). In some embodiments the object that holds the above information is populated with an instruction to erase what was in standard input=paramcontents, such as by setting processObject.StandardInput.Flush( ). In some embodiments the object that holds the above information is populated with an instruction to close the std input such as by setting StandardInput.Close( ). In some embodiments the object that holds the above information is populated with an instruction to set a variable to hold any error output to empty string, such as by setting errorString=””.

Some embodiments of method 4900 also include assigning a new thread to error handling, such as “threadStart(AddressOf StandardErrorReader)”.

Some embodiments of method 4900 also include creating a thread for terror retrieval the, such “New Thread(errorEntry)” and starting the error thread, such as “errorThread.Start( )”. If the thread does not come back finished within so many seconds then the error thread is cancelled, such as by “errorThread.Abort( )”. If there is no timeout, an empty parameter is created . . . for any output received by command processing, such as by “outputString= . . . ”” and a variable is filled with the condition for timeout, such as by “errorString=“Timed out after“” and a time of long did it take to timeout is added the error string, such as “ProcessTimeOutMilliseconds.ToString & “milliseconds”” Then the process object is killed. If the error thread is alive, then the error thread is killed. If a condition where killing necessary is ended, then polling begins. Results are checked output is prepared, by obraining and exitcode, and if the exit code indicates successful generation of keys, then an error string is set to indicate no error, otherwise the error string is set to indicate error a gpgnet error exists that is not from other source, and a error exception indicating the encryption error ois raised .

In some embodiments, the keys are set to expire after a certain condition, such as length of time.

Note that when redirecting stdin, and/or stdout, and/or stderr, shellexecute must not be implemented, neither can the window be open, except to test for errors.

Facility stdin supplies parameters vs a file parameter, to provide added security of not having the passphrase sitting in a file that could otherwise be easily hacked.

FIG. 50 is a flowchart of a method 5000 to encrypt email communications according to an embodiment. Method 5000 solves the need in the art for greater security of email communication. Method 5000 is one embodiment of the encrypting 4902 and transmitting 4904 in FIG. 49 above. In method 5000, the manner of encrypting 4902 that is compliant with RFC 2440 farther includes encrypting 5002 the email communication by a symmetric-key process from a one-time key. A one-time key is a key that expires upon the first use of the key. The encrypting 5002 yields a session key. Method 5000 also includes encrypting 5004 the session key. The session key is encrypted from a public key, the public key being associated with, generated by, or known to the intended recipient of the email communication. Thereafter, method 5000 includes transmitting 5006 the encrypted session key with the encrypted email communication.

In method 5000, the standard method GnuPG provides encryption from sender to recipient such that the encrypted email communication cannot be read during transit, and if the encrypted email communication is modified during transit, the encrypted email communication will not decrypt on the recipient end. Also if the encrypted email communication is not sent from a trusted source that has a public key of recipient, the encrypted email communication will not decrypt. Also, in some embodiments, the encrypted emails are stored in the database in encrypted form so that the encrypted email communication cannot be accessed, stolen or viewed by unwarranted database access.

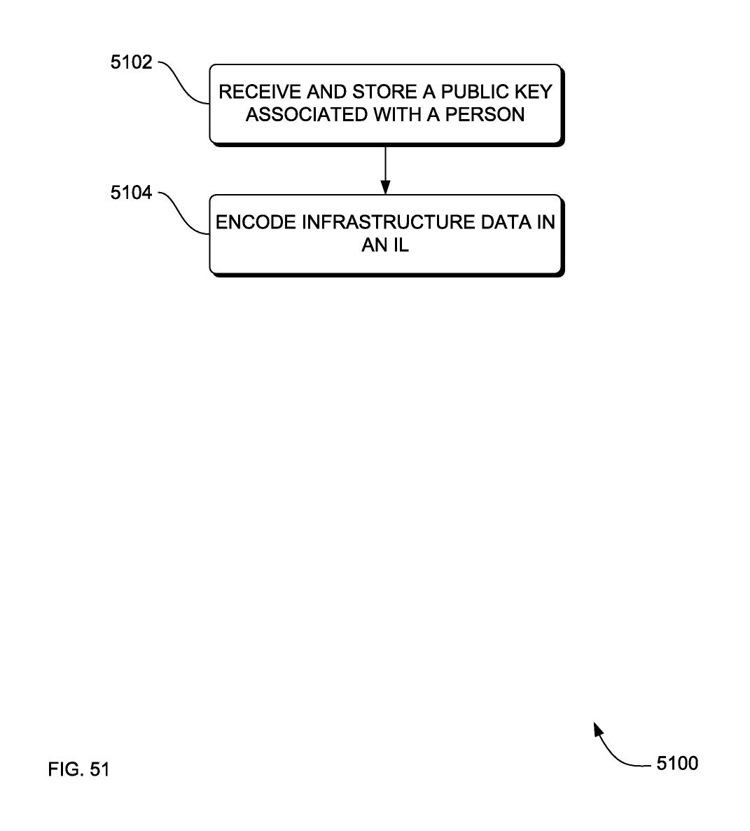

FIG. 51 is a flowchart of a method 5100 to decrypt email communications according to an embodiment. In some embodiments, the decrypting method 5100 is performed by an email communication client. In some embodiments, the method is invoked by a user by clicking on a button of a graphical user interface that is labeled “decrypt”. In some embodiments, method 5100 includes receiving 5102 and storing a public key that is associated with a particular person. Subsequently, method 5100 includes using a public key to decrypt 5104 an email communication that is encrypted by a key management facility in a manner that is compliant with RFC 2440.

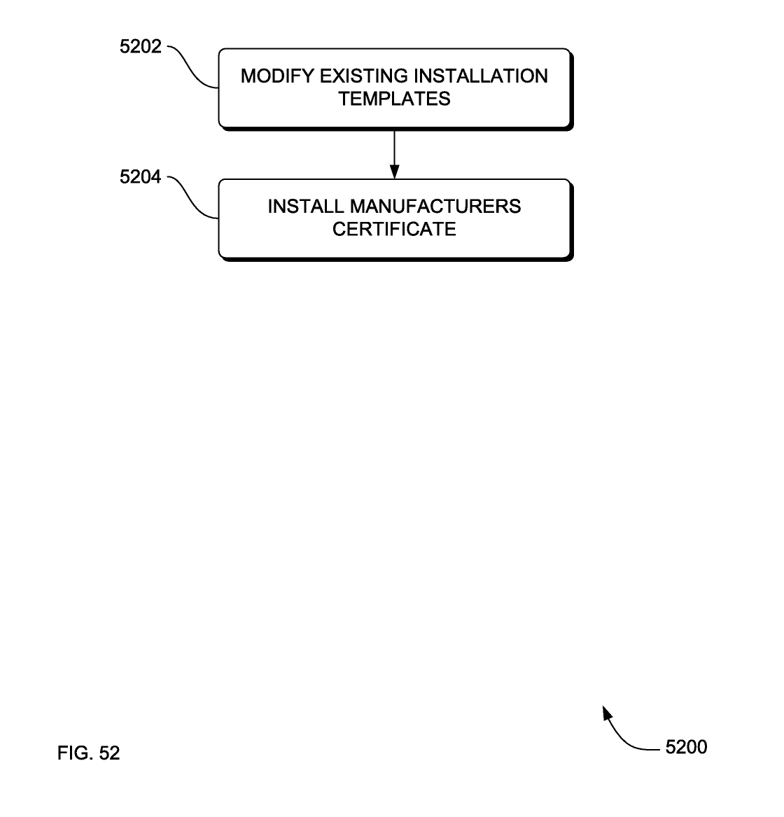

FIG. 52 is a flowchart of a method 5200 to install supporting components of an email communication client according to an embodiment. Method 5200 solves the need in the art for a more convenient installation procedure of an application program and an object framework.

Quality, modem, programs often require the installation of an object framework, such as Microsoft .NET or Microsoft SQL Server to support application features. Installation of an object framework makes installation of the dependent applications more difficult. To engineer components that provide convenient installation of an object framework, method 5200 includes modifying 5202 existing installation templates for a custom installation of the object framework (e.g. SQL Server Express 2005). Method 5200 also includes installing 5204 a certificate to identify the manufacturer of the software. For example, if a software manufacturer purchases a certificate from Thawte Inc of Britain, Thawte will verify whether a company meets Thawte's guidelines to be a Thawte Identified company. If verification occurs Thawte will send the manufacturer an electronic ticket. Certificates from Thawte are not in a usable format for .NET utilization, so Thawte certificates are exported to a format that can be imported into a usable form.

In some embodiments, method 5240 supports all three main ways of connecting to the object framework in case a user had a prior installation of it with a specific connection type in use. Three radio buttons are supplied to provide the three options of: SQL Authentication, Windows Authentication, and IP Address Connection to the SQL Server. When a user selects a type of connection desired, the user's usemame and password are used to build the proper connection string that allows one to use the SQL Server database.

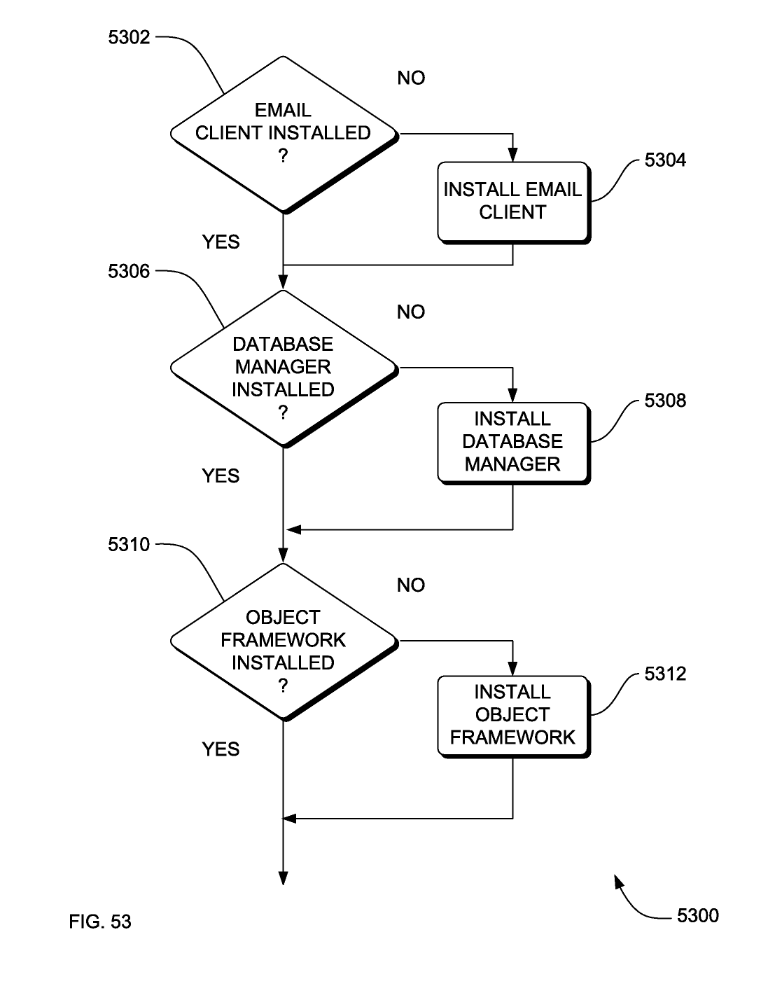

FIG. 53 is a flowchart of a method 5300 to manage scenarios of previous installation states of an email communication client according to an embodiment. Method 5300 manages scenarios of previous installation states, such as the following four states: 1) A destination computer performing method 5300 has no software installed 5302 relating to the operation of the email client, in which case the email client is installed 5304. 2) The destination computer does not have currently installed 5306 a database manager of sufficient capability, such as Microsoft SQL Server 7.0 or higher, in which case, installation of a database manager is performed 5308. 3) The destination computer does not have currently installed 5310 an object framework of sufficient capability, such as Microsoft .NET 2.0 or higher, in which case, installation of an object framework is performed 5312 by method 5300. 4) The destination computer has currently installed 5306 a database manager of sufficient capability, such as Microsoft SQL Server 7.0 or higher and the destination computer has currently installed 5310 an object framework of sufficient capability, such as Microsoft .NET 2.0 or higher, in which case installation 5308 of a database manager and an object framework is performed 5312. A software component performing method 5300 installation will recognize all these cases and not reinstall a component that is currently installed. Method 5300 provides fast and easy download and install of complex components to serve a sophisticated email program. The user is shielded from having to know anything about SQL Server Database or .NET.

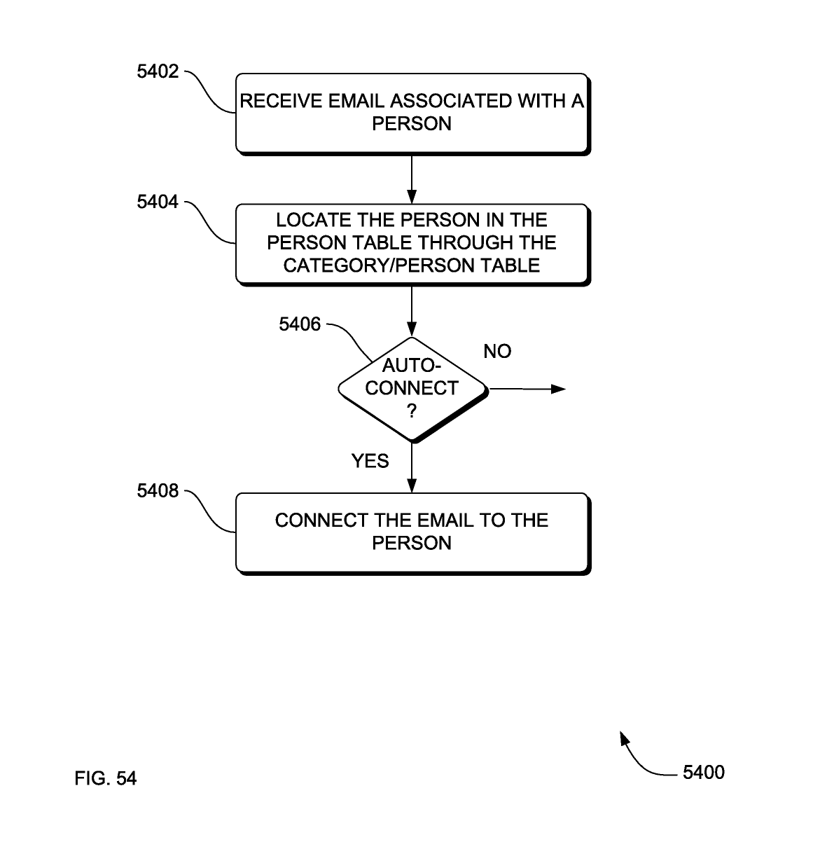

FIG. 54 is a flowchart of a method 5400 to associate an email with an idea or a category in an email communication client according to an embodiment. Method 5400 solves the need in the art for more general association between emails and other indicia.

In method 5400, the email client does not access folders or locations, but instead, the email client accesses categories or categorical ideas to which emails are associated or attached. For example, emails can be associated with an idea or category of Current Client Project. An incoming email originating from a particular sender can be automatically connected or associated to an account of that sender in the database and/or a current project of the sender.

When an email communication that is associated with a person is received 5402 by the email client, the person-to-email relationship in category/person table 442 of table 440 above is referenced 5404 in the database to locate information pertaining to the person. The set of categories connected to that person by the email client and the autoconnect field, and then the autoconnect field is verified 5406 as having been is set to one of the persons. If the verification is successful, then the email is connected 5408 to that category.

In some embodiments of method 5400, emails are associated with categories in the following manner: An email communication is received by the email client and the person associated with the email is located by referencing a relationship that relates all emails to the person who sent email. In some embodiments, the Communication table entry (the email) is connected to, the sender, in the Person table not by a third table but by a structural relationship between the tables: person and communication. The relationship is defined on frompersonid field in communication being connected to the id field in the person table.). After locating the person in the database, another relation from person to categories (e.g. the category/person table 402) locate all the categories associated with the person of the email communication.

In some embodiments of method 5400, categories are evaluated to determine which of the categories, if any, have the auto connect feature turned on. In some embodiments, only one category is allowed to have the auto connect feature turned on. When a category is determined to have the autoconnect feature turned on, then that category is the category to which email is connected. In some embodiments, each email is connected automatically to a person and a category.

In regards to method 5400, the user operates the email client in the following manner: The user can select a person in the email client database. The user can then select a screen or page (known at a “person detail” screen) through which the email client presents detailed information on the person. The person detail screen presents a list of categories of which the selected person is related to or associated with. The person detail screen includes a button adjacent or in close proximity to the categories list. When the user clicks the button, the email client causes a marker to appear next to, adjacent or in close proximity to one of the categories and the adjacent category is automatically connected to or associated with all emails from that person. When the user clicks the button again, the email client causes the marker to be moved to or placed at a next category in the category list. When the user clicks the button when the last category in the list is marked, then no category is marked by the email client so that the user can manually do a proper category connection if a proper category connection is desired by the user. When the user clicks the button when no category is marked, then the email client causes the first category in the list to be marked.

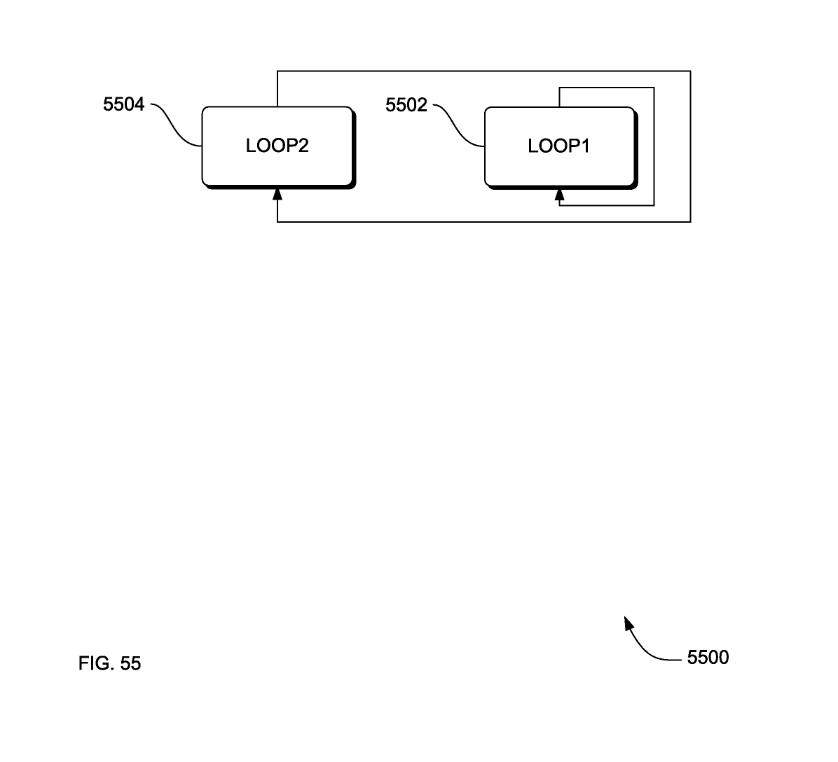

FIG. 55 is a flowchart of a method 5500 to store locations of favorite resources, according to an embodiment. Method 5500 solves the need in the art for a Favorites list that can be easily viewed to contemplate changes in the Favorites files and perform drag and drop operations and method 5500 solves the need to use simple editing tools on the Favorites file.

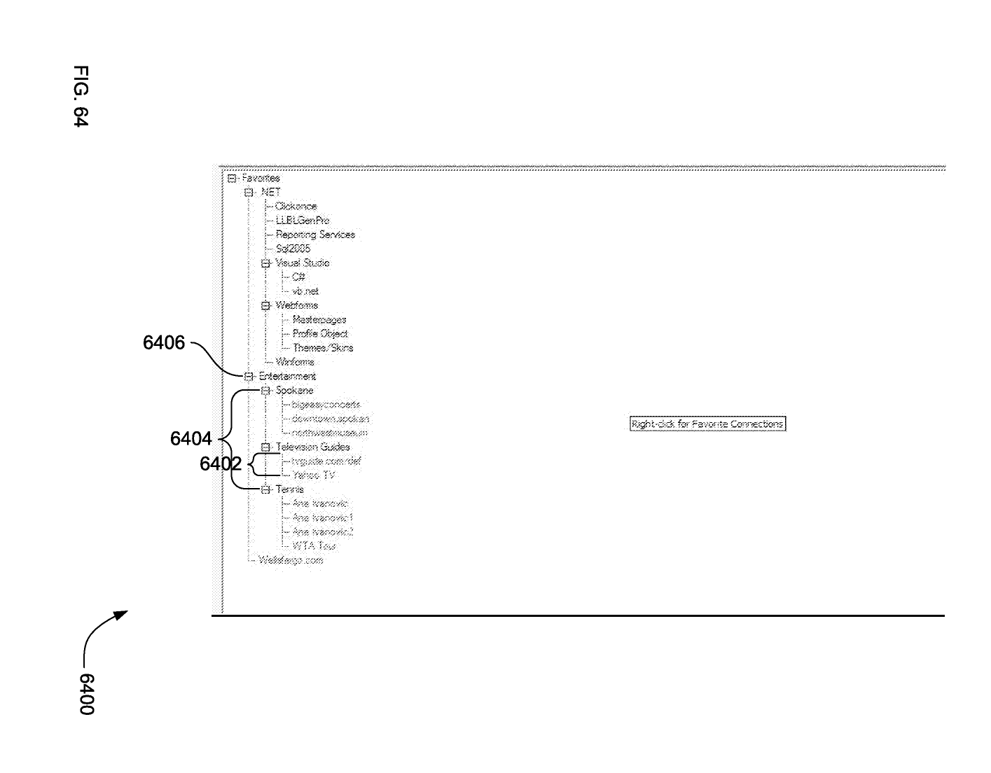

Method 5500 provides an infinitely complex tree of two types of entities: Favorite URLs and Favorite Groups of URLs. In some embodiments, method 5500 includes actions that manage drag/drop of both the Favorite URLs and Favorite Groups of URLs while the user is scrolling when a tree of Favorites is bigger than one page. Thus method 5500 solves the need in the art for a Favorites list that can be easily viewed to contemplate changes in the Favorites files and more easily perform drag and drop operations. Method 5500 includes a loop 5502 within a loop 5504 that invokes code recursively to process nodes of the Favorites list, which eliminates the need for a limit on the number of nodes in a tree or the number of levels in that tree. This allows the entries in the favorites list to be nested as shown in FIG. 64.

In regards to method 5500, the user operates the email client in the following manner: The user clicks on a hyperlink in an email communications and is navigated to the right in the screen where the user clicked on the hyperlink. To save the hyperlink in the favorites, the user right-clicks to associate the current hyperlink to a currently selected Favorite category or group. More specifically, when the user invokes the right-click function, a menu is displayed that includes an option labeled “Connect URL to current selected Favorite.” Adding the hyperlink is inconsequential because after the user accesses the Favorites page, the user can view all hyperlinks and groups by scrolling if the Favorites extends beyond a full screen. Then the user can drag the hyperlink to any place within the Favorites. If the user needs a new category to organize, the user can add a new category in a few clicks of the mouse after entering a group name. In some embodiments, to add a new Favorite Group, the user selects a Favorite Group within which to add the new Favorite Group in a tree format. Thereafter, the user clicks on a button labeled “New,” then the user enters in a name of the Favorite Group in the Favorite textbox, then the user clicks a button labeled “Save” button.

Then the user can drag the hyperlink of interest into that new group. In some embodiments, to drag a hyperlink or Group to a different location, as with any draggable application, the user performs a “left click” using the mouse on visual representation of a node and holds down the left mouse button and does not release the left mouse button until the user has dragged the visual representation over the node to which the user intends to move the dragged node. Any Group can be dragged to any other Group. Any hyperlink can be dragged onto any Group.

In some embodiments, the Favorites are stored in a table named Favorites in a database, such as database 3304 in FIG. 33 above. In some embodiments, to store a Favorite, the email client creates a new record in the table called Favorite for each Group or hyperlink with all the information about that entity of interest. In some embodiments, storing the favorites in a table of a database provides the same benefits of data integrity that are provided to the tables in FIGS. 2-31, including the availability of the table to be backed up and transferred easily to any computer on which the favorites could be useful. In some embodiments, when a drag operation reaches the edge of the container of the tree scrolling of the tree in relation to that container begins which does not lose the functional aspect of the dragging that was going on. The tree that is bigger than the container can have the top node dragged to the bottom node, so again there is no limit on Favorite tree size.

In some embodiments, up to 80% of a screen is dedicated to display of the Favorites data, which solves the need in the art for a Favorites list that can be easily viewed to contemplate changes in the Favorites files and more easily perform drag and drop operations.

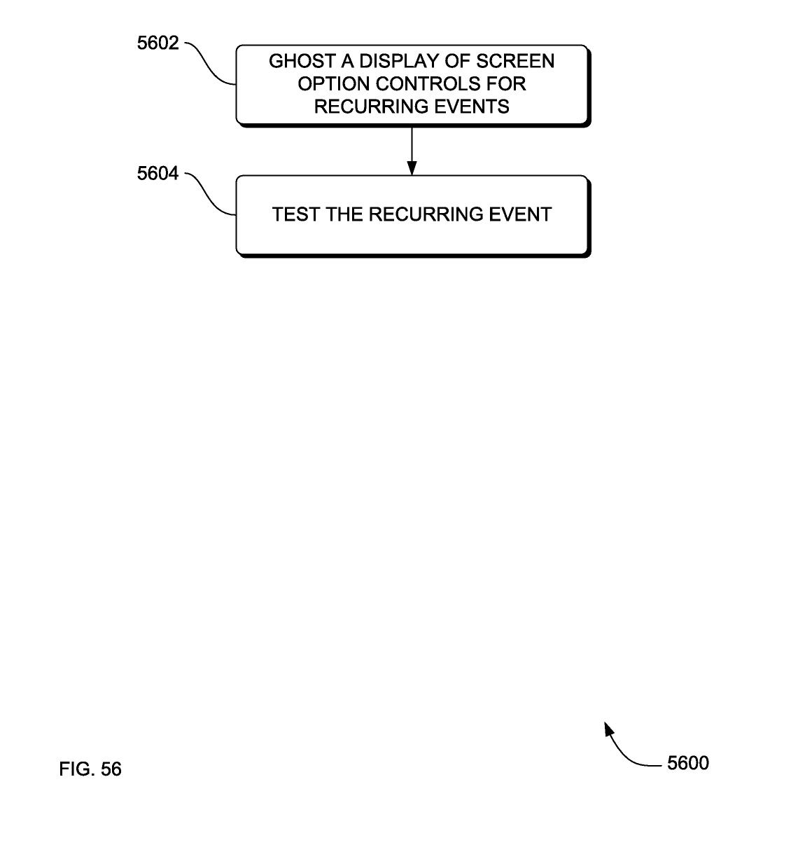

FIG. 56 is a flowchart of a method 5600 to manage recurring events, according to an embodiment. Method 5600 solves the need in the art manage recurring events with the advantages of conventional systems.

Method 5600 supports the display of options for recurring events on one display page in which an email client includes no more than one form having seven display pages for all aspects of email related activities, yet no more than one display page is available for recurring events.

Method 5600 includes ghosting 5602 of controls for recurring events. The ghosting 5602 guides the user when the user indicates the use of more complex options of recurring events rather than the use of a default simple set of options of recurring events. Ghosting is a process of prohibiting a user to interact with any control that does not make sense in the context of the user's current selections.

In some embodiments of method 5600, when the user clicks on a “Save” button in the screen of option controls for a recurring event, a description of the choice is displayed in a textbox of a long description of the recurring event. In that case, the user can view and read the description to determine or verify if the long description properly describes what the user intended.

Furthermore, method 5600 also displays the schedule of the recurring event for the next four years. This displaying 5602 provides a means of the user to test 5604 the accuracy and validity of the scheduling of the recurring event. In some embodiments of the displaying 5602, the first four events in chronological order of the recurring event are generated and displayed in a yellow status bar at the top of the screen without any other significant or substantive data being displayed on the screen. When the displayed four events are accurate and valid, the display of the four events provides to the user a confidence that the recurring event is accurately and validly scheduled throughout the entire duration of the recurring event. In some embodiments, two cases of generating of the occurrences associated with a recurring event are performed, the first case being the test described above in this paragraph, and the second case being generating all occurrences of the recurring event.

The test and generating all occurrences include the same functions, except generating all occurrences further includes saving the generated occurrences to the database, such as database 3304 in FIG. 3300. In some embodiments, the occurrences are saved to a favorites table such as shown in FIG. 31.

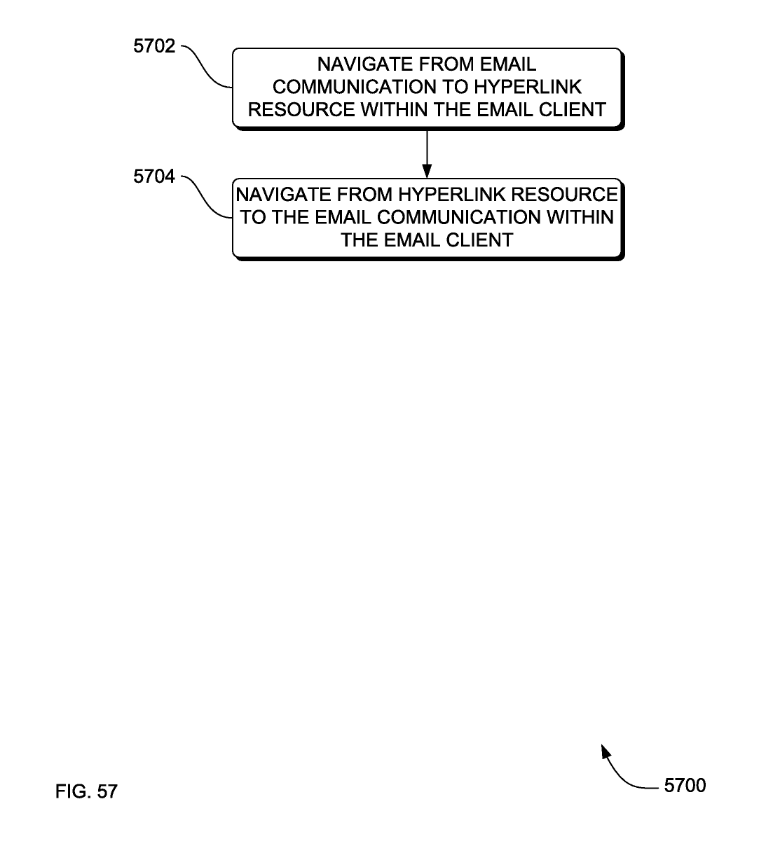

FIG. 57 is a flowchart of a method 5700 to view email communications, according to an embodiment. Method 5700 solves the need in the art to display or view in the email program a resource located at a hyperlink so that the entire display of the email program is visible to the user.

Method 5700, a click by a user on a hyperlink in an email communication, causes the current screen to navigate 5702 from the email communication to the selected resource, within the display of the email client. Thus, method 5700 provides display or view of a resource located at a hyperlink in the email program so that the entire display of the email program is visible to the user.

Thereafter, a click on a back arrow causes the screen to navigate 5704 back to the email communication. Thus, method 5700 provides a means of the user to interact with the email communication immediately to continue to other functions, such as saving Favorites, sending a webpage with one click to any address, continuing to navigate to a more interesting page leaving less information behind.

In some embodiments, a journal of all web addresses to which the user navigated is stored. In some further embodiments, method 5700 is implemented by customizing the Browser Control of Visual Studio program of Microsoft Corporation.

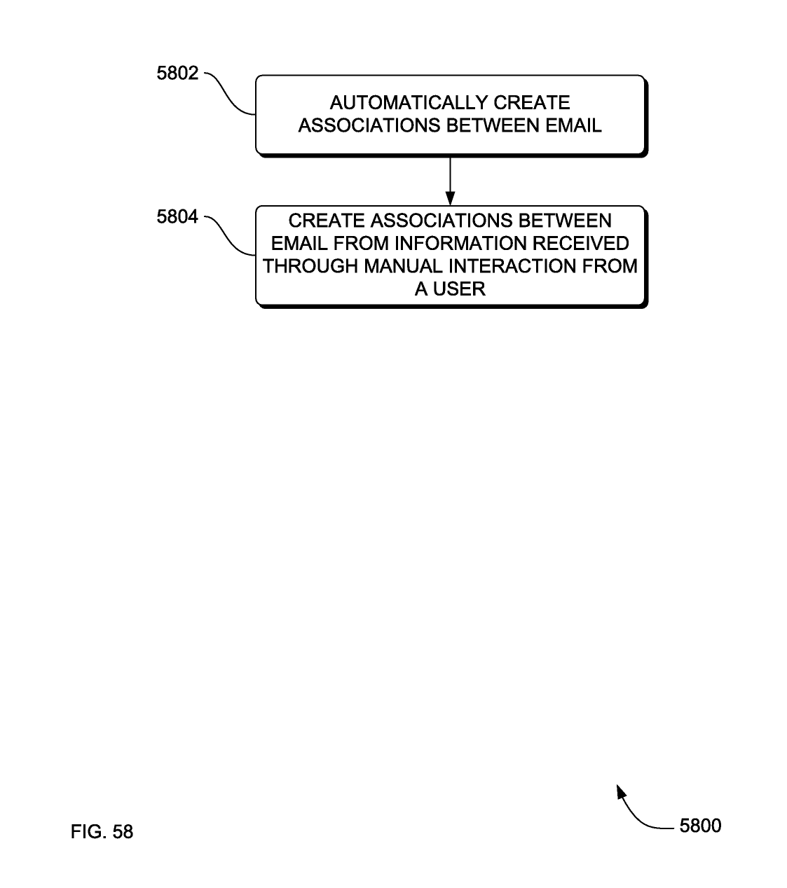

FIG. 58 is a flowchart of a method 5800 to access email communications, according to an embodiment. Method 5800 solves the need in the art to more easily access email communications.

Method 5800 provides a facility or means to locate stored email communications from a multitude of screens, wherein the stored email is related to the particular screen that from a search is invoked. For example, a screen that displays information on people (known as “people screen”) provides a number of manners in which to find people, and a screen that displays information on emails (known as a “email screen”) provides a number of manners in which to search emails, but the searching relies on existing associations. The searching provides a means to select a particular person or email that the user wants to focus on. The searching is supported by a display of a special set of people or emails that narrow my search for the subset or individual. One example is all people whose last names start with “W”. Another example is a search all emails not deleted from the last two days.

Method 5800 includes creating 5802 associations by automating associating, such as associating email to people and associating email to category and people to priority, etc. The automated aspect of the creation of the associations means that the connections are created without involvement from the user. For example, associations between email and people for example are created without involvement from the user

The email client tracks email that has been sent, and refers to the tracked information to create associations. For example, the email client tracks that an email is sent to a person in a person table by comparing the destination address and then the email client creates the association between the email and the person.

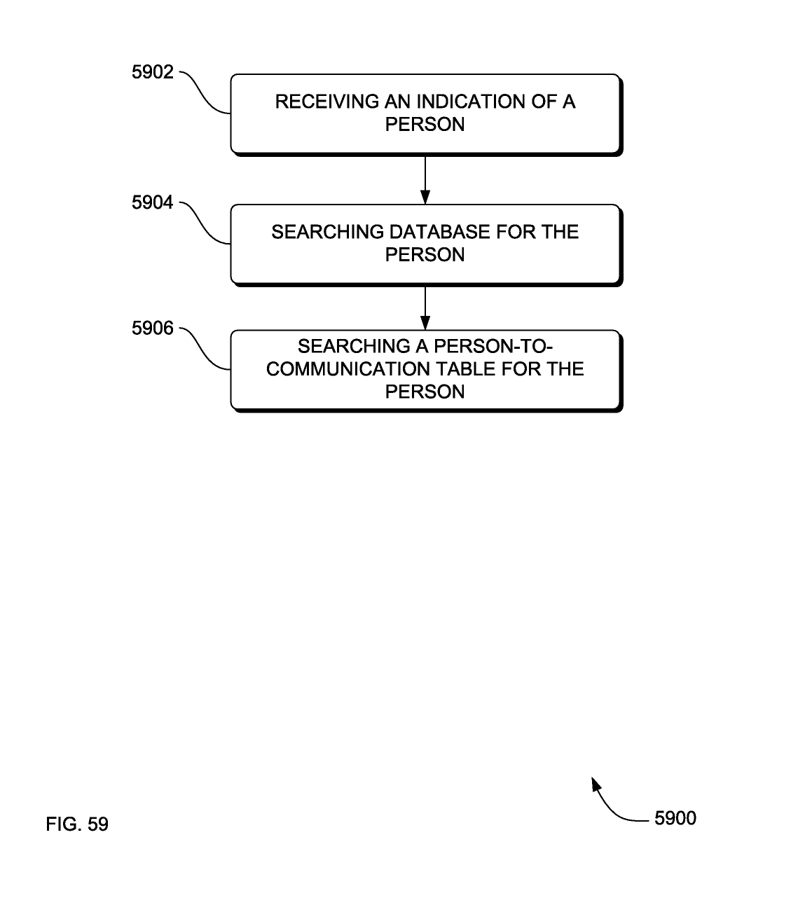

FIG. 59 is a flowchart of a method 5900 to automate history of email communications, according to an embodiment. Method 5900 solves the need in the art for a less time-consuming manner of storing and organizing email communications in regard to a personal identity.

The email client automatically associates each received email communication with the sender of the email communication if the sender is stored in the database as a contact. Any sender of an email communication can be added to the database. Email communications can be also auto-associated with at least one category.

Method 5900 includes receiving 5902 an indication of a first checked person whose name was selected by the user from a list of persons. Method 5900 also includes searching 5904 a database to locate the indicated person. Thereafter method 5900 also includes searching 5906 through database relation called person to communication between those associated tables, all emails related to that person for a user customizable date range.

Emails of a particular person can be located by the user in the following manner: The user selects the person in a list of people that can be obtained from the person table. The user selects a screen that displays email communications and selects a button to provide the history, such as a button labeled “history.”

Emails of a particular category can be located by the user in the following manner: The user selects a function to change the email receive screen radio buttons from “People” to “Topic” and then the user select a button to provide the history, such as a button labeled “history.”

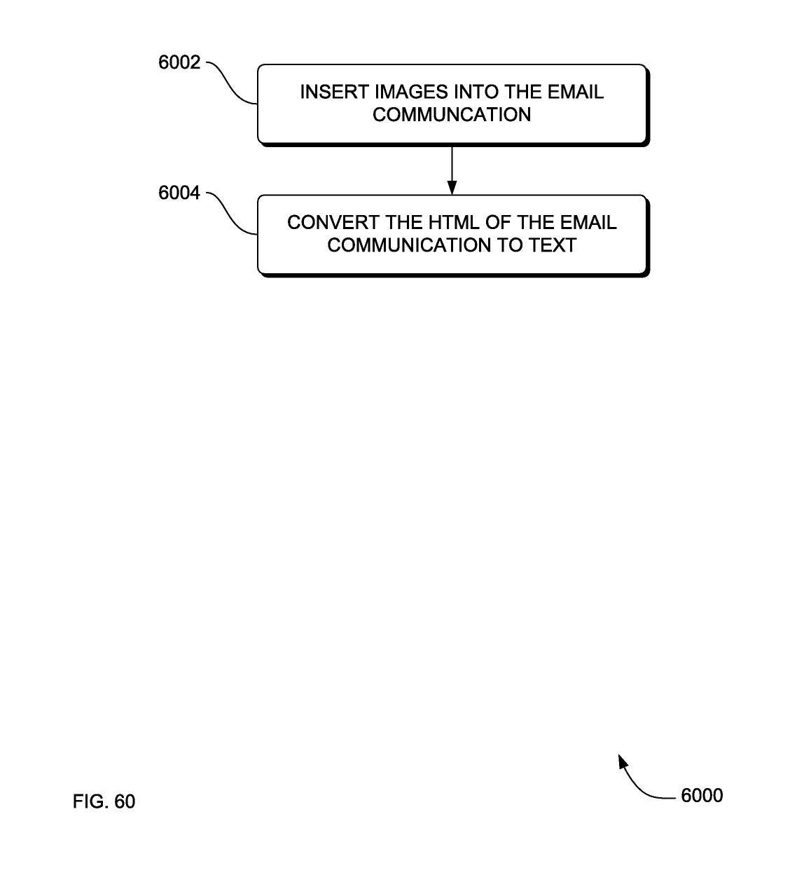

FIG. 60 is a flowchart of a method 6000 to convert HTML to text, according to an embodiment. Method 6000 solves the need in the art for an email client that does not generate a reply to an email communication that includes HTML.

Method 6000 includes editing 6002 HTML in a composition page of an email client. The editing 6002 includes inserting images into an email communication. In some embodiments, the inserting includes placing a file location of the image in the body of the email communication in the HTML format “<IMG SRC=‘pathtofile’>” which is interpreted by a browser as in directive to display the file located at ‘pathtofile’ in the place in the body. Method 6000 also includes converting 6004 HTML to text. The conversion makes composition of a reply to the email communication more convenient. In some embodiments, the converting 6004 includes removing special formatting symbols from the HTML text so that only text that remains is text that is readable by a human. In some embodiments of the converting 6004, the HTML tags are removed from the normal text using regular expressions.

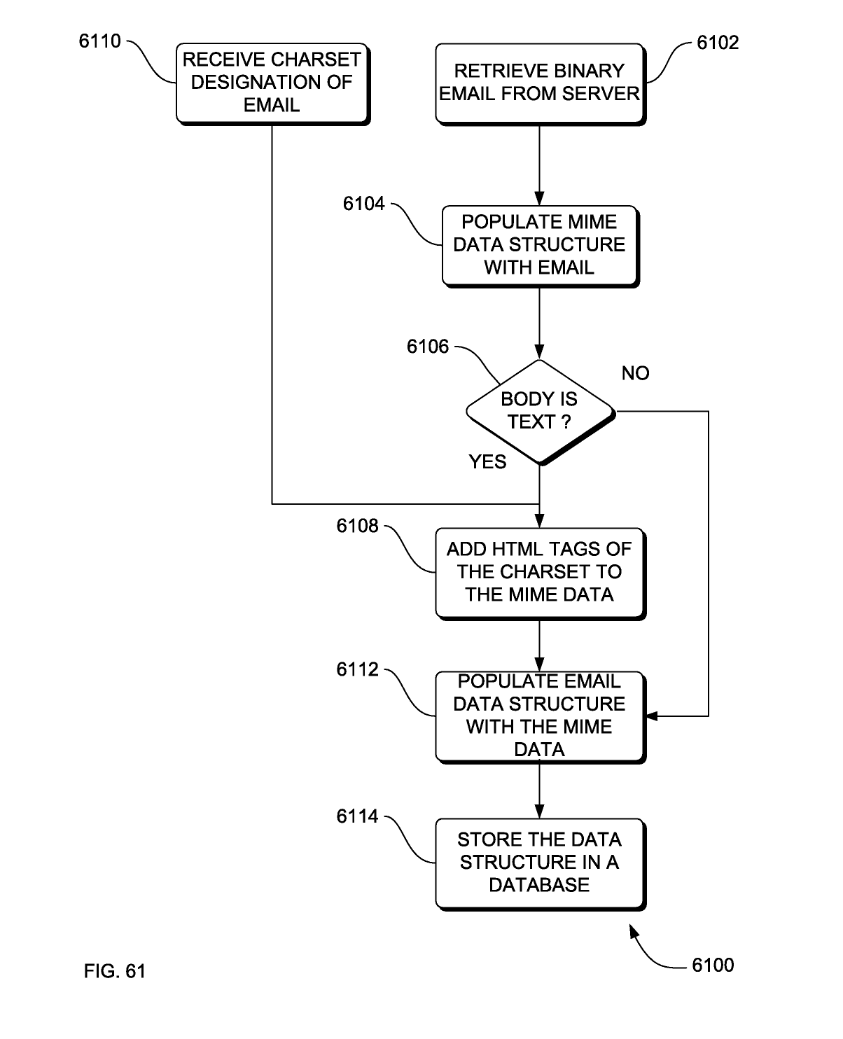

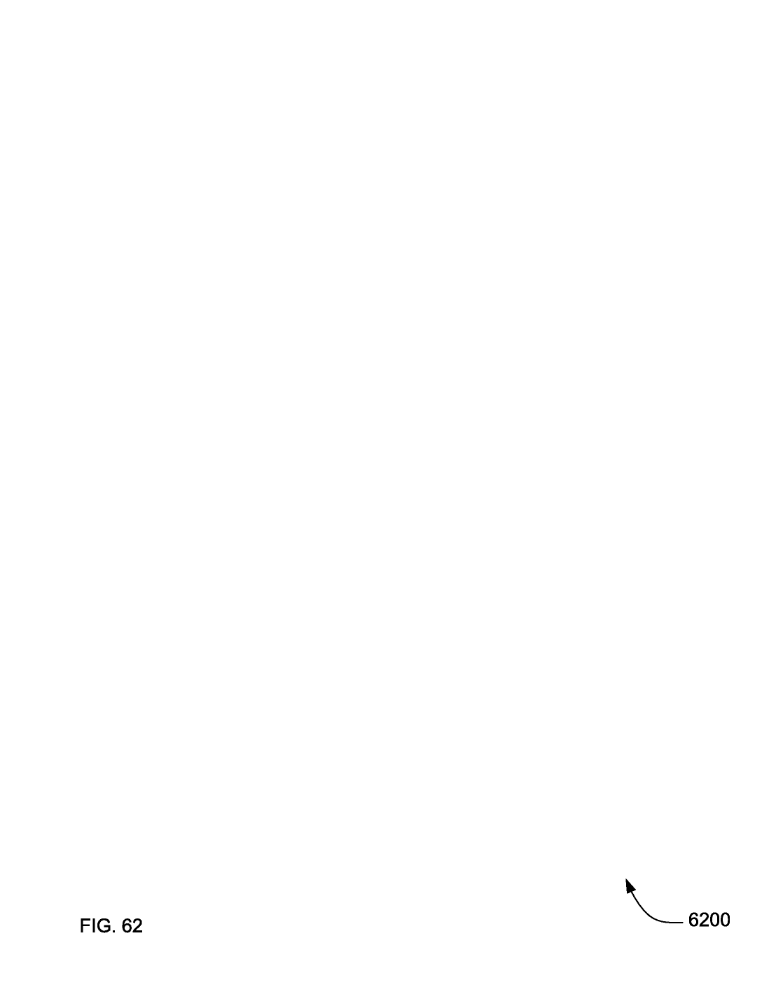

FIG. 61 is a flowchart of a method 6100 to receive and store an email communication that retains a designation of the character set of the email communication, according to an embodiment. Method 6100 solves the need in the art to display all extended characters of text that is encoded in an extended character set.

Method 6100 includes retrieving 6102 the email communication as a binary file from a server and populating 6104 a data structure that is compliant with the Multipurpose Internet Mail Extensions (MIME) standard with data from the email communication. In some embodiments, the retrieving 6102 is performed by invoking a component of another software package. MIME is a standard for multi-part, multimedia electronic mail messages and World-Wide Web hypertext documents on the Internet. MIME provides the ability to transfer non-textual data, such as graphics, audio and fax. MIME is defined in RFC 2045, RFC 2046, RFC 2047, RFC 2048, RFC 2049, and BCP0013 published by the IETF. MIME uses mimencode to encode binary data into base 64 using a subset of ASCII.

Thereafter, in some embodiments, if the body of the email is determined 6106 to include HTML tags, HTML tags are added 6108 to the body text. For example, a HTML declaration (e.g. <HTML>is added to the beginning of the text, and a HTML (e.g. </HTML>ending is added to the end of the text. In additional, a HTML declaration of the character set is added to the text. For example, the following HTML statements are added to the text: <HEAD><META CHARSET=??></HEAD>where ?? is the designation of the character set that is received in action 6110 as described below. Before adding the HTML to the text, method 6100 includes receiving 6110 the designation of the character set of a text body of the email communication.

Thereafter, in some embodiments, method 6100 includes populating 6112 an email data structure with data from the MIME-compliant data structure. In some embodiments, the email data structure is the table layout data structure 2600 in FIG. 26 above, and the designation of the character set is populated into the CHAR SET field 2604.

Thereafter, method 6100 includes storing 6114 the populated email data structure in a database. In some embodiments the database is an SQL database, such as database 3304 in FIG. 34 above, SQL Server Database-A 4008, SQL Server Database-B 4010 in FIG. 40 above, or SQL Server Database-C 4104 in FIG. 41 above.

Method 6100 retains the designation of the character set in both actions 6108 and 6112, which provides a means to display all extended characters of text in the email communication that is encoded in an extended character set. Some embodiments of method 6100 include either action 6108 or action 6112, but not necessarily both actions.

Graphical User Interface Embodiments

FIG. 63 is a block diagram of a graphical user interface (GUI) 6300 to associate an email with an idea or a category in an email communication client, according to an embodiment. Method 6300 solves the need in the art for more general association between emails and other indicia.

GUI 6300 includes a category list 6302 for a person with a marked category 6304 and a button 6306 that invokes an association between the person and the marked category 6304. The association that GUI 6300 provides enables a user of the email client to access and review emails of a particular category project without having to page through all the emails for all the projects. For example, a lawyer could look at the client's current project and easily find all recent emails relating to the current project without looking through all the emails for all the projects.

FIG. 64 is a block diagram of a display of nested Favorites list 6400 to store locations of favorite resources, according to an embodiment. Diagram 6400 solves the need in the art for a Favorites list that can be easily viewed to contemplate changes in the Favorites files and perform drag and drop operations.

Diagram 6400 includes a number of nested favorites lists, such as Television Guides 6402 and Spokane 6404. The nesting of the lists allows each of the lists to be closed by clicking the open/close button of the list, such as button 6406. Diagram 6400 shows an image of a Favorite organization which supports full dragging and dropping of hyperlinks even while scrolling over a very complex tree from top to bottom. If a user drags a hyperlink from the top of the tree to the bottom of a tree that is four pages in height due to complex organization, the tree scrolls automatically to easily allow the user to get to the bottom of the tree or any intermediary point and then drop there.

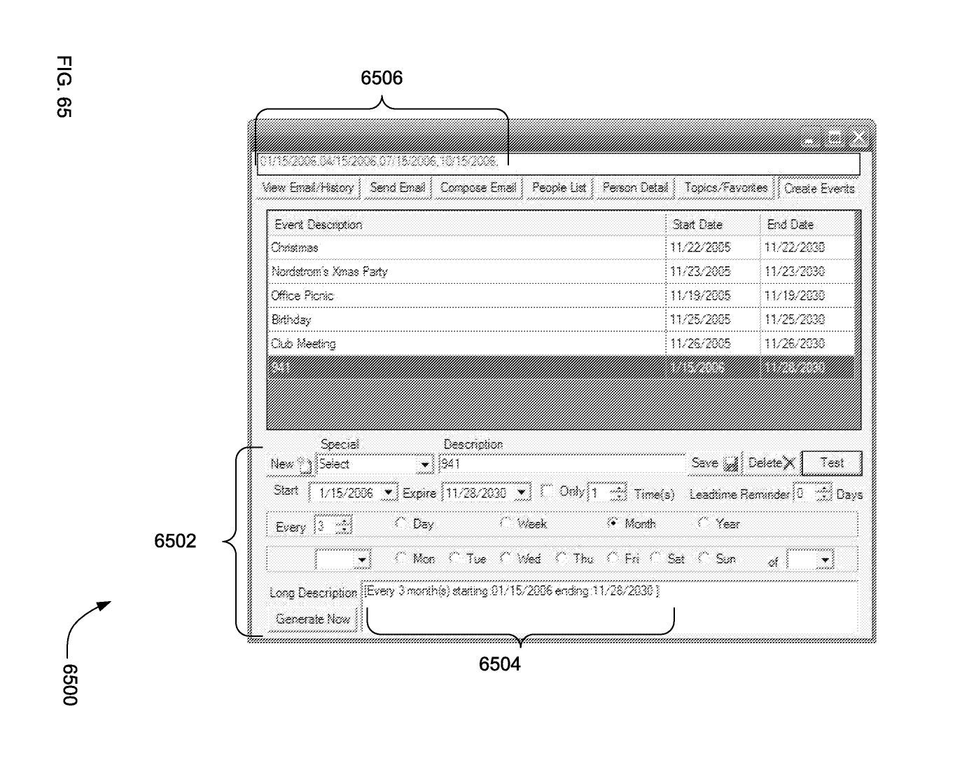

FIG. 65 is a block diagram of a display of recurring events 6500, according to an embodiment. Diagram 6500 solves the need in the art to manage recurring events with the advantages of conventional systems.

Display 6500 includes a recurring event 6502 for an Internal Revenue Service 941 form that is scheduled to be completed each quarter. Note the long description 6504 describing settings that the user selected. Above are the first four dates 6506 for which this recurring event 6502 will create an email reminder. Display 6500 provides display of a number of options for recurring events on one page, without a complexity that would make a user feel unconfident about their selections.

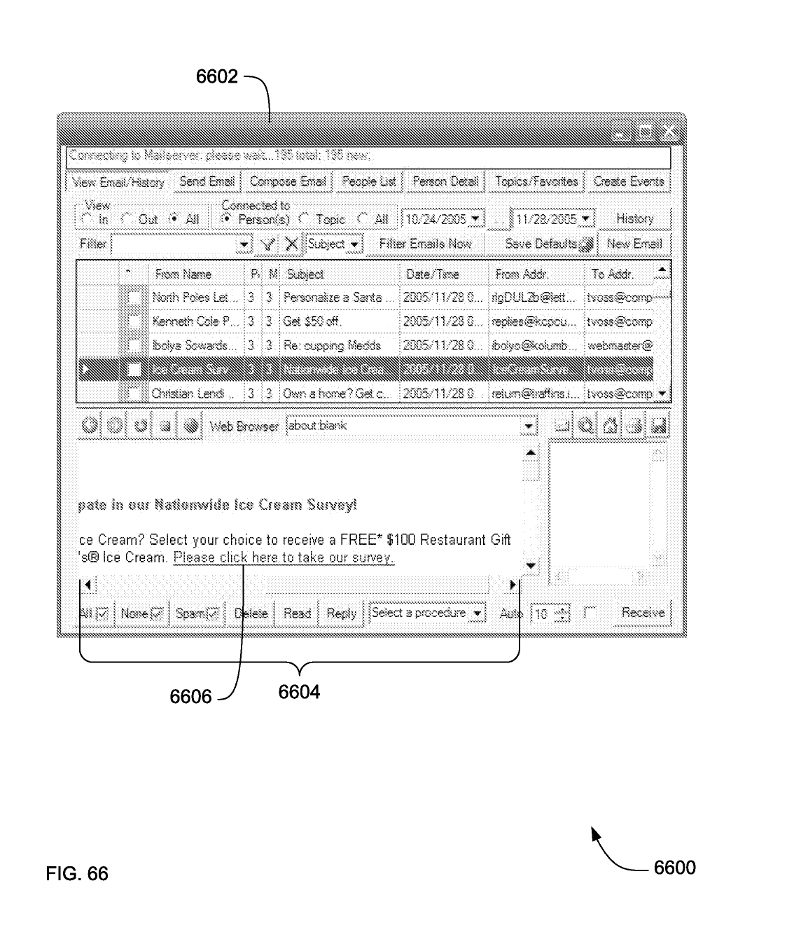

FIG. 66 is a block diagram of a display of an email communication 6600, according to an embodiment. Diagram 6600 solves the need in the art to manage recurring events with the advantages of conventional systems. Display 6600 includes an image 6602 of a screen where an email 6604 is displayed that contains a hyperlink 6606.

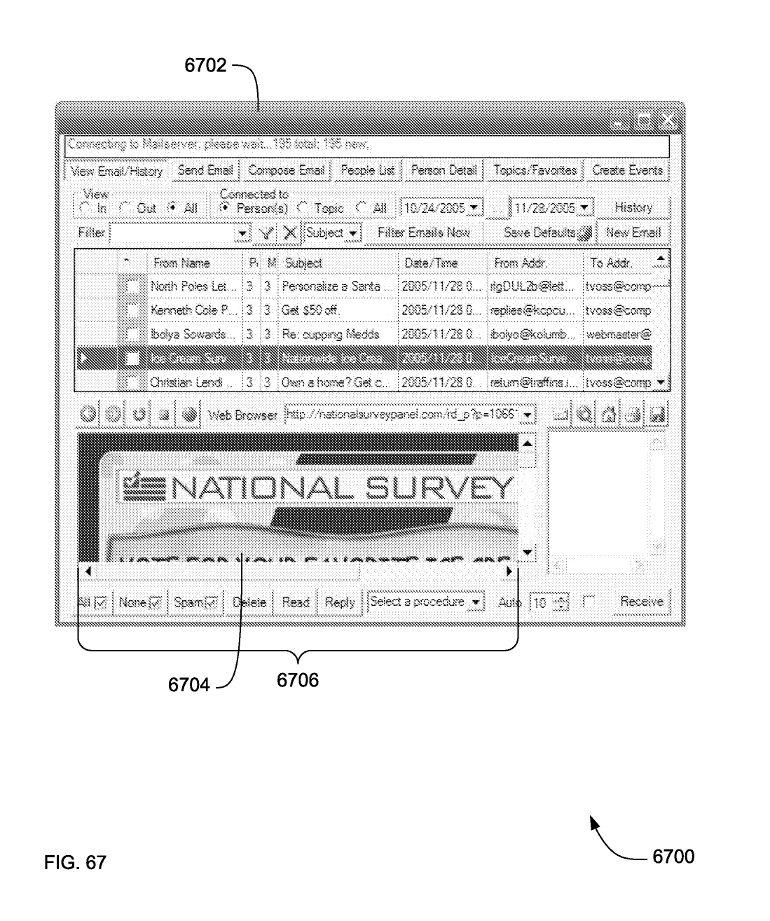

FIG. 67 is a block diagram of a display of an email communication 6700, according to an embodiment. Diagram 6700 solves the need in the art to manage recurring events with the advantages of conventional systems. Display 6700 includes an image 6702 of a screen in which a resource 6704 located at the hyperlink 6606 is displayed so that the entire display of the email client is visible to the user. FIG. 67 illustrates how working with one application, the email client, is simpler than working with two applications (the email client and a browser) to display a resource at the hyperlink, thus the email program can interact more easily with web content.

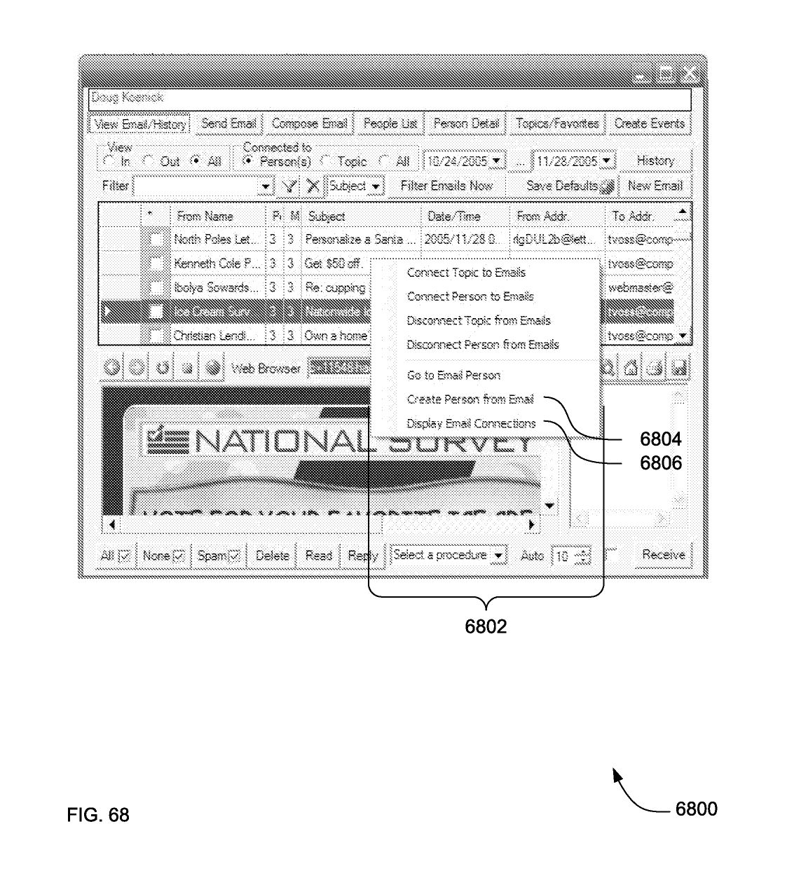

FIG. 68 is a block diagram of a display of an email screen 6800, according to an embodiment. Email screen 6800 solves the need in the art to more easily access email communications.

Email screen 6800 includes an example of a menu 6802 for an email screen. Note as an example that with one click the person detail for an email is displayed so that a user could call someone on the phone who has just emailed the user. Using the email screen, the user also can connect an email to another person, topic, disconnect the email, etc. Note that with one click of selection 6804 a user can create a person that wasn't in the database before by using the information in the email and have the current email connect to that person. From selection 6806, the user can also determine how many items an email is connected to. Similar functions exist for people, topics, hyperlinks, events and compositions. Thus, the higher degree of association that the menu 6802 of email screen 6800 helps solve the need in the art to more easily access email communications.

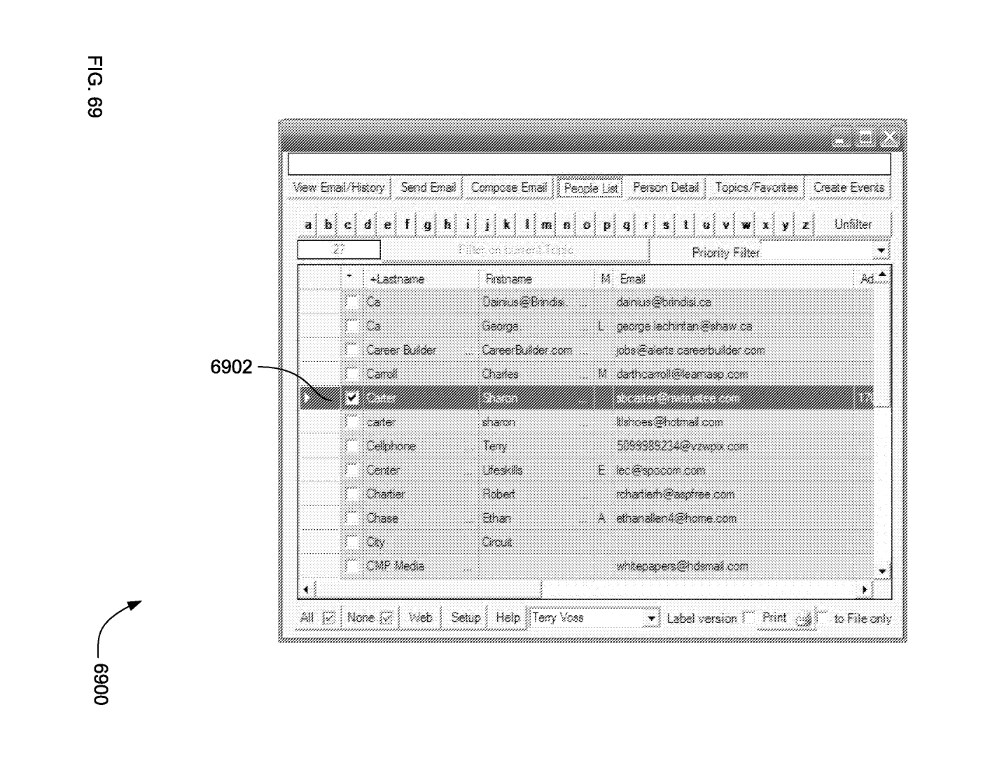

FIG. 69 is a block diagram of a display of a person screen 6900, according to an embodiment. The person screen shows one selected person 6902: Sharon Carter. This function is performed before receiving 5902 an indication of a first checked person whose name was selected by the user from a list of persons.

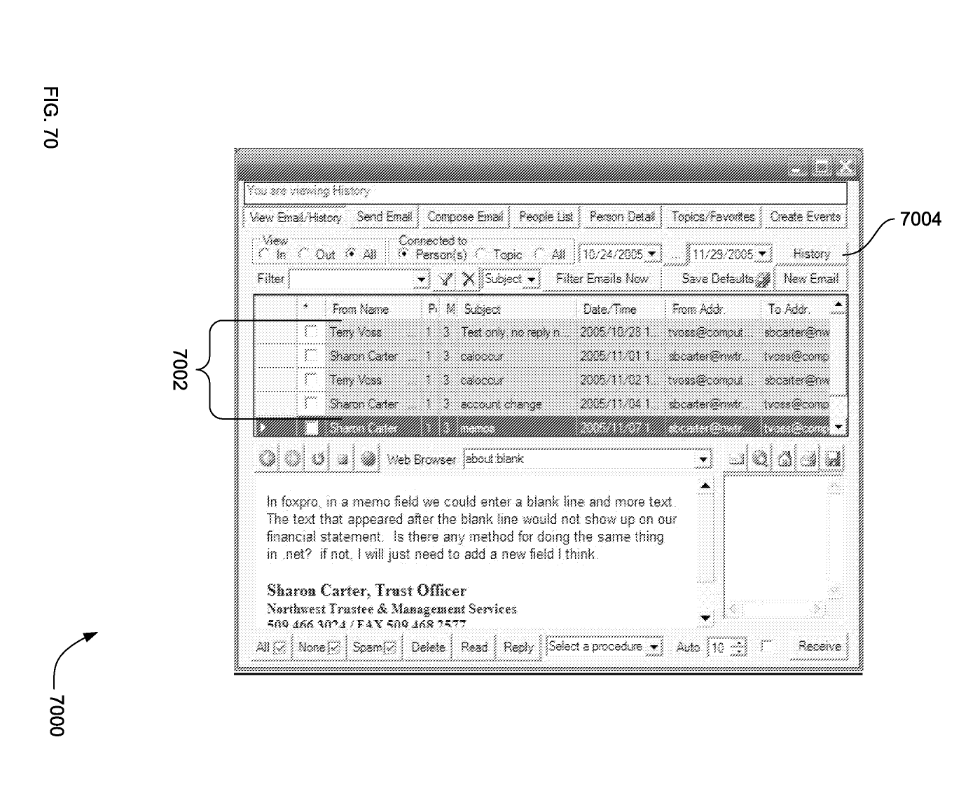

FIG. 70 is a block diagram of a display of a history screen 7000, according to an embodiment. The display includes a list 7002 of historic emails. To invoke the display, the History button 7004 is clicked. This display is performed after searching 5906 through a database relation called person to communication which obtains all emails related to that person.

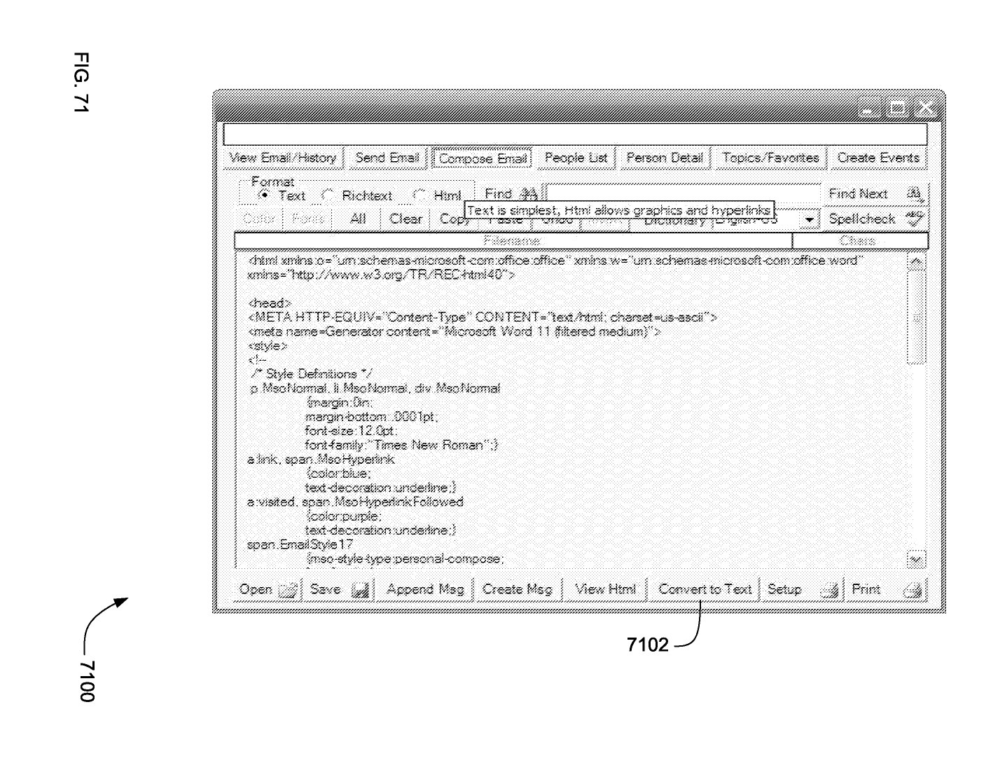

FIG. 71 is a block diagram of a display of an email composition screen 7100 before conversion of HTML to text, according to an embodiment. The email composition screen 7100 shows the HTML code of an email communication. The email composition screen 7102 includes a button 7102 to convert the HTML to text.

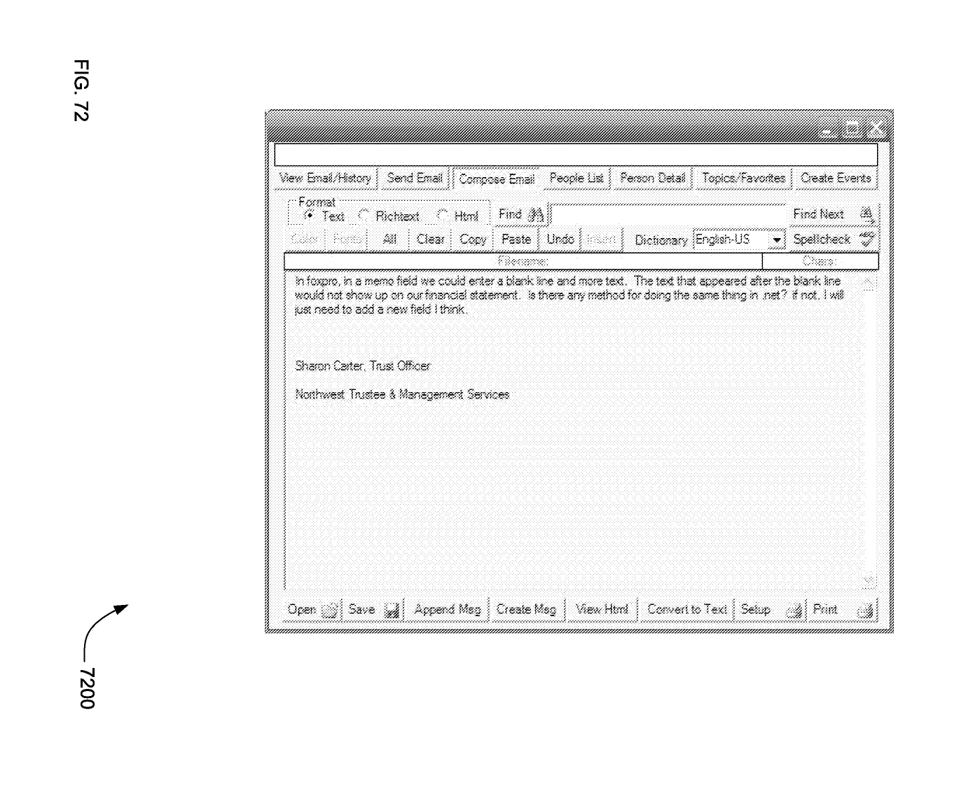

FIG. 72 is a block diagram of a display of an email composition screen 7200 after conversion of HTML to text, according to an embodiment. The email composition screen 7100 shows a display of HTML of an email communication.

In some embodiments, methods 4200-6100 and graphical user interfaces 6300-7200 are implemented as a computer data signal embodied in a carrier wave that represents a sequence of instructions which, when executed by a processor, such as processor 3304 in FIG. 33, cause the processor to perform the respective method. In other embodiments, methods 4200-6100 and graphical user interfaces 6300-7200 are implemented as a computer-accessible medium having executable instructions capable of directing a processor, such as processor 3204 in FIG. 32, to perform the respective method. In varying embodiments, the medium is a magnetic medium, an electronic medium, or an optical medium.

### CONCLUSION

An email client is described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application is meant to include all object-oriented, database and communication environments and alternate technologies which provide the same functionality as described herein.

We claim:

1. A computer-accessible medium having executable instructions to associate an email with a category in an email client, the executable instructions capable of directing a processor to perform:
receiving an email communication that is associated with a person; and
locating information pertaining to the person by referencing a person-to-email relationship in a category/person table,
wherein the category/person table comprises
a field storing data representing an indexed key field representing an identification of a category/person;
a field storing data representing a category; and
a field storing data representing a person,
verifying that a field representing an auto-connection for the person is set to affirmative; and
associating the email communication with the category referenced in the category/person table.

2. The computer-accessible medium of claim 1, wherein execution of the instructions is managed by a runtime module, the runtime module farther comprising an architecture of cooperation between natively executing instructions and the runtime module, the architecture specifying that at any point of the execution, the runtime module can stop the executing processor and retrieve information specific to the current processor instruction address, the information being query-able pertaining to runtime state, such as register or stack memory contents.

3. The computer-accessible medium of claim 1, the medium further comprising executable instructions capable of directing the processor to perform:
receiving a selection of the person;
displaying detailed information of the person; including a list of categories of with which the selected person is related to or associated;
receiving an indication of a selection of a graphical user interface button adjacent or in close proximity to the display of the categories list;
displaying a marker next to, adjacent or in close proximity to one of the categories;
associating automatically all emails from the person;
receiving an indication of the user selecting the button;
moving the marker next to a category in the category list;
receiving an indication of the user selecting the button when no category is marked; and
marking the first category in the category list.

4. The computer-accessible medium of claim 1, the medium farther comprising executable instructions capable of directing the processor to perform:
storing a body of the email communication in a first data file structure; and
storing the at least one attachment in a second data file structure.

5. The computer-accessible medium of claim 1, the medium farther comprising executable instructions capable of directing the processor to perform:
determining that a sender of the email is stored in a database; and
creating an association in the database between the email and the sender.

6. The computer-accessible medium of claim 1, wherein the table is accessed through a structured-query-language database manager, the structured-query-language database manager having a high level security manager.

7. The computer-accessible medium of claim 1, wherein the executable instructions further comprise managed code whose execution is managed by a runtime module, the runtime module further defining an architecture of cooperation between natively executing instructions and the runtime module, wherein the architecture of cooperation requires that at any point of execution of the executable instructions, the runtime module can stop a processor that is executing the executable instructions and the processor can retrieve information specific to a current CPU instruction address, wherein retrieved information pertains to runtime state, including register or stack memory contents.

8. A computer-accessible medium having executable instructions to encrypt email communications, the executable instructions capable of directing a processor to perform:
encrypting an email communication in conjunction with a key management facility, the encrypting being performed in a manner that is compliant with RFC 2440, the encrypting being farther performed by a component that is compliant with an architecture of cooperation between natively executing instructions and a runtime module, the architecture further specifying that at any point of execution, the runtime module is operable to stop an executing processor and the runtime module is further operable to retrieve information specific to the current executing processor instruction address, the information including runtime state information; and
transmitting the encrypted email communication.

9. The computer-accessible medium of claim 8, wherein the executable instructions capable of directing the processor to perform the encrypting further comprise executable instructions capable of directing the processor to perform:
embodying the executable instructions capable of directing the processor to perform the encrypting in a wrapper class that is compliant with the architecture of cooperation, the wrapper class providing a public domain version of encryption process in accordance with RFC 2440.

10. The computer-accessible medium of claim 8, wherein the executable instructions capable of directing the processor to perform the encrypting further comprise executable instructions capable of directing the processor to perform:
encrypting the email communication in a symmetric-key process from a one-time key, the one-time key further comprising a key that expires upon the first use of the key.

11. The computer-accessible medium of claim 10, wherein the one-time key farther comprises:
a session key

12. The computer-accessible medium of claim 11, wherein the executable instructions capable of directing the processor to perform the encrypting further comprise executable instructions capable of directing the processor to perform:

13. The computer-accessible medium of claim 12, wherein the executable instructions capable of directing the processor to perform the encrypting further comprise executable instructions capable of directing the processor to perform:
encrypting the session key from a public key, the public key being associated with, generated by, or known to the intended recipient of the email communication.

14. The computer-accessible medium of claim 13, wherein the executable instructions capable of directing the processor to perform the transmitting further comprise executable instructions capable of directing the processor to perform:
transmitting the encrypted session key with the encrypted email communication.

15. A graphical user interface comprising:
a plurality of favorites lists, wherein the favorites list is nested, wherein the nested favorites list provides graphical dragging and dropping of hyperlinks while a user operating the nested favorites lists scrolls over nested favorites lists; and
at least one open/close button associated with each of the plurality of nested favorites lists, wherein the nesting of the favorites lists provides each of the nested favorites lists to be opened or closed.

16. A computer-accessible medium having executable instructions to manage scenarios of previous installation states of an email communication client, the executable instructions capable of directing a processor to perform:
installing the email communication client on a destination computer after
affirmatively determining a first scenario of the destination computer having no software installed relating to the operation of the email communication client;
installing a database manager on the destination computer after affirmatively determining a second scenario of the destination computer having no database manager installed that is of sufficient capability for operation of the email communication client; and
installing an architectural software component on the destination computer after affirmatively determining a third scenario of the destination computer having no architectural software component installed that is of sufficient capability for operation of the email communication client, wherein the architectural software component further comprises an architectural software component that is compliant with an architecture of cooperation between natively executing instructions and a runtime module, the architecture further specifying that at any point of execution, the runtime module is operable to stop an executing processor and the runtime module is further operable to retrieve information specific to the current executing processor instruction address, the information including runtime state information.

17. The computer-accessible medium of claim 16, the medium further comprising executable instructions capable of directing the processor to perform:
recognizing any combination of the scenarios and not installing a component that is currently installed.

18. A computer-accessible medium having executable instructions to receive and store an email communication, the executable instructions capable of directing a processor to perform:
retrieving the email communication as a binary file from a server;
receiving a designation of a character set of a text body of the email communication;
populating a data structure that is compliant with the MIME standard with data from the email communication;
populating an email data structure with data from the MIME-compliant data structure;
populating the email data structure with the designation of the character set; and
storing the email data structure in a database.

19. The computer-accessible medium of claim 18, wherein the database further comprises:
a SQL database.

20. The computer-accessible medium of claim 18, wherein the executable instructions capable of directing the processor to populate the data structure that is compliant with the MIME standard with data from the email communication further comprise executable instructions capable of directing the processor to perform:
translating the email communication to a data structure that is compliant with MIME.
